(19) United States
(12) Patent Application Publication
(10) Pub. No.: US 2017/0372414 A1
(43) Pub. Date: Dec. 28, 2017

(54) INFORMATION PROCESSING SYSTEM AND INFORMATION PROCESSING APPARATUS

(71) Applicants: Kohichiroh NISHIKAWA, Tokyo (JP); Dongzhe ZHANG, Kanagawa (JP)

(72) Inventors: Kohichiroh NISHIKAWA, Tokyo (JP); Dongzhe ZHANG, Kanagawa (JP)

(73) Assignee: Ricoh Company, Ltd., Tokyo (JP)

(21) Appl. No.: 15/625,141

(22) Filed: Jun. 16, 2017

(30) Foreign Application Priority Data
Jun. 22, 2016 (JP) 2016-123685
Oct. 13, 2016 (JP) 2016-201971
Jan. 20, 2017 (JP) 2017-008807
Feb. 20, 2017 (JP) 2017-029487

(51) Int. Cl. G06Q 40/02; G06K 9/00; G06Q 20/20; H04N 1/00

(52) U.S. Cl. CPC G06Q 40/02; H04N 1/00244; G06K 9/00469; G06Q 20/209; H04N 1/00225

(57) ABSTRACT

An information processing system includes one or more processors. The one or more processors are configured to receive, from an apparatus, first image data that includes one or more evidence paper images for expense reporting; extract the one or more evidence paper images from the received first image data, and generate one or more sets of second image data corresponding to the one or more evidence paper images, respectively; and send the generated one or more sets of second image data to a system including at least an expense report function to cause the system including at least the expense report function to register each of the one or more sets of second image data in the system including at least the expense report function.

### CROSS-REFERENCE TO APPLICATIONS

The present application claims priority under 35 U.S.C.§119 to Japanese Patent Application No. 2016-123685, filed Jun. 22, 2016, Japanese Patent Application No. 2016-201971, filed Oct. 13, 2016, Japanese Patent Application No. 2017-008807, filed Jan. 20, 2017, and Japanese Patent Application No. 2017-029487, filed Feb. 20, 2017. The contents of Japanese Patent Application No. 2016-123685, Japanese Patent Application No. 2016-201971, Japanese Patent Application No. 2017-008807, and Japanese Patent Application No. 2017-029487 are incorporated herein by reference in their entirety.

### BACKGROUND

### 1. Technical Field

The present disclosure relates to an information processing system and an information processing apparatus.

### 2. Description of the Related Art

Recently, a service that provides a combination of functions (for example, a scanning service, a printing service, a mail delivery service, a file upload service, and so forth) is known. For example, a service of uploading an electronic file generated through scanning, to an external system, is known. Such a type of service may be implemented as a result of one or more processes each implementing a function being carried out as a sequence of processes.

An image forming apparatus which carries out a sequence of processes based on instructions that include process information in which one or more processes are indicated as the sequence of processes is known (for example, see Japanese Patent No. 4039191).

### SUMMARY

According to one aspect, an information processing system includes one or more processors. The one or more processors are configured to receive, from an apparatus, first image data that includes one or more evidence paper images for expense reporting; extract the one or more evidence paper images from the received first image data, and generate one or more sets of second image data corresponding to the one or more evidence paper images, respectively; and send the generated one or more sets of second image data to a system including at least an expense report function to cause the system including at least the expense report function to register each of the one or more sets of second image data in the system including at least the expense report function.

Other objects, features, and advantages will become more apparent from the following detailed description when read in conjunction with the accompanying drawings.

### BRIEF DESCRIPTION OF THE DRAWINGS

FIG. 1 illustrates one example of a system configuration of an information processing system according to a first embodiment;

FIG. 2 illustrates a hardware configuration of examples of a service providing system and a PC terminal according to the first embodiment;

FIG. 3 illustrates a hardware configuration of one example of an apparatus according to the first embodiment;

FIG. 4 illustrates an outline of a receipt registration service according to the first embodiment;

FIG. 5 illustrates a functional configuration of one example of the information processing system according to the first embodiment;

FIG. 6 illustrates one example of a functional configuration of a logic processing unit according to the first embodiment;

FIG. 7 illustrates one example of processing flow information in which a sequence of processes that implement a receipt registration service are defined;

FIG. 8 illustrates one example of processing flow information in which a sequence of processes to be iteratively carried out, in the sequence of processes that implement the receipt registration service, are defined;

FIG. 9 is a sequence diagram illustrating one example of an overall process carried out when a user uses a receipt registration service according to the first embodiment;

FIG. 10 illustrates one example of a receipt registration service use screen page;

FIG. 11 is a sequence diagram illustrating one example of a processing flow carrying-out process for implementing a receipt registration service according to the first embodiment;

FIG. 12 is a sequence diagram illustrating one example of a receipt registration process according to the first embodiment;

FIG. 13 is a sequence diagram illustrating one example of an overall process carried out when a user uses an expense reimbursement service according to the first embodiment;

FIG. 14 illustrates one example of a screen page transition concerning an expense reimbursement service;

FIG. 15 illustrates one example of a hardware configuration of an apparatus according to a second embodiment;

FIG. 16 illustrates one example of processing flow information in which a sequence of processes for implementing a receipt registration service according to the second embodiment are defined;

FIG. 17 illustrates one example of processing flow information in which a sequence of processes to be iteratively carried out, in the sequence of processes for implementing the receipt registration service, are defined;

FIG. 18 is a sequence diagram illustrating one example of an overall process carried out when a receipt registration service according to the second embodiment is used;

FIG. 19 illustrates one example of a screen page transition concerning a receipt registration service;

FIGS. 20 and 21 illustrate examples of photographing a receipt;

FIG. 22 is a sequence diagram illustrating one example of a processing flow carrying-out process for implementing a receipt registration service according to the second embodiment;

FIG. 23 is a sequenced diagram illustrating one example of a receipt image extraction process according to the second embodiment;

FIG. 24 illustrates one example of a functional configuration of an information processing system according to a third embodiment;

FIG. 25 illustrates one example of token information;

FIG. 26 is a sequence diagram illustrating one example of an authentication cooperation setting process according to the third embodiment;

FIG. 27 illustrates one example of a screen page transition concerning an authentication cooperation setting process;

FIG. 28 is a sequence diagram illustrating one example of an overall process carried out when a user uses a receipt registration service according to the third embodiment;

FIG. 29 illustrates one example of a receipt registration use screen page;

FIG. 30 illustrates one example of a functional configuration of an information processing system according to a fourth embodiment;

FIG. 31 is a sequence diagram illustrating one example of agent setting process according to the fourth embodiment;

FIG. 32 illustrates one example of an agent setting screen page;

FIG. 33 is a sequence diagram illustrating one example of an overall process for a case where a user uses a receipt registration service as an agent according to the fourth embodiment;

FIGS. 34 and 35 illustrate examples of a screen page transition in a case where a receipt registration service is used by an agent;

FIG. 36 illustrates one example of a functional configuration of a logic processing unit according to a fifth embodiment;

FIG. 37 illustrates one example of a template registration screen page;

FIG. 38 illustrates one example of processing flow information in which a sequence of processes for implementing a receipt registration service according to the fifth embodiment are defined;

FIG. 39 is a sequence diagram illustrating one example of an overall process carried out when a receipt registration service according to the fifth embodiment is used;

FIG. 40 illustrates one example of a template selection screen page;

FIGS. 41 and 42 are a sequence diagram illustrating one example of a processing flow carrying-out process that implements a receipt registration service according to the fifth embodiment;

FIG. 43 is a sequence diagram illustrating one example of a receipt registration process according to the fifth embodiment;

FIG. 44 illustrates one example of a system configuration of an information processing system according to a sixth embodiment;

FIG. 45 illustrates an outline of a receipt registration service according to the sixth embodiment;

FIG. 46 illustrates a functional configuration of one example of an information processing system according to the sixth embodiment;

FIG. 47 illustrates one example of a functional configuration of a logic processing unit according to the sixth embodiment;

FIG. 48 is a sequence diagram illustrating one example of an overall process carried out when a user uses a receipt registration service according to the sixth embodiment;

FIG. 49 is a sequence diagram illustrating one example of a processing flow carrying-out process that implements a receipt registration service according to the sixth embodiment;

FIG. 50 is a sequence diagram illustrating one example of a receipt registration process according to the sixth embodiment;

FIG. 51 illustrates a functional configuration of one example of an information processing system according to a seventh embodiment;

FIG. 52 is a sequence diagram illustrating one example of an overall process carried out when a receipt registration service according to the seventh embodiment is used;

FIG. 53 is a sequence diagram illustrating one example of a processing flow carrying-out process for implementing a receipt registration service according to the seventh embodiment;

FIG. 54 is a sequence diagram illustrating one example of a receipt image extraction process according to the seventh embodiment;

FIG. 55 illustrates a hardware configuration of one example of an apparatus according to an eighth embodiment;

FIG. 56 illustrates one example of a functional configuration of an information processing system according to the eighth embodiment;

FIG. 57 illustrates one example of authentication ticket information;

FIG. 58 is a sequence diagram illustrating one example of a cooperation setting operation according to the eighth embodiment;

FIG. 59 illustrates one example of a screen page transition according to an expense reimbursement application;

FIGS. 60A and 60B illustrate examples of a setting completion screen page and a login failure screen page;

FIG. 61 is a sequence diagram illustrating one example of an overall process for using a receipt registration service according to the eighth embodiment;

FIG. 62 illustrates another example of a screen page transition concerning the expense reimbursement application;

FIG. 63 is a sequence diagram illustrating one example of a processing flow carrying-out process implementing a receipt registration service according to the eighth embodiment; and

FIG. 64 is a sequence diagram illustrating one example of a receipt registration process according to the eighth embodiment.

### DETAILED DESCRIPTION OF EMBODIMENTS

According to embodiments that will now be described, it is possible to register pieces of paper for evidence, such as receipts that may be pieces of paper that are output from a cash register or the like usable as evidence for expenses, in cooperation with an external service such as an expense reimbursement service. In more detail, according to the embodiments, it is possible to register image files of images of pieces of paper for evidence such as receipts or the like in an external expense reimbursement service, the image files being generated as a result of the pieces of paper for evidence such as receipts or the like being scanned by an image forming apparatus, for example.

Thus, according to the embodiments, users who register pieces of paper for evidence such as receipts for expense reimbursement are advantageously assisted.

In this regard, for the purpose of convenience, an image of a piece of paper for evidence may be simply referred to as an evidence paper image.

Below, the embodiments will be described in detail with reference to the drawings.

### First Embodiment

### <System Configuration>

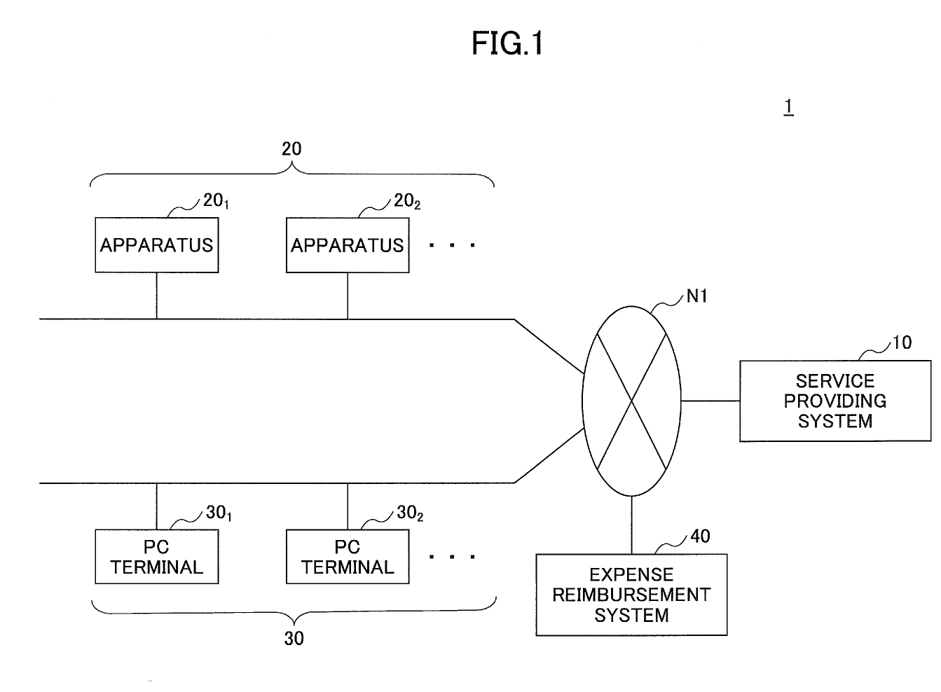

A system configuration of an information processing system 1 according to a first embodiment will now be described with reference to FIG. 1. FIG. 1 illustrates one example of a system configuration of an information processing system 1 according to the first embodiment.

The information processing system 1 according to the first embodiment includes a service providing system 10, apparatuses 20, PC terminals 30, and an expense reimbursement system 40. These system elements are connected together via a wide-area network N1 such as the Internet in such a manner that the system elements can carry out communications together.

The service providing system 10 includes one or more information processing apparatuses, and provides various services via the network N1, each service being implemented by a sequence of processes, i.e., combinations of processes from among a plurality of processes that implement various functions, respectively.

Actual examples of the various functions include, for example, a printing function, a scanning function, a facsimile transmission function, a data format conversion function, a mail delivery function, an OCR (Optical Character Recognition) function, a function of modifying information, an information compressing/decompression function, a function of storing information in a repository, and so forth. The actual examples of the various functions further include a function of cooperating with an external service (for example, an expense reimbursement service provided by the expense reimbursement system 40).

The service providing system 10 according to the present embodiment provides a service implemented by a sequence of processes that include a process of cooperating with the expense reimbursement service. An actual example of a service provided by the service providing system 10 according to the present embodiment will be described later. Hereinafter, a sequence of processes may also be referred to as a “processing flow”.

The apparatuses 20 may be various electronic apparatuses that users use. For example, the apparatuses 20 may be image forming apparatuses such as MFPs (MultiFunction Peripherals). A user uses an apparatus 20 to use a service provided by the service providing system 10.

Actual examples of the apparatuses 20 are not limited to image forming apparatuses, and, may include, for example, smartphones, tablet terminals, digital cameras, projectors, and electronic blackboards.

Hereinafter, for distinguishing the respective apparatuses 20, the apparatuses 20 may be referred to as an “apparatus 20₁”, an “apparatus 20₂”, and so forth, using the subscripts.

The PC terminals 30 include, for example, desktop PCs (Personal Computers), notebook-type PCs, smartphones, tablet terminals, or the like, to be used by users. The users can use expense reimbursement services provided by the expense reimbursement system 40.

Hereinafter, for distinguishing the respective PC terminals 30, the PC terminals 30 may be referred to as “a PC terminal 30₁”, a “PC terminal 30₂”, and so forth, using subscripts.

The expense reimbursement system 40 is a computer system providing expense reimbursement services via the network N1. The expense reimbursement services are services for reimbursing expenses such as travelling expenses, costs of entertaining clients, and so forth. The users use, for example, browsers installed in the PC terminals 30, to access the expense reimbursement system 40 and use expense reimbursement services.

The configuration of the information processing system 1 illustrated in FIG. 1 is one example, and the information processing system 1 may have another configuration. For example, the information processing system 1 according to the present embodiment may include various devices that carry out at least one of inputting and outputting electronic data, and use services provided by the service providing system 10.

### <Hardware Configuration>

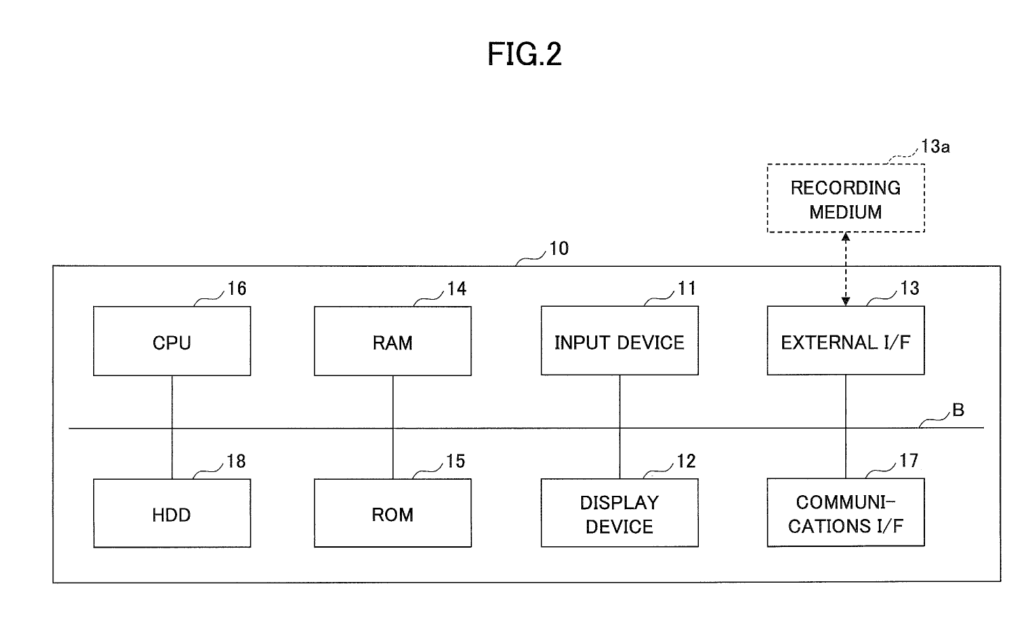

Next, hardware configurations of the service providing system 10 and the PC terminals 30 included in the information processing system 1 according to the present embodiment will be described with reference to FIG. 2. FIG. 2 illustrates hardware configurations of examples of the service providing system 10 and the PC terminals 30 according to the present embodiment. The service providing system 10 and the PC terminals 30 may have the same hardware configurations, and therefore, below, mainly the hardware configuration of the service providing system 10 will be described.

The service providing system 10 illustrated in FIG. 2 includes an input device 11, a display device 12, an external I/F 13, and a RAM (Random Access Memory) 14. Also, the service providing system 10 includes a ROM (Read-Only Memory) 15, a CPU (Central Processing unit) 16, a communications I/F 17, and a HDD (Hard Disk Drive) 18. The respective hardware elements are connected via a bus B. The input device 11 includes a keyboard, a mouse, a touch panel, or the like, and is used for a user to input various operation signals. The display device 12 includes a display, or the like, and displays processing results of the service providing system 10. It is possible that at least one of the input device 11 and the display device 12 is connected to the service providing system 10 when the at least one of the input device 11 and the display device 12 is used.

The communications I/F 17 is an interface for connecting the service providing system 10 to the network N1. The service providing system 10 carries out communications via the communications I/F 17.

The HDD 18 is a nonvolatile storage device storing programs and data. The programs and data stored by the HDD 18 include an OS (Operating System) that is basic software controlling the entirety of the service providing system 10, application software providing various functions with the OS, and so forth. The service providing system 10 may use a drive for a flash memory as a storage medium, for example, a SSD (Solid State Drive), instead of the HDD 18.

The HDD 18 manages the stored programs and data through a file system or a database.

The external I/F 13 is an interface for connecting to external devices. The external devices include a recording medium 13a. The service providing system 10 reads information from and writes information to the recording medium 13a via the external I/F 13. The recording medium 13a may be a flexible disk, a CD (Compact Disc), a DVD (Digital Versatile Disc), a SD (Secure Digital) memory card, a USB (Universal Serial Bus) memory, or the like.

The ROM 15 is a nonvolatile semiconductor memory that can hold programs and data even after the power supply is stopped. The ROM 15 stores programs and data such as a BIOS (Basic Input/Output System) executed when the service providing system 10 is started, OS settings, network settings, and so forth.

The RAM 14 is a volatile semiconductor memory temporarily storing programs and data.

The CPU 16 controls the entirety of the service providing system 10 and implements various functions, by reading programs and data from storage devices such as the ROM 15, HDD 18, and so forth, to RAM 14 and carrying out processes.

The service providing system 10 and the PC terminals 30 according to the present embodiment implement various processes that will be described below with the hardware configurations illustrated in FIG. 2.

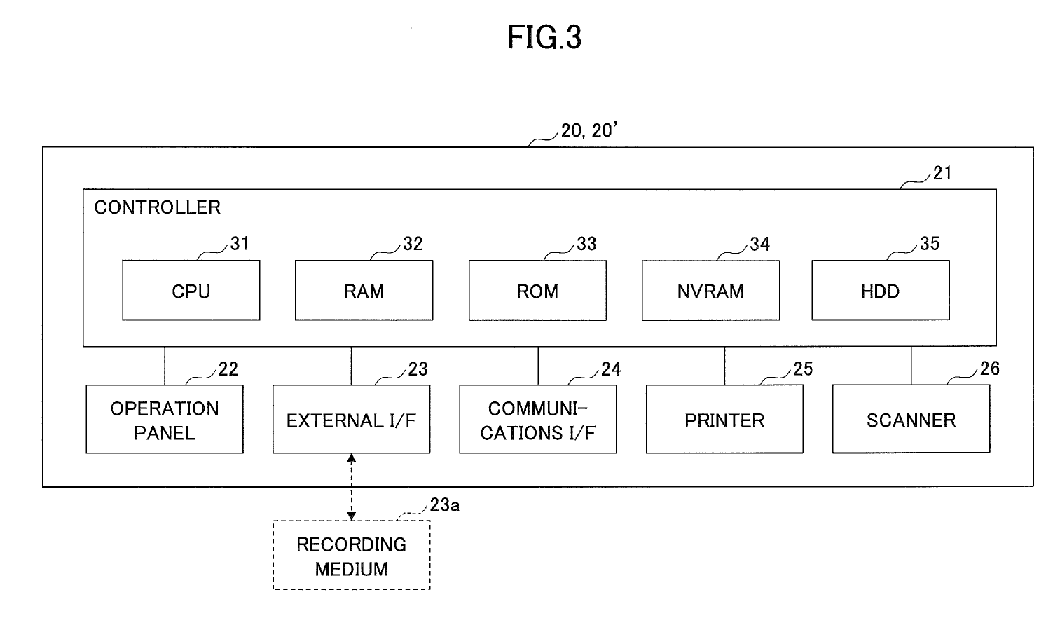

Hardware configuration of the apparatuses 20 included in the information processing system 1 according to the present embodiment in a case where the apparatuses 20 are image forming apparatuses will now be described with reference to FIG. 3. FIG. 3 illustrates hardware configurations of examples of the apparatuses 20 according to the present embodiment.

The apparatus 20 illustrated in FIG. 3 includes a controller 21, an operation panel 22, an external I/F 23, a communications I/F 24, a printer 25, and a scanner 26. The controller 21 includes a CPU 31, a RAM 32, a ROM 33, a NVRAM (Non-Volatile RAM) 34, and a HDD 35.

The ROM 33 is a nonvolatile semiconductor memory storing various programs and data. The RAM 32 is a volatile semiconductor memory temporarily storing programs and data. The NVRAM 34 stores, for example, setting information. The HDD 35 is a nonvolatile storage device storing various programs and data.

The CPU 31 controls the entirety of the apparatus 20 and implements functions, by reading programs, data, setting information, and so forth, from the ROM 33, the NVRAM 34, the HDD 35, and so forth, to the RAM 32 and carrying out processes.

The operation panel 22 includes an input unit for receiving user's inputs; and a display unit displaying information. The external I/F 23 is an interface for connecting to external devices. The external devices include a recording medium 23a. The apparatus 20 reads information from and writes information to the recording medium 23a via the external I/F 23. The recording medium 23a may be, for example, an IC (Integrated Circuit) card, a flexible disk, a CD, a DVD, a SD memory card, a USB memory, or the like.

The communications I/F 24 is an interface to connect the apparatus 20 with the network N1. The apparatus 20 carries out communications via the communications I/F 24. The printer 25 prints print data. The scanner 26 is a reading device that reads an original image and generates an electronic file (i.e., an image file).

The apparatus 20 according to the present embodiment implements various processes that will be described later with the hardware configuration illustrated in FIG. 3.

### <Services Provided by Service Providing System>

Services provided by the service providing system 10 according to the present embodiment will now be described. According to the present embodiment, it is assumed that the apparatus 20 is an image forming apparatus.

The service providing system 10 according to the present embodiment provides a service in which receipts placed on a platen (i.e., the scanner 26) of the apparatus 20 are scanned, and a corresponding image file is generated; areas that include the receipts are extracted from the image file, and corresponding receipt image files are generated; and the receipt image files are registered in an expense reimbursement service.

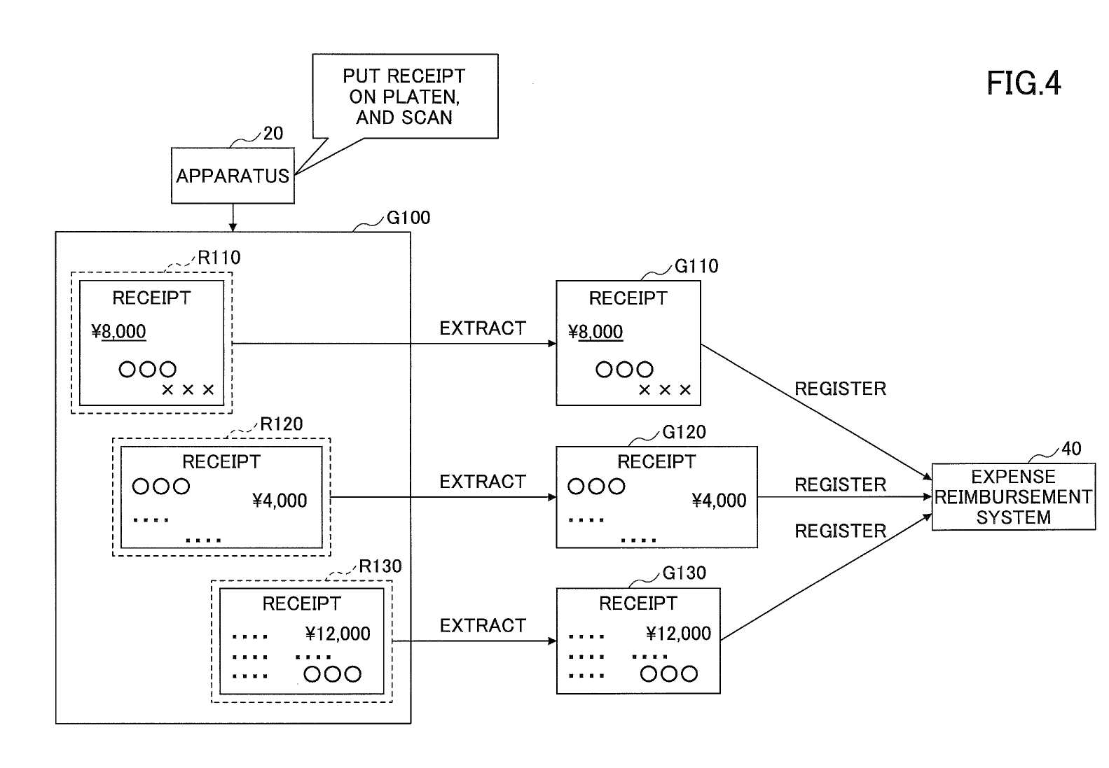

That is, as illustrated in FIG. 4, the service providing system 10 according to the present embodiment scans, for example, three receipts, to generate a scanned image file G100, and extracts areas R110-R130 including the respective receipts to generate receipt image files G110-G130. Then, the service providing system 10 according to the present embodiment registers the generated receipt image files G110-G130 in an expense reimbursement service.

Now, description will be made assuming that the above-described service (hereinafter, simply referred to as a “receipt registration service”) is provided.

However, services provided by the service providing system 10 are not limited to receipt registration services. The service providing system 10 may also provide such another service that, for example, an OCR process or an enciphering process is carried out on receipt image files generated as a result of areas of images of receipts being extracted from a scanned image file; and the receipt image files on which the OCR process or the enciphering process is carried out are registered in an expense reimbursement service.

### <Functional Configuration>

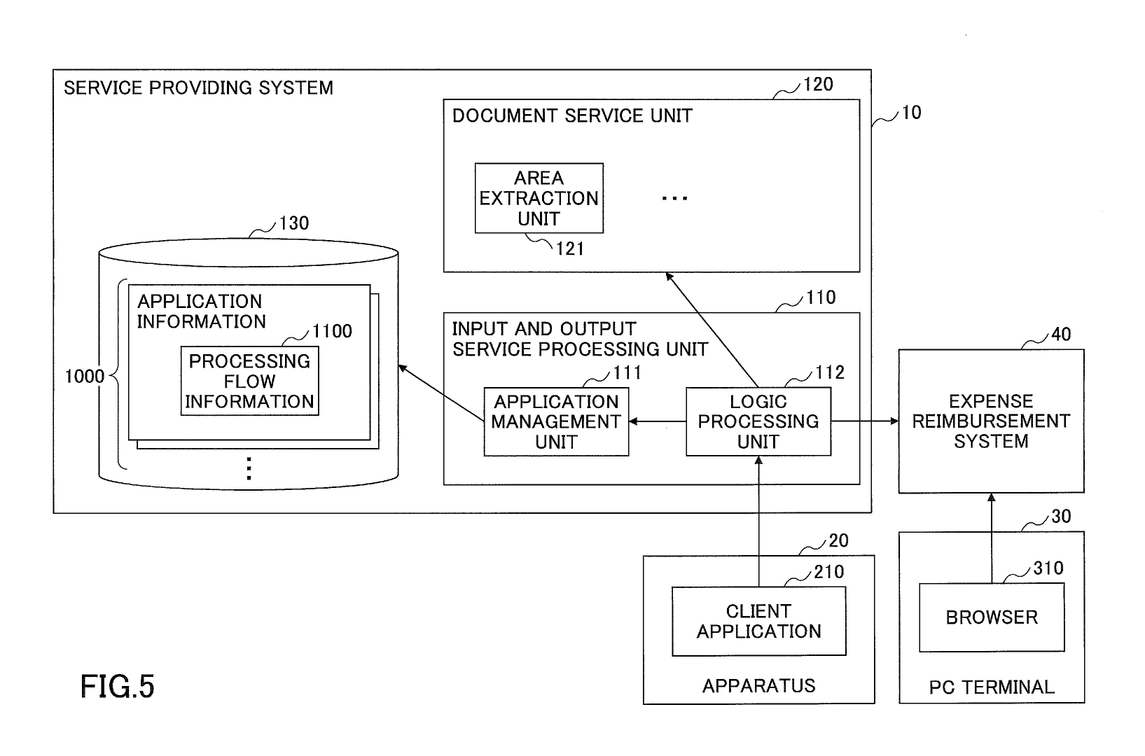

A functional configuration of the information processing system 1 according to the present embodiment will now be described with reference to FIG. 5. FIG. 5 illustrates a functional configuration of one example of the information processing system 1 according to the present embodiment.

The apparatus 20 illustrated in FIG. 5 includes a client application 210 executed by, for example, the CPU 31, and so forth. The client application 210 is an application program for a user to use a service provided by the service providing system 10. The user can use the receipt registration service provided by the service providing system 10 using the client application 210 installed in the apparatus 20.

The PC terminal 30 illustrated in FIG. 5 includes a browser 310 implemented by, for example, the CPU 16, and so forth. A user of the PC terminal 30 can use an expense reimbursement service provided by the expense reimbursement system 40 through the browser 310.

The service providing system 10 illustrated in FIG. 5 includes an input and output service processing unit 110 and a document service unit 120. These functional units are implemented by processes carried out by the CPU 16 according to one or more programs installed in the service providing system 10.

Also, the service providing system 10 illustrated in FIG. 5 includes an application information storage unit 130. The application information storage unit 130 can be implemented by the HDD 18. The application information storage unit 130 may also be implemented by a storage device connected with the service providing system 10 via the network N1, or the like.

The input and output service processing unit 110 carries out processes concerning services provided by the service providing system 10. The input and output service processing unit 110 includes an application management unit 111 and a logic processing unit 112.

The application management unit 111 manages application information 1000 stored in an application information storage unit 130. The application information 1000 includes applications for providing services implemented by sequences of processes. That is, the application information 1000 provides various services (for example, the receipt registration service) provided by the service providing system 10.

In response to a request from the logic processing unit 112, the application management unit 111 returns processing flow information 1100 included in the application information 1000. The processing flow information 1100 is information in which sequences of processes for implementing services provided by the application information 1000 are defined.

In response to a request from the client application 210, the logic processing unit 112 acquires a set of processing flow information 1100 included in the application information 1000 through the application management unit 111. Then, the logic processing unit 112 carries out a sequence of processes (i.e., a processing flow) for implementing a service provided by the application information 100 based on the set of processing flow information 1100 acquired through the application management unit 111. Thus, the service providing system 10 according to the present embodiment provides various services (for example, the receipt registration service).

The document service unit 120 carries out processes included in a sequence of processes (a processing flow) based on the set of processing flow information 1100. The document service unit 120 includes an area extraction unit 121.

The area extraction unit 121 extracts areas (for example, areas including images of receipts) from a scanned image file, to generate one or more image files (for example, receipt image files). The area extraction unit 121 extracts the areas by using image processing technology, such as template matching technology, for example.

The document service unit 120 may also include, for example, an enciphering/deciphering unit that enciphers and deciphers electronic files; a compressing/decompressing unit that compresses and decompresses electronic files; an OCR processing unit that carries out an OCR process on electronic files, or the like.

Thus, the document service unit 120 includes various functional units to carry out processes included in a sequence of processes (a processing flow). Therefore, the document service unit 120 is implemented by a group of programs (modules) for providing various functions.

The application information 1000 is stored in the application information storage unit 130 in a state of being associated with application IDs that identify respective sets of the application information 1000. It is also possible that the respective sets of the application information 1000 are associated with application names.

For example, a set of application information 1000 for providing the receipt registration service includes a set of processing flow information 1100 in which a sequence of processes to implement the receipt registration service are defined.

Note that a set of application information 1000 may include two or more sets of processing flow information 1100.

As described above, in a set of processing flow information 1100, a sequence of processes (i.e., a processing flow) to implement a service to be provided by the application information 1000 are defined. Such a set of processing flow information 1100 will be described later in detail.

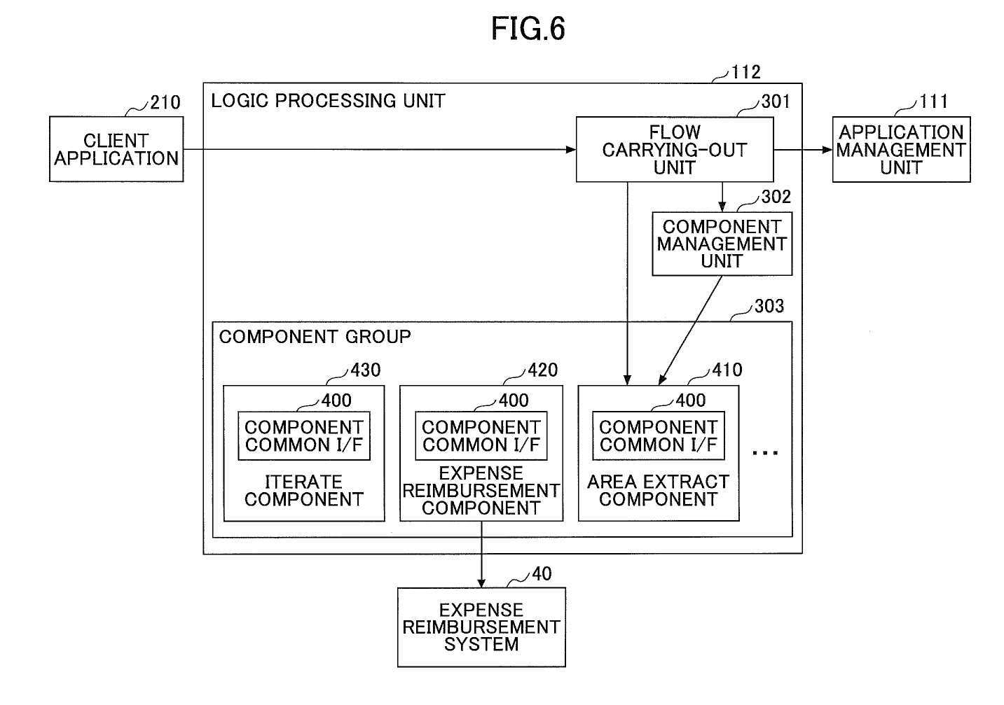

A detailed functional configuration of the logic processing unit 112 will now be described with reference to FIG. 6. FIG. 6 illustrates one example of a functional configuration of the logic processing unit 112 according to the present embodiment. The logic processing unit 112 illustrated in FIG. 6 includes a flow carrying-out unit 301, a component management unit 302, and a component group 303.

The flow carrying-out unit 301 responds to a request from the client application 210, to acquire a set of processing flow information 1100 included in the application information 1000 through the application management unit 111. Then, the flow carrying-out unit 301 carries out a sequence of processes (i.e., a processing flow) based on the set of processing flow information 1100 acquired from the application management unit 111.

The sequence of processes (i.e., the processing flow) based on the set of processing flow information 1100 are carried out as a result of components for carrying out the respective processes included in the sequence of processes being combined. The components are implemented by programs or modules for implementing functions, and defined by, for example, classes, functions, and so forth.

The component management unit 302 manages the components. The component management unit 302 responds to a request from the flow carrying-out unit 301 to generate a component, and return the generated component to the flow carrying-out unit 301. Generating a component means loading the component defined by, for example, classes, functions, and so forth, in a memory (for example, the RAM 14).

The component group 303 is a collection of components. The component group 303 includes an area extract component 410, an expense reimbursement component 420, and an iterate component 430.

The area extract component 410 generates receipt image files. That is, the area extract component 410 requests the area extraction unit 121 of the document service unit 120 to carry out a process to extract areas including images of receipts from a scanned image file, and generates receipt image files.

The expense reimbursement component 420 transmits various requests to the expense reimbursement system 40. That is, the expense reimbursement component 420 requests the expense reimbursement system 40 to generate a ledger in which receipt image files will be registered. Also, the expense reimbursement component 420 requests registration of the receipt image files in the ledger.

The iterate component 430 iteratively carries out one or more processes. That is, the iterate component 430 iteratively carries out one or more processes by iteratively carrying out a sequence of processes (i.e., a processing flow) including the one or more processes several times.

The component group 303 may further include various components such as, for example, a compression component for compressing electronic files, a conversion components for converting the data formats of electronic files, and so forth.

Each of the components included in the component group 303 has a component common I/F 400. The component common I/F 400 includes APIs (Application Program Interface) defined for the respective components, including an API for generating the components and an API for carrying out the processes of the components.

It is possible that the component management unit 302 generates the respective components included in the component group 303 using the component common I/F 400 when, for example, the service providing system 10 is started.

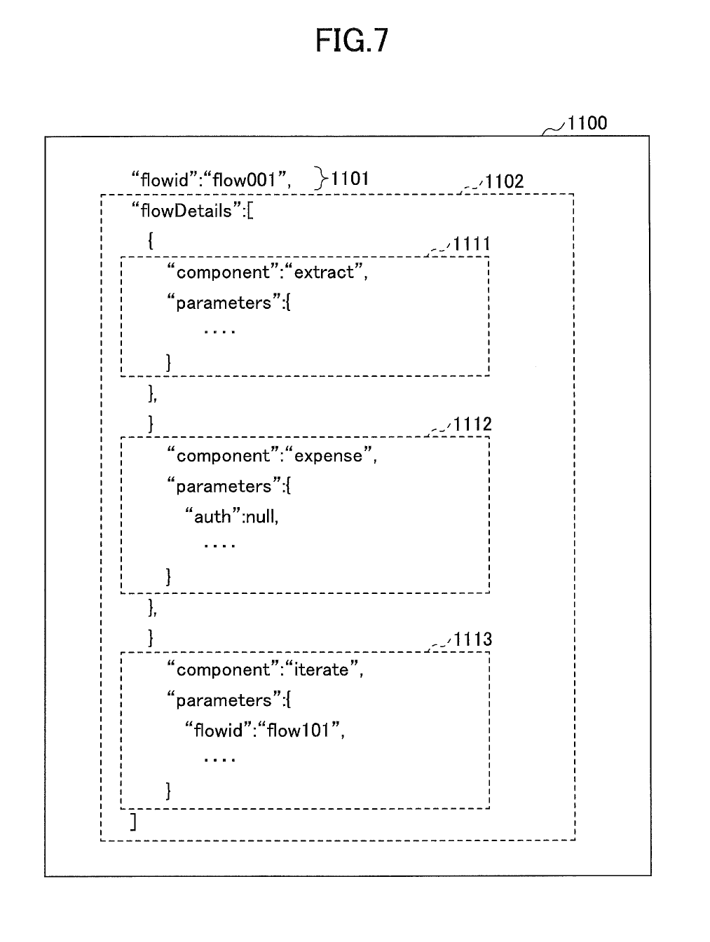

A set of processing flow information 1100 in which ha sequence of processes (i.e., a processing flow) for implementing a receipt registration service according to the present embodiment are defined will be described with reference to FIG. 7. FIG. 7 illustrates one example of a set of processing flow information 1100 in which a sequence of processes to implement a receipt registration service are defined.

The set of processing flow information 1100 illustrated in FIG. 7 includes a flow ID 1101 identifying the set of processing flow information 1100, and a flow detail 1102 in which the process contents of each of the processes included in the processing flow are defined.

The flow detail 1102 includes processing definitions 1111-1113 in which the process contents of the processes included in the processing flow are defined. Each of the processing definitions 1111-1113 includes “component” indicating a component name of the component for carrying out the process, and “parameters” defining parameter information for the component.

Actually, for “component” of the processing definition 1111, the component name “extract” of the area extract component 410 is defined. For “parameters” of the processing definition 1111, parameter information for the area extract component 410 is defined.

Note that, one example of the parameter information for the area extract component 410 is parameter information (for example, an image file of a receipt to be extracted) for identifying an area to be extracted.

In the same way, for “component” of the processing definition 1112, the component name “expense” of the expense reimbursement component 420 is defined. Also, for “parameters” of the processing definition 1112, parameter information for the expense reimbursement component 420 is defined. For the “parameters” of the processing definition 1112, parameter information ‘“auth”: null’ for setting authentication information (for example, a user name, a password, or an access token) or the like for using the expense reimbursement system 40, or the like, is defined.

Another example of the parameter information for the expense reimbursement component 420 is parameter information for setting a request (for example, a ledger generation request) to be sent to the expense reimbursement system 40.

In the same way, for “component” of the processing definition 1113, the component name “iterate” of the iterate component 430 is defined. For “parameters” of the processing definition 1113, parameter information for the iterate component 430 is defined.

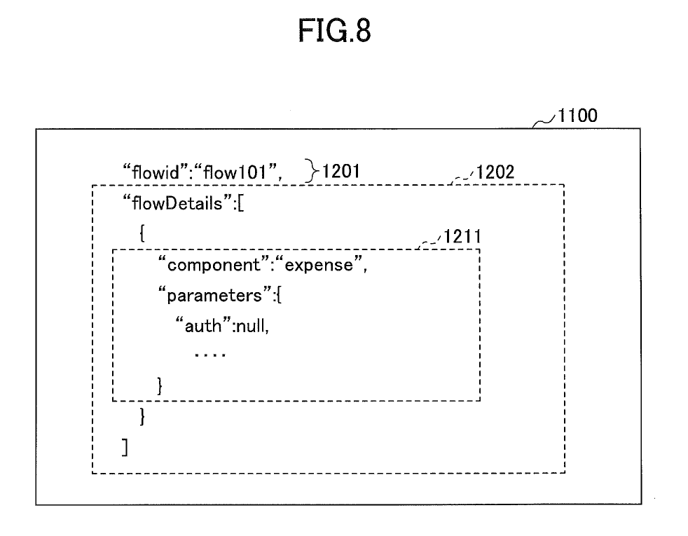

For the “parameters” of the processing definition 1113, parameter information indicating a flow ID ‘“flowid”: “flow101”’ of a set of processing flow information 1100 defining a sequence of processes to be iteratively carried out by the iterate component 430 is defined. The set of processing flow information 1100 having the flow ID “flow101” will be described later with reference to FIG. 8.

Another example of the parameter information for the iterate component 430 is parameter information for setting the number of times (iterative number of times) for which a sequence of processes is iteratively carried out by the iterate component 430.

Thus, in the set of processing flow information 1100, the components that carry out respective processes included in the sequence of processes, and the parameter information for the components are defined. Note that the order in which the processes defined in the respective processing definitions will be carried out is the order of the processing definitions that are described in the flow details 1102. That is, concerning the sequence of processes (the processing flow) based on the set of processing flow information 1100 illustrated in FIG. 7, the process will be carried out in such an order that, first, the processes defined in the processing definition 1111, then, the processes defined in the processing definition 1112, and then, the processes defined in the processing definition 1113, will be carried out. However, the actual method of indicating the order of carrying out the processes is not limited to this manner. For example, it is also possible that a set of processing flow information 1100 includes information indicating the order of carrying out the processes defined in the respective processing definitions.

Thus, the area extract component 410 generates one or more receipt image files by extracting areas of images of receipts included in a scanned image file. The expense reimbursement component 420 generates a ledger in which receipt image files are to be registered, in the expense reimbursement system 40.

The processing definition 1113 of the set of processing flow information 1100 illustrated in FIG. 7 defines that the iterate component 430 will iteratively carry out a sequence of processes based on a set of processing flow information 1100 identified by the flow ID “flow101”. The set of processing flow information 1100 having the flow ID “flow101” will now be described with reference to FIG. 8. FIG. 8 illustrates one example of a set of processing flow information 1100 defining a sequence of processes to be iteratively carried out, during a sequence of processes implementing a receipt registration service.

The set of processing flow information 1100 illustrated in FIG. 8 includes a flow ID 1201 and a flow detail 1202.

The flow details 1202 include a processing definition 1211. The processing definition 1211 includes “component” indicates the component name of the component carrying out the process, and “parameters” defining parameter information for the component.

Actually, for “component” of the processing definition 1211, the expense reimbursement component 420 having the component name “expense” is defined. For “parameters” of the processing definition 1211, parameter information for the expense reimbursement component 420 is defined.

For “parameters” of the processing definition 1211, parameter information ‘“auth”: null’ for setting authentication information (for example, a user name, a password, or an access token) or the like for using the expense reimbursement system 40 is defined.

Another example of the parameter information for the expense reimbursement component 420 is parameter information for setting a request (for example, a receipt image file registration request) to be sent to the expense reimbursement system 40.

Thus, the iterate component 430 can register one or more receipt image files in the expense reimbursement system 40 by the expense reimbursement component 420 through iteratively carrying out the sequence of processes based on the set of processing flow information 1100 illustrated in FIG. 8.

### <Process Detail>

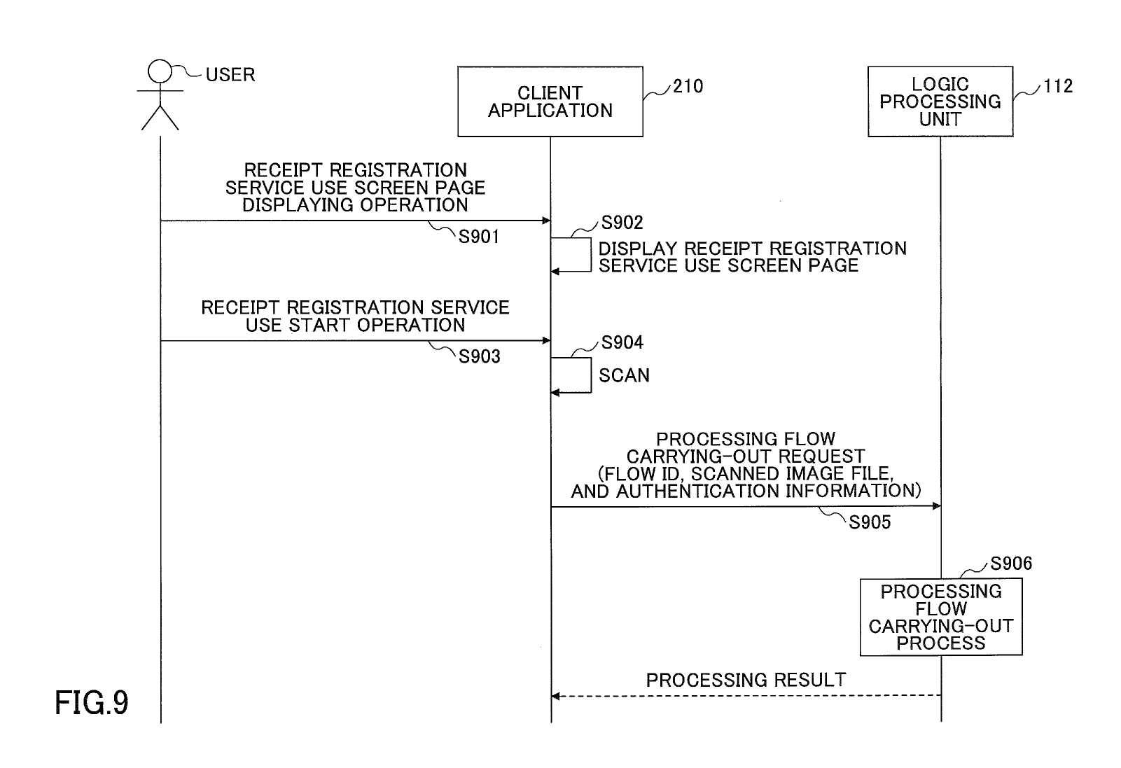

Next, processes of the information processing system 1 according to the present embodiment will be described in detail. First, a process where the user of the apparatus 20 uses a receipt registration service to register receipt image files (i.e., image files of receipts) in the expense reimbursement system 40 will be described with reference to FIG. 9. FIG. 9 is a sequence diagram illustrating one example of an overall process carried out when a user uses a receipt registration service according to the present embodiment.

First, the user uses the apparatus 20 and performs a receipt registration service use screen page displaying operation to display a receipt registration service use screen page (step S901). Then, the client application 210 of the apparatus 20 receives the operation to display the receipt registration service use screen page. Note that, an operation to display the receipt registration service use screen page is, for example, an operation to start the client application 210.

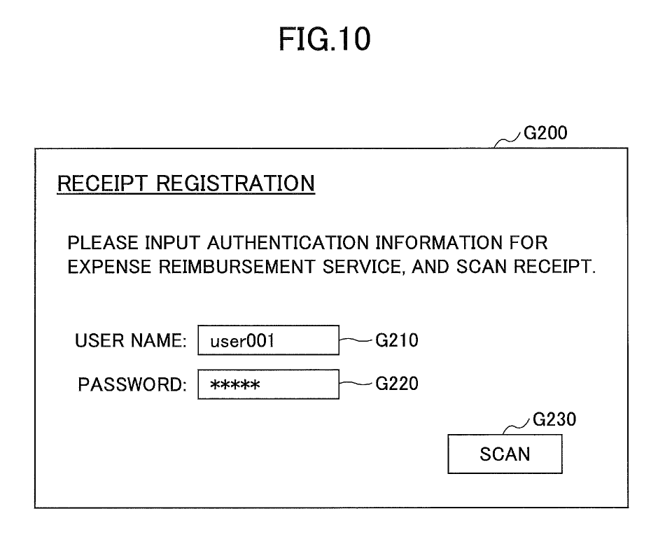

After receiving the user's operation to display the receipt registration service use screen page, the client application 210 displays the receipt registration service use screen page G200, for example, illustrated in FIG. 10 (step S902).

The receipt registration service use screen page G200 illustrated in FIG. 10 includes a user name input field G210, a password input field G220, and a scanning button G230. The user name input field G210 and the password input field G220 are used for inputting a user name and a password, respectively, concerning an expense reimbursement service as examples of authentication information for using the expense reimbursement service. The scanning button G230 is a display component for scanning a receipt to generate a scanned image file.

Then, the user uses the apparatus 20 and performs a receipt registration service use start operation to start using a receipt registration service (step S903). That is, the user sets, on the scanner 26 of the apparatus 20, one or more receipts, and inputs the user name and the password to the user name input field G210 and the password input field G220, respectively, of the receipt registration service use screen page G200 illustrated in FIG. 10. Then, the user presses the scanning button G230, and thus, performs the receipt registration service use start operation. Then, the client application 210 receives the receipt registration service use start operation. In this regard, the user can set various types of pieces of paper for evidence usable as evidence for expenses, instead of receipts, on the scanner 26. Receipts to be set on the scanner 26 may be such a kind of receipts that are pieces of paper and output from a cash register, or the like. For convenience, such a kind of receipts that are pieces of paper and output from a cash register, or the like, will be referred to as “simple receipts”, hereinafter.

After receiving the receipt registration service use start operation performed by the user, the client application 210 reads the respective receipts placed on the scanner 26, and generates a scanned image file including areas where the respective receipts appear (step S904).

Thus, the apparatus 20 according to the embodiment generates the image file (the scanned image file) by reading the receipt placed on the scanner 26. However, an actual method of generating such an image file is not limited to this method. For example, if the apparatus 20 is a digital camera, a smartphone, a tablet terminal, or the like, the apparatus 20 may generate the image file by photographing the receipts.

Then, the client application 210 transmits a processing flow carrying-out request to the logic processing unit 112 (step S905). The processing flow carrying-out request includes the flow ID “flow001” of the set of processing flow information 1100 for implementing a receipt registration service according to the embodiment, the scanned image file, and authentication information (that is, the user name and the password).

The flow ID “flow001” has been associated with, for example, the scanning button G230 of the receipt registration service use screen page G200. However, it is also possible that the flow ID “flow001” has been associated with, for example, the receipt registration service use screen page G200.

After receiving the processing flow carrying-out request, the logic processing unit 112 carries out the processing flow (step S906). That is, the logic processing unit 112 carries out a sequence of processes based on the set of processing flow information 1100 identified by the flow ID “flow001” included in the processing flow carrying-out request.

After thus carrying out the processing flow, the logic processing unit 112 returns a processing result of the processing flow that has been carried out. Thus, the service providing system 10 according to the present embodiment provides the receipt registration service to the apparatus 20.

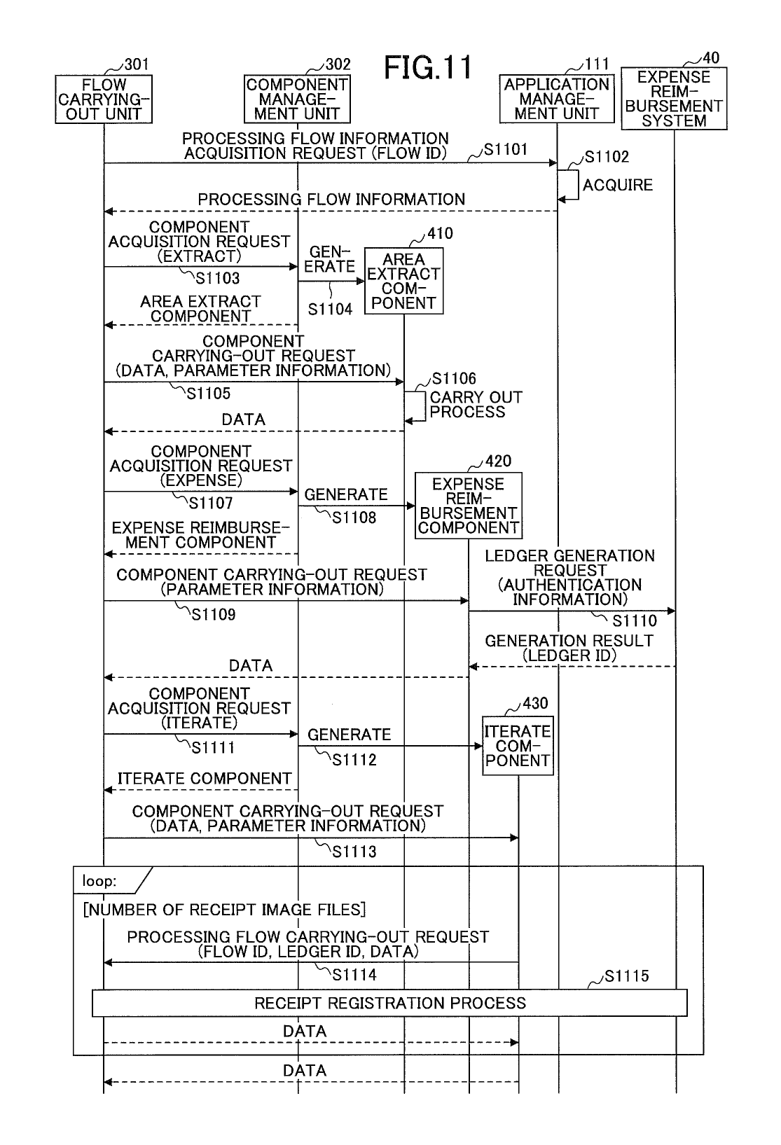

Details of step S906 to carry out the processing flow illustrated in FIG. 9 will now be described with reference to FIG. 11. FIG. 11 is a sequence diagram illustrating one example of a processing flow to implement a receipt registration service according to the present embodiment.

First, after receiving the processing flow carrying-out request from the client application 210, the flow carrying-out unit 301 transmits a processing flow information acquisition request to the application management unit 111 (step S1101). Note that, the processing flow information acquisition request includes the flow ID “flow001” acquired from the processing flow carrying-out request.

After receiving the processing flow information acquisition request, the application management unit 111 acquires the set of processing flow information 1100 identified by the flow ID “flow001” included in the processing flow information acquisition request, from the application information 1000 stored in the application information storage unit 130 (step S1102). That is, the application management unit 111 acquires the set of processing flow information 1100 illustrated in FIG. 7 from the application information storage unit 130.

Then, the application management unit 111 returns the set of processing flow information 1100 acquired from the application information storage unit 130 to the logic processing unit 112.

The flow carrying-out unit 301 transmits a component acquisition request based on the set of processing flow information 1100 illustrated in FIG. 7 to the component management unit 302 (step S1103). That is, the flow carrying-out unit 301 transmits a component acquisition request having the component name “extract” defined for “component” of the processing definition 1111 of the set of processing flow information 1100 illustrated in FIG. 7 to the component management unit 302.

After receiving the component acquisition request, the component management unit 302 generates a component having the component name “extract” (that is, the area extract component 410) (step S1104). Generating the area extract component 410 can be implemented by using the API prepared for generating components defined in the component common I/F 400. Then, the component management unit 302 returns the generated area extract component 410 to the flow carrying-out unit 301. That is, the component management unit 302 returns, for example, an address at which the area extract component 410 is loaded in a memory (for example, the RAM 14), to the flow carrying-out unit 301.

Then, the flow carrying-out unit 301 transmits a component carrying-out request to the area extract component 410 (step S1105).

The component carrying-out request includes data. The data included in the component carrying-out request is the scanned image file included in the processing flow carrying-out request received from the client application 210. Thus, the flow carrying-out unit 301 transmits electronic data such as an image file simply as “data” (without paying attention to the data format) to each component.

The component carrying-out request also includes each set of parameter information defined for “parameters” of the processing definition 1111 of the set of processing flow information 1100 illustrated in FIG. 7.

After receiving the component carrying-out request, the area extract component 410 carries out a process on the data included in the component carrying-out request according to the parameter information (step S1106). That is, the area extract component 410 uses the area extraction unit 121 of the document service unit 120 to extract the areas of images of the receipts included in the scanned image file, and generates receipt image files. If the scanned image file includes a plurality of the areas of images of the receipts, the area extract component 410 extracts each of the plurality of areas of images of the receipts, to generate the respective receipt image files.

If an area where a “simple receipt” appears is included in the scanned image file, the area extract component 410 extracts the area where the simple receipt appears to generate a simple receipt image file. In this case, the receipt registration service registers the simple receipt image file in the expense reimbursement system 40.

If the area of the image of the receipt included in the scanned image file is inclined, or the like, the area is rotated to correct the inclination, or the like, then, is extracted. Thereafter, the receipt image file is generated.

Then, the area extract component 410 returns data indicating the receipt image files to the flow carrying-out unit 301.

Then, the flow carrying-out unit 301 transmits a component acquisition request based on the set of processing flow information 1100 illustrated in FIG. 7 to the component management unit 302 (step S1107). That is, the flow carrying-out unit 301 transmits the component acquisition request having the component name “expense” defined for “component” included in the processing definition 1112 of the set of processing flow information 1100 to the component management unit 302.

After receiving the component acquisition request, the component management unit 302 generates a component having the component name “expense” (that is, the expense reimbursement component 420) (step S1108). Generating the expense reimbursement component 420 can be implemented by using the API prepared for generating components defined in the component common I/F 400.

Then, the component management unit 302 returns the generated expense reimbursement component 420 to the flow carrying-out unit 301. That is, the component management unit 302 returns, for example, an address at which the expense reimbursement component 420 is loaded in a memory (for example, the RAM 14), to the flow carrying-out unit 301.

Then, the flow carrying-out unit 301 transmits a component carrying-out request to the expense reimbursement component 420 (step S1109). The component carrying-out request includes each set of parameter information defined for “parameters” included in the processing definition 1112 of the set of processing flow information 1100 illustrated in FIG. 7.

That is, the component carrying-out request includes parameter information in which authentication information is set to parameter information ‘“auth”: null’. For example, if the user name “user001” and the password “abcde” have been input to the user name input field G210 and the password input field G220, respectively, of the receipt registration service use screen page G200, the parameter information included in the component carrying-out request has the contents ‘“auth”: “user001/abcde”’.

The component carrying-out request also includes parameter information for transmitting a ledger generation request to the expense reimbursement system 40.

After receiving the component carrying-out request, the expense reimbursement component 420 carries out a process according to the parameter information (step S1110). That is, the expense reimbursement component 420 transmits a ledger generation request to the expense reimbursement system 40. The expense reimbursement component 420 can transmit the ledger generation request, by using, for example, a WebAPI disclosed by the expense reimbursement system 40. The ledger generation request also includes the authentication information.

Then, the expense reimbursement system 40 generates a ledger to register the receipt image files, and returns a ledger ID for identifying the generated ledger to the expense reimbursement component 420 as the processing result. Then, the expense reimbursement component 420 returns data indicating the ledger ID to the flow carrying-out unit 301.

Thus, the expense reimbursement component 420 generates the ledger for registering the receipt image files in an expense reimbursement service by requesting the expense reimbursement system 40 to generate the ledger.

Then, the flow carrying-out unit 301 transmits a component acquisition request based on the set of processing flow information 1100 illustrated in FIG. 7 to the component management unit 302 (step S1111). That is, the flow carrying-out unit 301 transmits the component acquisition request for the component having the component name “iterate” defined for “component” included in the processing definition 1113 of the set of processing flow information 1100 illustrated in FIG. 7 to the component management unit 302.

After receiving the component acquisition request, the component management unit 302 generates a component having the component name “iterate” (that is, the iterate component 430) (step S1112). Generating the iterate component 430 can be implemented by using the API prepared for generating components defined in the component common I/F 400.

Then, the component management unit 302 returns the generated iterate component 430 to the flow carrying-out unit 301. That is, the component management unit 302 returns, for example, an address at which the iterate component 430 is loaded in a memory (for example, the RAM 14), to the flow carrying-out unit 301.

Then, the flow carrying-out unit 301 transmits a component carrying-out request to the iterate component 430 (step S1113).

Note that, the component carrying-out request includes data indicating the receipt image files generated by the area extract component 410. Therefore, if the area extract component 410 generates a plurality of the receipt image files, the component carrying-out request includes the corresponding sets of data indicating the respective receipt image files.

Also, the component carrying-out request includes each set of parameter information defined for “parameters” included the processing definition 1113 of the set of processing flow information 1100 illustrated in FIG. 7. That is, the component carrying-out request includes parameter information ‘“flowid”: “flow101”’ and parameter information indicating the ledger ID returned in step S1110.

After receiving the component carrying-out request, the iterate component 430 transmits a processing flow carrying-out request to the flow carrying-out unit 301 for each set of data included in the component carrying-out request (that is, for each receipt image file) (step S1114). That is, the iterate component 430 carries out the receipt registration process of step S1115 iteratively for the number of times equal to the number of the receipt image files. Note that, the processing flow carrying-out request includes data (that is, the receipt image file), the flow ID “flow101”, and the ledger ID.

After receiving the processing flow carrying-out request, the flow carrying-out unit 301 carries out, concerning the expense reimbursement service, a process for registering the receipt image file in the ledger identified by the ledger ID (i.e., a receipt registration process) (step S1115). Then, the flow carrying-out unit 301 returns the processing result of the receipt registration process to the iterate component 430.

Thereafter, the iterate component 430 returns data indicating a processing result of iteratively carrying-out the receipt registration process of step S1115 to the flow carrying-out unit 301.

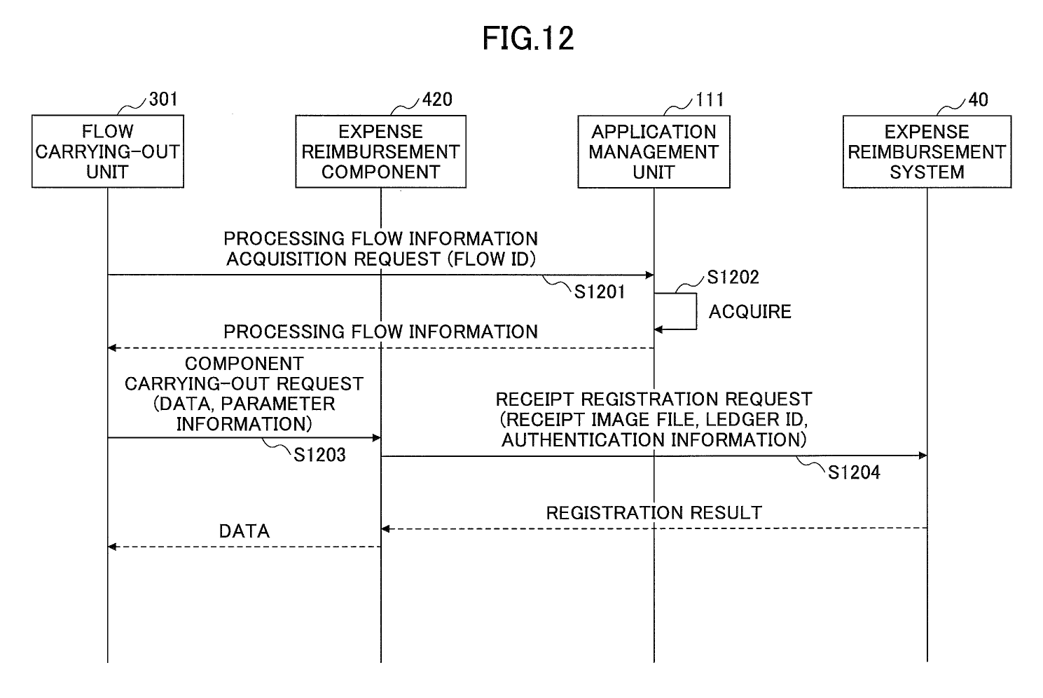

Details of the receipt registration process (i.e., step S1115) will now be described with reference to FIG. 12. FIG. 12 is a sequence diagram illustrating one example of a receipt registration process according to the present embodiment. First, after receiving the processing flow carrying-out request from the iterate component 430, the flow carrying-out unit 301 transmits a processing flow information acquisition request to the application management unit 111 (step S1201). The processing flow information acquisition request includes the flow ID “flow101” received from the processing flow carrying-out request.

After receiving the processing flow information acquisition request, the application management unit 111 acquires the set of processing flow information 1100 identified by the flow ID “flow101” included in the processing flow information acquisition request, from the application information 1000 stored in the application information storage unit 130 (step S1202). That is, the application management unit 111 acquires the set of processing flow information 1100 illustrated in FIG. 8 from the application information storage unit 130.

Then, the application management unit 111 returns the set of processing flow information 1100 acquired from the application information storage unit 130 to the logic processing unit 112.

Then, the flow carrying-out unit 301 transmits a component carrying-out request to the component having the component name “expense” defined for “component” included in the processing definition 1211 of the set of processing flow information 1100 illustrated in FIG. 8 (step S1203). That is, the flow carrying-out unit 301 transmits the component carrying-out request to the expense reimbursement component 420.

The component carrying-out request includes data (that is, the receipt image file). Also, the component carrying-out request includes parameter information in which authentication information is set to parameter information ‘“auth”: null’; parameter information for requesting the expense reimbursement system 40 to register the receipt; and parameter information indicating the ledger ID.

After receiving the component carrying-out request, the expense reimbursement component 420 carries out a process according to the data and the parameter information (step S1204). That is, the expense reimbursement component 420 transmits a receipt registration request to the expense reimbursement system 40. The expense reimbursement component 420 can transmit the receipt registration request by using, for example, a WebAPI disclosed by the expense reimbursement system 40. Also, the receipt registration request includes the receipt image file, the ledger ID, and the authentication information.

Then, the expense reimbursement system 40 registers the receipt image file in the ledger identified by the ledger ID, and returns the registration result to the expense reimbursement component 420. Then, the expense reimbursement component 420 returns data indicating the registration result to the flow carrying-out unit 301.

Thus, the expense reimbursement component 420 can register the receipt image file in the ledger concerning the expense reimbursement service by requesting the expense reimbursement system 40 to register the receipt.

In this regard, as a result of the receipt image file being registered in the ledger concerning the expense reimbursement service, receipt data corresponding to the receipt image file is registered in the ledger. The receipt data includes, for example, items such as an account item, a date, and so forth. The respective items (for example, an item value of the account item, an item value of the date, and so forth) that are to be set in the receipt data may be acquired from, for example, carrying out an OCR process on the receipt image file.

According to the present embodiment described above, the service providing system 10 extracts areas of images of receipts included in a scanned image file (see step S1106 of FIG. 11). However, it is also possible that the apparatus 20 instead carries out the process of extracting areas of images of receipts included in a scanned image file. In this case, for example, in the sequence diagram of FIG. 9, after carrying out step S904, the apparatus 20 extracts areas of images of receipts included in a scanned image file to generate respective receipt image files, and transmits the processing flow carrying-out request including the receipt image files to the service providing system 10.

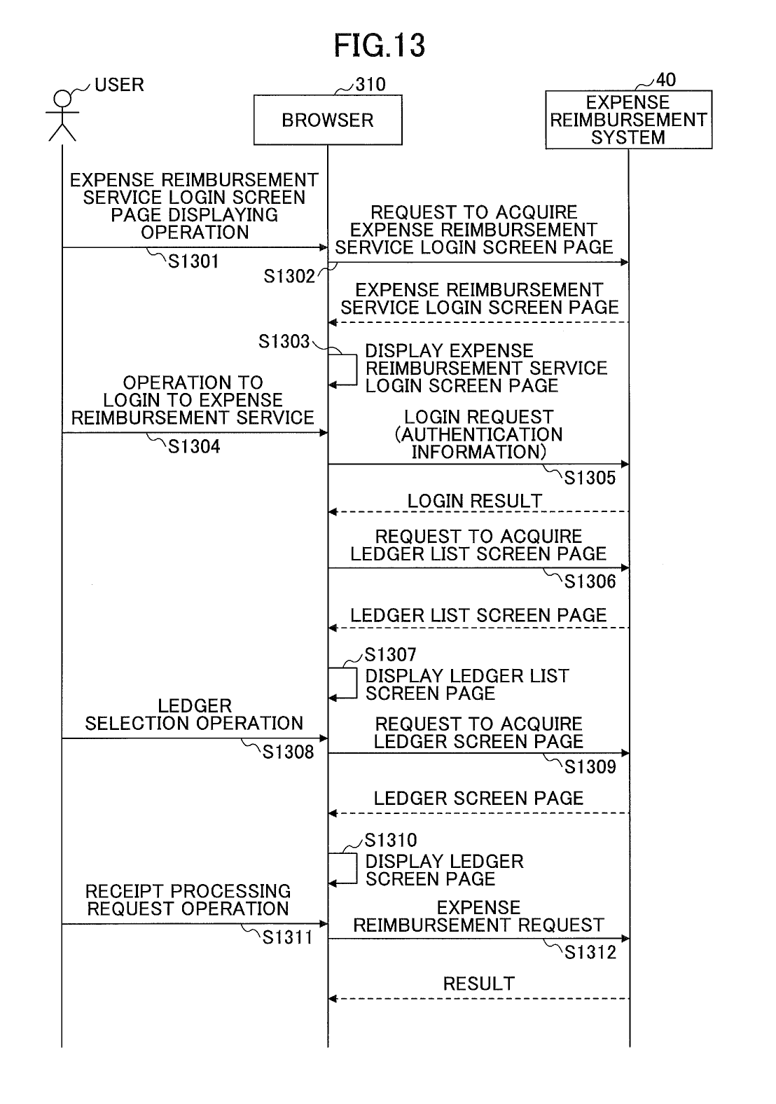

Next, a process carried out when the user of the PC terminal 30 uses an expense reimbursement service will be described with reference to FIG. 13. FIG. 13 is a sequence diagram illustrating one example of an overall process for using an expense reimbursement service according to the present embodiment.

First, the user uses the PC terminal 30 to perform an “expense reimbursement service login screen page displaying operation” (step S1301). Then, the browser 310 of the PC terminal 30 receives the expense reimbursement service login screen page displaying operation. For example, the user can perform the expense reimbursement service login screen page displaying operation by pressing a display component of a link for an expense reimbursement service login screen page in a certain screen page displayed by the browser 310. It is also possible that the user performs the expense reimbursement service login screen page displaying operation by, for example, inputting the URL (Uniform Resource Locator) of the expense reimbursement service login screen page in an address bar of the browser 310, or the like.

After receiving the user's expense reimbursement service login screen page displaying operation, the browser 310 transmits a request to acquire the expense reimbursement service login screen page to the expense reimbursement system 40 (step S1302). Then, the expense reimbursement system 40 returns screen page information (for example, information defining the expense reimbursement service login screen page in a HTML (HyperText Markup Language) format) for displaying the expense reimbursement service login screen page to the browser 310.

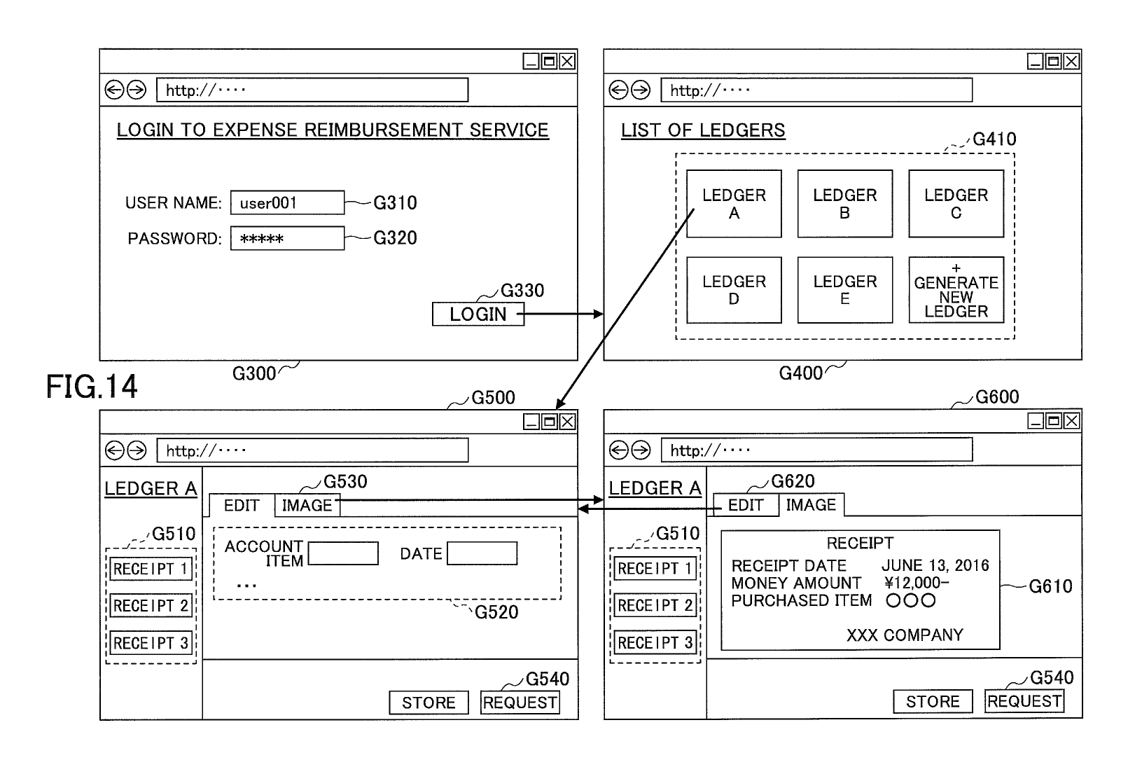

After receiving the screen page information for displaying the expense reimbursement service login screen page, the browser 310 displays the expense reimbursement service login screen page G300, for example, as illustrated in FIG. 14, based on the screen page information (step S1303).

The login screen page G300 illustrated in FIG. 14 includes a user name input field G310, a password input field G320, and a login button G330. The user name input field G310 and the password input field G320 are used to input, as an example of authentication information to be input for using an expense reimbursement service, a user name and a password for the expense reimbursement service. The login button G330 is a display component to be pressed for transmitting a login request to the expense reimbursement service.

Then, the user uses the PC terminal 30 to perform an operation to login to the expense reimbursement service (step S1304). That is, the user inputs the user name and the password in the user name input field G310 and the password input field G320, respectively, of the login screen page G300 illustrated in FIG. 14, and then, presses the login button G330 to perform the login operation. Then, the browser 310 receives the login operation.

After receiving the user's login operation, the browser 310 transmits a login request to the expense reimbursement system 40 (step S1305). The login request includes the authentication information (that is, the user name and the password that have been input in the user name input field G310 and the password input field G320, respectively).

Then, the expense reimbursement system 40 determines the validity of the authentication information included in the received login request, and returns the login result to the browser 310. Below, the description will be continued assuming that the login result indicating that the login is successful.

After receiving the login result, the browser 310 transmits a request to acquire a ledger list screen page to the expense reimbursement system 40 (step S1306). Then, the expense reimbursement system 40 returns screen page information (for example, information defining the ledger list screen page in a HTML format) for displaying the ledger list screen page.

After receiving the screen page information for displaying the ledger list screen page, the browser 310 displays the ledger list screen page G400, for example, as illustrated in FIG. 14, based on the screen page information (step S1307).

The ledger list screen page G400 illustrated in FIG. 14 includes a ledger list G410. The user can perform editing, or the like, of the receipt data that is registered in a ledger by selecting the desired ledger from the ledger list G410. Also, by selecting a “generate new ledger” icon included in the ledger list G410, the user can generate a new ledger.

Then, the user uses the PC terminal 30 to perform a ledger selection operation (step S1308). The user performs the ledger selection operation for selecting a desired ledger from the ledger list G410 in the ledger list screen page G400 illustrated in FIG. 14. Then, the browser 310 receives the ledger selection operation. Below, the description will be continued assuming that the user has selected the “ledger A” icon.

After receiving the user's selection operation, the browser 310 transmits a request to acquire a ledger screen page for the select “ledger A” to the expense reimbursement system 40 (step S1309). Then, the expense reimbursement system 40 returns screen page information (for example, information defining the ledger screen page in a HTML format) for displaying the ledger screen page for “ledger A” to the browser 310.

After receiving the screen page information for displaying the ledger screen page for “ledger A”, the browser 310 displays the ledger screen page G500 based on the screen page information, for example, as illustrated in FIG. 14 (step S1310).

The ledger screen page G500 illustrated in FIG. 14 includes a receipt list G510, a receipt editing field G520, a switching tab G530, and a request button G540. The user can input or edit the receipt data (for example, an account item, a date, and so forth) in the receipt editing field G520, after selecting the desired receipt from the receipt list G510.

Also, in the ledger screen page G500 illustrated in FIG. 14, if the user presses the switching tab G530, the browser 310 receives the user's pressing operation, and switches the displayed screen page to a ledger screen page G600 illustrated in FIG. 14.

The ledger screen page G600 illustrated in FIG. 14 includes a receipt image G610 and a switching tab G620. The receipt image G610 corresponds to the receipt image file of the receipt selected from the receipt list G510. Thus, the user can input or edit the receipt data in the receipt editing field G520 of the ledger screen page G500 illustrated in FIG. 14, after referring to the receipt image G610.

If the user presses the switching tab G620 in the ledger screen page G600 illustrated in FIG. 14, the browser 310 receives the user's pressing operation, and switches the displayed screen page into the ledger screen page G500 illustrated in FIG. 14.

Thus, the user can confirm the desired receipt image G610 by selecting the corresponding receipt from the receipt list G510. Therefore, the user can input or edit each item included in the receipt editing field G520 (for example, the account item, the date, and so forth) after referring to the receipt image G610. Note that it is also possible that the receipt editing field G520 and the receipt image G610 are displayed together in a single screen page.

Then, the user uses the PC terminal 30 to perform a receipt processing request operation (step S1311). That is, the user presses a request button G540 in the ledger screen page G500 or the ledger screen page G600 illustrated in FIG. 14, and thus, performs the receipt processing request operation. Then, the browser 310 receives the receipt processing request operation.

After receiving the receipt processing request operation, the browser 310 transmits an expense reimbursement request for the requested receipt to the expense reimbursement system 40 (step S1312). Then, the expense reimbursement system 40 carries out an expense reimbursement process, for example, according to a workflow, or the like, and returns a response to the expense reimbursement request. Thus, the expense concerning the receipt for which the user has input or edited the receipt data is reimbursed.

### Second Embodiment

A second embodiment will now be described. According to the second embodiment, the apparatus 20 is, for example, a smartphone, a tablet terminal, a digital camera, or the like. Therefore, the receipt image file is generated from a photographed image file generated as a result of the apparatus 20 photographing receipts. The receipts are then registered in an expense reimbursement service.

In the description of the second embodiment, mainly differences from the first embodiment will be described, and description of the parts having substantially the same functional configurations as those in the first embodiment and description of the parts implementing substantially the same processes as those in the first embodiment will be appropriately omitted. Also, the same reference numerals as those in the first embodiment are given to the systems/apparatuses/devices/units corresponding to those in the first embodiment.

### <Hardware Configuration>

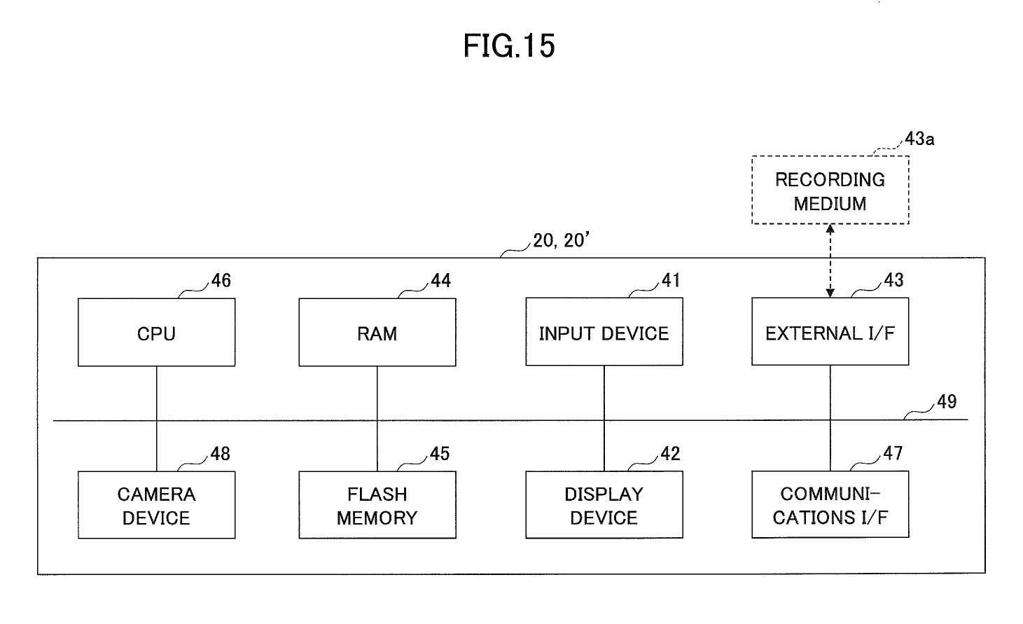

First, a hardware configuration for a case where the apparatus 20 included in the information processing system 1 according to the present embodiment is a smartphone or a tablet terminal will be described with reference to FIG. 15. FIG. 15 illustrates one example of a hardware configuration of the apparatus 20 according to the present embodiment.

The apparatus 20 illustrated in FIG. 15 includes an input device 41, a display device 42, an external I/F 43, and a communications I/F 44. The apparatus 20 further includes a RAM 45, a CPU 46, a flash memory 47, and a camera device 48. These hardware elements are connected via a bus 49.

The input device 41 includes a touch panel, or the like, and is used for the user to input various operation signals. The display device 42 includes a display, or the like, and displays processing results of the apparatus 20.

The communications I/F 44 is used to connect the apparatus 20 to the network N1. The apparatus 20 carries out communications through the communications I/F 44.

The flash memory 47 is, for example, an EEPROM (Electrically Erasable and Programmable Read-Only Memory), and is a nonvolatile storage device storing programs and data. The programs and data stored in the flash memory 47 include an OS controlling the entirety of the apparatus 20, application software providing various functions with the OS, and so forth.

The external I/F 43 is an interface for external devices. The external devices include a recording medium 43a. The apparatus 20 reads information from and writes information in the recording medium 43a via the external I/F 43. The recording medium 43a may be, for example, a SD memory card, a USB memory, or the like.

The RAM 45 is a volatile semiconductor memory and temporarily stores programs and data. The CPU 46 controls the entirety of the apparatus 20 and implements functions by reading programs and data from a storage device such as the flash memory 47 to RAM 45 and carrying out processes. The camera device 48 photographs a photographing area to generate an image file (i.e., a photographed image file).

The apparatus 20 according to the present embodiment implements various processes that will be described later with the hardware configuration illustrated in FIG. 15.

### <Services Provided by Service Providing System>

Services provided by the service providing system 10 according to the present embodiment will now be described. According to the present embodiment, it is assumed that the apparatus 20 is a smartphone or a tablet terminal. However, the apparatus 20 may also be, for example, a digital camera, a game apparatus, a wearable-type information terminal, or the like, as long as the apparatus 20 includes the camera device 48.

The service providing system 10 according to the present embodiment provides a service (i.e., a receipt registration service) of generating receipt image files from a photographed image file generated by the apparatus 20, and registering the receipt image files in an expense reimbursement service.

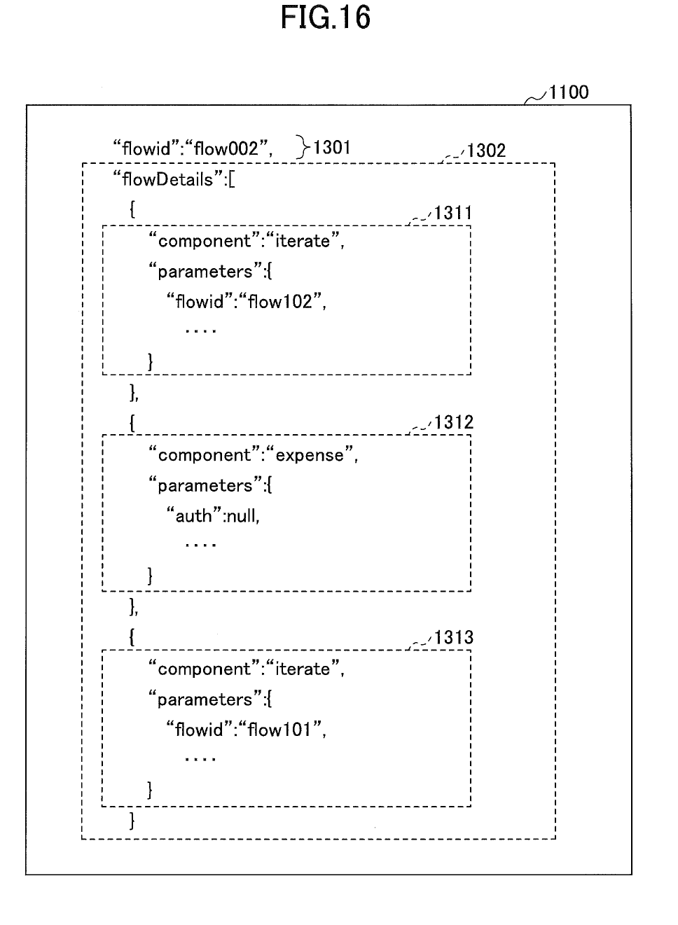

Processing flow information 1100 in which a sequence of processes (i.e., a processing flow) to implement a receipt registration service according to the present embodiment are defined will now be described with reference to FIG. 16. FIG. 16 illustrates one example of processing flow information 1100 in which a sequence of processes for implementing a receipt registration service according to the present embodiment are defined.

A set of processing flow information 1100 illustrated in FIG. 16 includes a flow ID 1301 identifying the set of processing flow information 1100, and a flow detail 1302 in which the process contents of each of the processes included in the set of processing flow are defined.

The flow detail 1302 includes processing definitions 1311-1313 in which the process contents of each of the processes included in the set of processing flow are defined. Each of the processing definitions 1111-1113 includes “component” indicating the component name of a component for carrying out the process, and “parameters” defining parameter information for the component.

Actually, for “component” of the processing definition 1311, the component name “iterate” of the iterate component 430 is defined. For “parameters” of the processing definition 1311, parameter information for the iterate component 430 is defined.

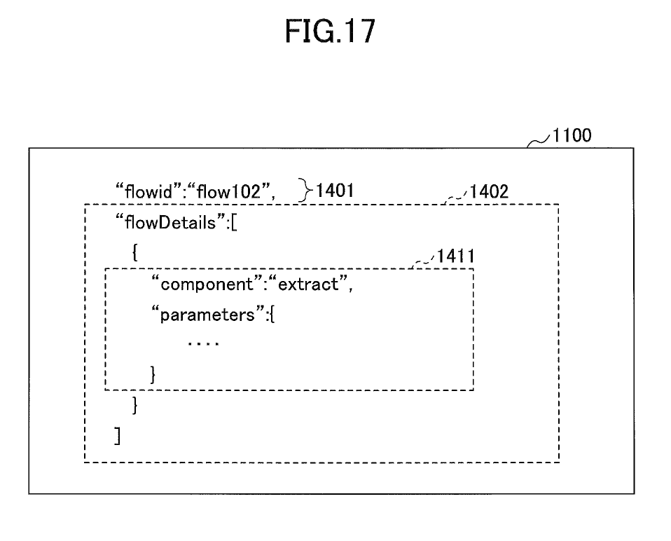

For “parameters” of the processing definition 1311, parameter information ‘“flowid”: “flow102”’ indicating a flow ID of a set of processing flow information 1100 in which a sequence of processes that the iterate component 430 carries out iteratively are defined. The set of processing flow information 1100 having the flow ID “flow102” will be described later with reference to FIG. 17.

In the same way, for “component” of the processing definition 1312, the component name “expense” of the expense reimbursement component 420 is defined. For “parameters” of the processing definition 1312, parameter information for the expense reimbursement component 420 is defined.

For “parameters” of the processing definition 1312, parameter information ‘“auth”: null’ for setting authentication information (for example, a user name, a password, an access token, or the like) or the like for using the expense reimbursement system 40 is defined.

In the same way, for “component” of the processing definition 1313, the component name “iterate” of the iterate component 430 is defined. For “parameters” of the processing definition 1313, parameter information for the iterate component 430 is defined.

For “parameters” of the processing definition 1313, parameter information ‘“flowid”: “flow101”’ indicating the flow ID of a set of processing flow information 1100 in which a sequence of processes that the iterate component 430 carries out iteratively are defined.

Thus, in the processing definition 1311 of the set of processing flow information 1100 illustrated in FIG. 16, it is defined that, through the iterate component 430, the sequence of processes based on the set of processing flow information 1100 identified by the flow ID “flow102”, described later, are to be iteratively carried out.

In the processing definition 1312 of the set of processing flow information 1100 illustrated in FIG. 16, it is defined that, through the expense reimbursement component 420, the expense reimbursement system 40 is requested to generate a ledger.

In the set of processing flow information 1313 of the set of processing flow information 1100 illustrated in FIG. 16, in the same way as the processing definition 1113 of the set of processing flow information 1100 illustrated in FIG. 7, it is defined that the sequence of processes based on the set of processing flow information 1100 identified by the flow ID “flow101” are to be iteratively carried out.

In the processing definition 1311 of the set of processing flow information 1100 illustrated in FIG. 16, it is defined that, through the iterate component 430, the sequence of processes based on the set of processing flow information 1100 identified by the flow ID “flow102” are to be iteratively carried out, as mentioned above. Below, the set of processing flow information 1100 identified by the flow ID “flow102” will be described with reference to FIG. 17. FIG. 17 illustrates one example of a set of processing flow information 1100 in which a sequence of processes for implementing a receipt registration service to be iteratively carried out are defined.

The set of processing flow information 1100 illustrated in FIG. 17 includes a flow ID 1401 and a flow detail 1402.

The flow detail 1402 includes a processing definition 1411. The processing definition 1411 includes “component” indicating the component name of a component for carrying out the process, and “parameters” defining parameter information for the component.

For “component” of the processing definition 1411, the component name “extract” of the area extract component 410 is defined. In the processing definition 1411, also parameter information for the area extract component 410 is defined.

The parameter information for the area extract component 410 includes, for example, parameter information (for example, receipt image files to be extracted) for determining areas to be extracted, or the like.

Thus, the iterate component 430 extracts respective receipt image files from one or more photographed image files by using the area extract component 410 as a result of the sequence of processes based on the set of processing flow information 1100 illustrated in FIG. 17 being iteratively carried out.

### <Process Details>

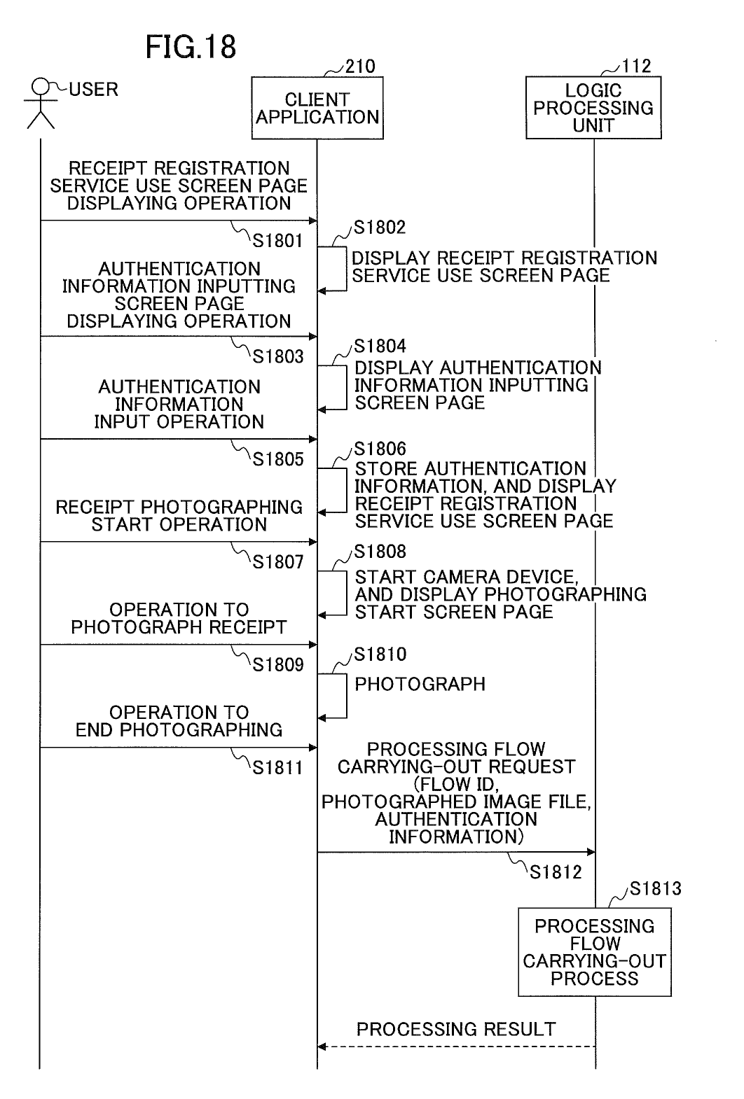

Process details of the information processing system 1 according to the present embodiment will now be described. Below, processes where the user of the apparatus 20 uses a receipt registration service to extract receipt image files from a photographed image file generated from photographing receipts, and register the receipt image files in an expense reimbursement service will be described with reference to FIG. 18. FIG. 18 is a sequence diagram illustrating one example of an overall process carried out when a receipt registration service according to the present embodiment is used.

First, the user uses the apparatus 20 to perform a receipt registration service use screen page displaying operation (step S1801). Then, the client application 210 of the apparatus 20 receives the receipt registration service use screen page displaying operation. The receipt registration service use screen page displaying operation may be, actually, for example, an operation to start the client application 210.

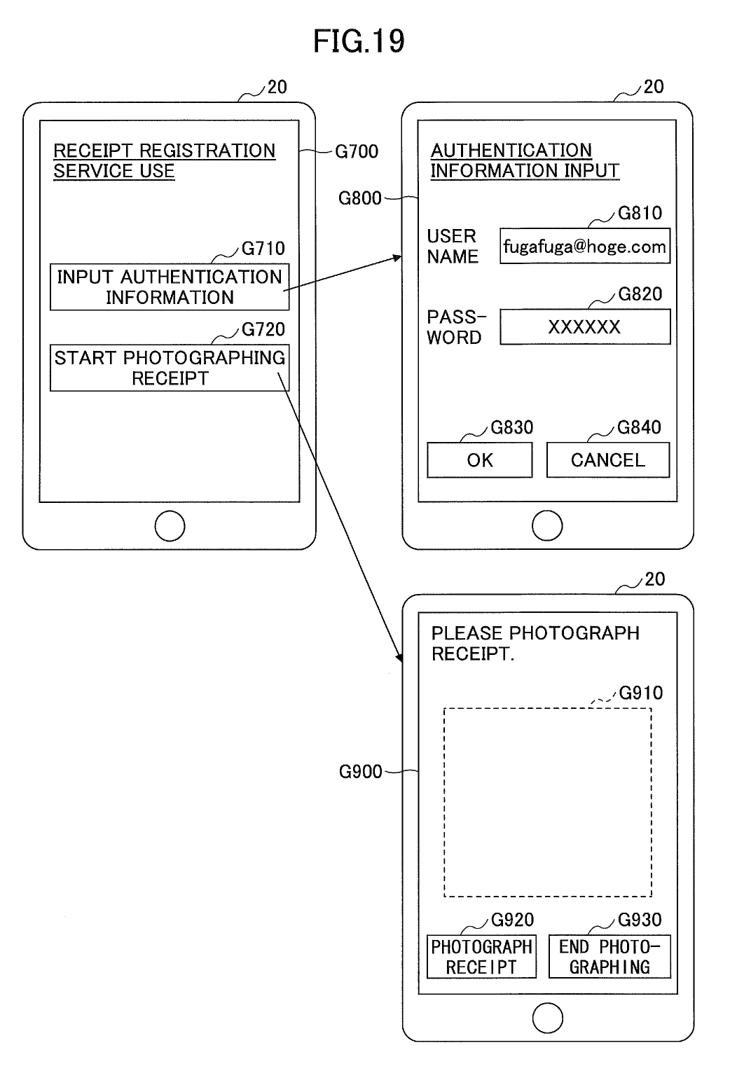

After receiving the user's receipt registration service use screen page displaying operation, the client application 210 displays a receipt registration service use screen page G700, for example, illustrated in FIG. 19 (step S1802).

The receipt registration service use screen page G700 illustrated in FIG. 19 includes an authentication information input button G710 and a receipt photographing start button G720. The authentication information input button G710 is a display component for the user to cause a transition to an authentication information inputting screen page G800 for using an expense reimbursement service. The receipt photographing start button G720 is a display component for the user to start the camera device 48 and cause a transition to a photographing start screen page G900 to photograph a receipt. It is assumed that the user presses the authentication information input button G710 in the receipt registration service use screen page G700 illustrated in FIG. 19 to perform an “authentication information inputting screen page displaying operation” (step S1803). Then, the client application 210 receives the authentication information inputting screen page displaying operation.

After receiving the user's authentication information inputting screen page displaying operation, the client application 210 displays the authentication information inputting screen page G800, for example, as illustrated in FIG. 19 (step S1804).

The authentication information inputting screen page G800 includes a user name input field G810, a password input field G820, an OK button G830, and a cancel button G840. The user name input field G810 and the password input field G820 are used by the user to input the user name and the password, respectively, as an example of authentication information for using an expense reimbursement service.

The OK button G830 is a display component for the user to store the user name and the password having been input in the user name input field G810 and the password input field G820, and return to the receipt registration service use screen page G700 illustrated in FIG. 19.

The cancel button G840 is a display component for the user to return to the receipt registration service use screen page G700 illustrated in FIG. 19 without storing the user name and the password having been input in the user name input field G810 and the password input field G820. It is assumed that the user inputs the user name and the password in the user name input field G810 and the password input field G820, respectively, in the authentication information inputting screen page G800 illustrated in FIG. 19, presses the OK button G830, and thus, performs an authentication information input operation (step S1805). Then, the client application 210 receives the authentication information input operation.

After receiving the authentication information input operation, the client application 210 stores the user name and the password having been input in the user name input field G810 and the password input field G820, and displays the receipt registration service use screen page G700 (step S1806). Actually, the client application 210 may store the user name and the password having been input in the user name input field G810 and the password input field G820 in a certain storage area of the flash memory 47, for example.

If the authentication information (for example, the user name and the password, or the like) has been already stored, steps S1803-S1806 may be omitted. That is, in this case, the user may perform a receipt photographing start operation of step S1807 that will be described later by pressing the receipt photographing start button G720 without pressing the authentication information input button G710 in the receipt registration service use screen page G700 illustrated in FIG. 19.

It is assumed that the user presses the receipt photographing start button G720 in the receipt registration service use screen page G700 illustrated in FIG. 19 to perform a receipt photographing start operation (step S1807). Then, the client application 210 receives the receipt photographing start operation.

After receiving the receipt photographing start operation, the client application 210 starts the camera device 48, and displays the photographing start screen page G900, for example, as illustrated in FIG. 19 (step S1808).

The photographing start screen page G900 illustrated in FIG. 19 includes a reference frame G910, a receipt photographing button G920, and a photographing end button G930. The reference frame G910, the receipt photographing button G920, and the photographing end button G930 are displayed in an image corresponding to the photographing area of the camera device 48 in a superimposition manner.

The reference frame G910 acts as a marker for the user to use as a reference position for photographing a receipt. The user can photographs a receipt in such a manner that the receipt to be photographed will fall within the reference frame G910 by adjusting the distance between the receipt and the apparatus 20, performing camera zooming in and out operation, and so forth. The receipt photographing button G920 is a display component for the user to generate a photographed image file by photographing the photographing area with the camera 48. The photographing end button G930 is a display component for the user to end photographing a receipt.

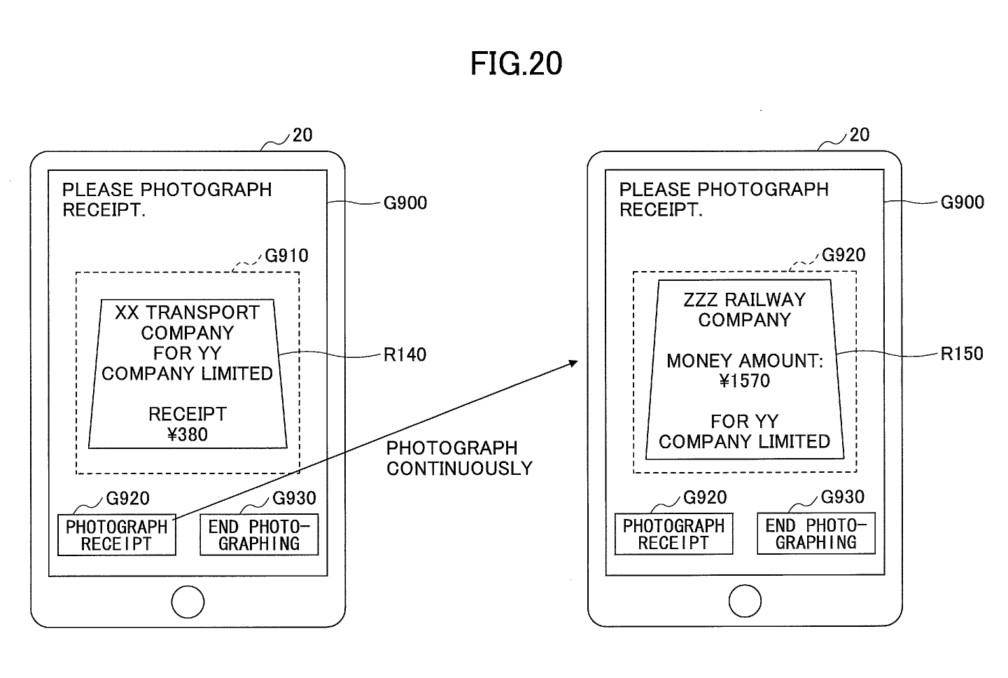

Photographing a receipt will now be described with reference to FIG. 20. FIG. 20 illustrates one example of photographing a receipt.

As illustrated in the left hand of FIG. 20, the user can photograph a receipt R140 by performing such an adjustment operation that the receipt R140 to be photographed appears within the reference frame G910 and pressing the receipt photographing button G920.

Also, as illustrated in the right hand of FIG. 20, for example, the user can photograph a receipt R150 continuously after photographing the receipt R140 by pressing the receipt photographing button G920. Thus, the user can photograph a plurality of receipts (R140, R150, and so forth), one by one, before pressing the photographing end button G930.

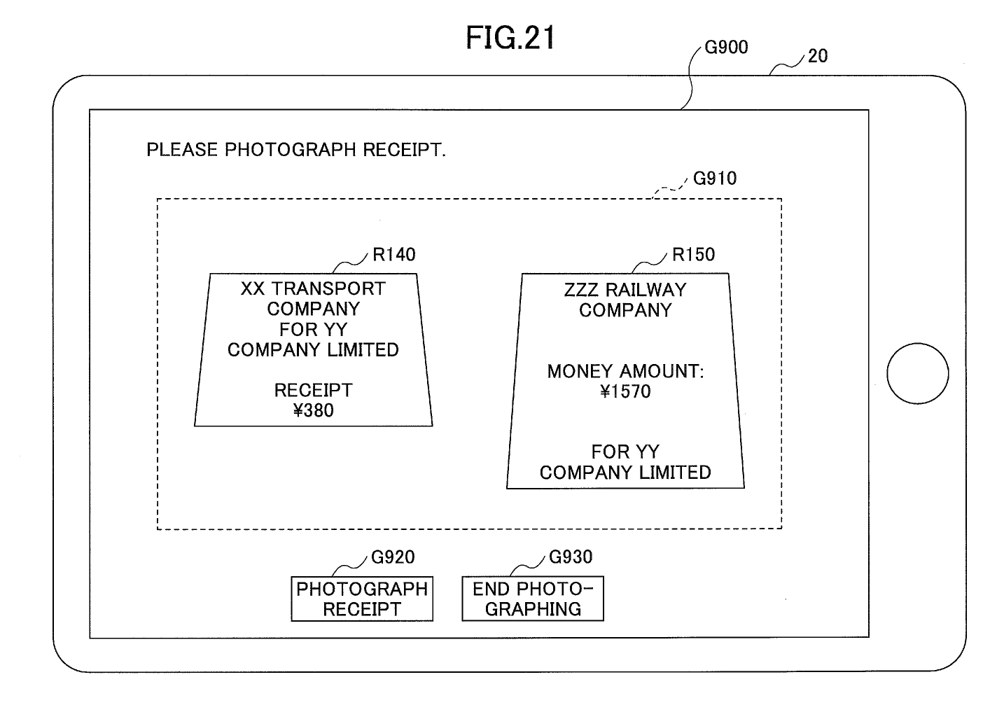

It is also possible that the user photographs a plurality of receipts through a single photographing operation. That is, for example, as illustrated in FIG. 21, the user may press the receipt photographing button G920 after making adjustment such that the receipts R140 and R150 will fall within the reference frame G910.

Returning to the description of the sequence diagram of FIG. 18, it is assumed that the user performs adjustment such that the receipt to be photographed will fall within the reference frame G910 in the photographing start screen page G900 illustrated in FIG. 19, then presses the receipt photographing button G920, and thus, performs an operation to photograph the receipt (step S1809). Then, the client application 210 receives the operation of photographing the receipt.

After receiving the operation of photographing the receipt, the client application 210 actually photographs the photographing area through the camera device 48, and generates a photographed image file (step S1810).

As described above, the user may iterate an operation of photographing a receipt of step S1810 before pressing the photographing end button G930.

It is assumed that the user presses the photographing end button G930 in the photographing start screen page G900 of FIG. 19, and performs an operation to end photographing (step S1811). Then, the client application 210 receives the operation to end photographing.

After receiving the operation to end photographing, the client application 210 transmits a processing flow carrying-out request to the logic processing unit 112 (step S1812). Note that the processing flow carrying-out request includes the flow ID “flow002” of the set of processing flow information 1100 for implementing a receipt registration service according to the present embodiment, and authentication information (that is, the user name and the password). Also, the processing flow carrying-out request includes the one or more photographed image files generated in step S1810 mentioned above.

The flow ID “flow002” has been associated with, for example, the photographing end button G930 in the photographing start screen page G900. However, it is also possible that the flow ID “flow002” has been associated with, for example, the photographing start screen page G900.

Then, after receiving the processing flow carrying-out request, the logic processing unit 112 carries out a processing flow carrying-out process (step S1813). That is, the logic processing unit 112 carries out a sequence of processes based on the set of processing flow information 1100 of the flow ID “flow002” included in the processing flow carrying-out request.

Then, the logic processing unit 112 returns the processing result of the processing flow carrying-out process to the client application 210. Thus, the service providing system 10 according to the present embodiment can provide the receipt registration service to the apparatus 20.

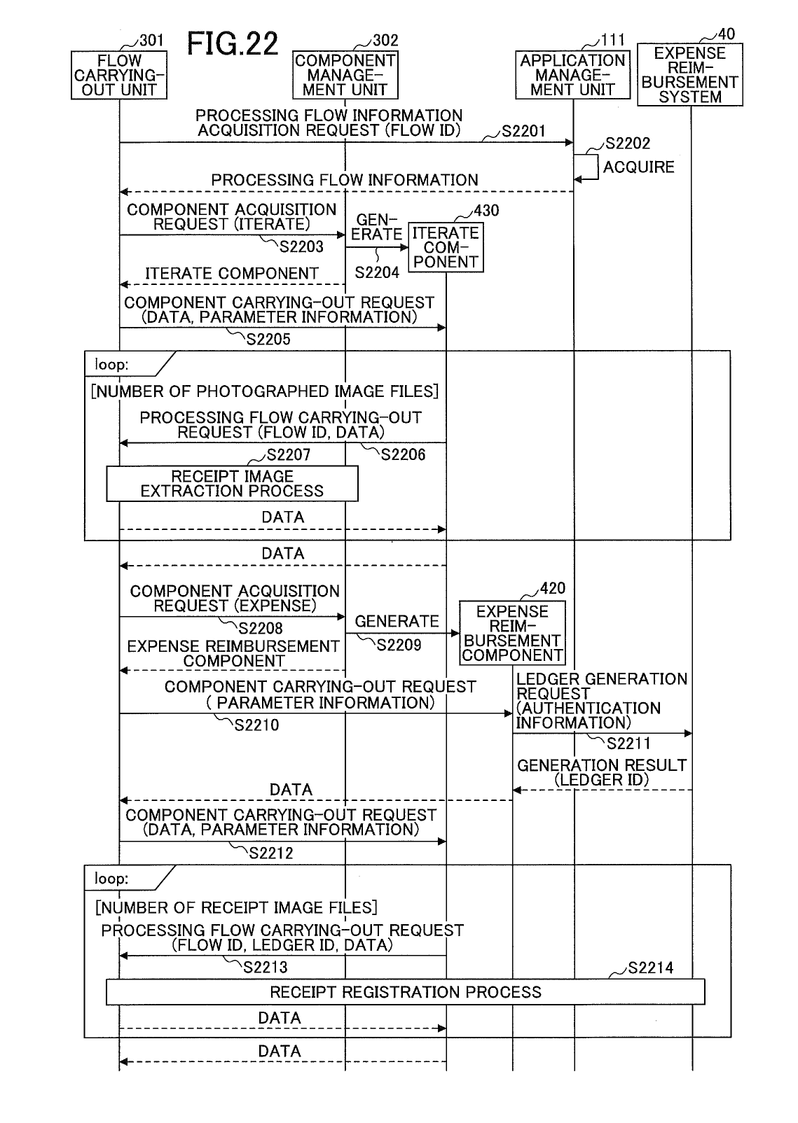

The processing flow carrying-out process illustrated in FIG. 18 (i.e., step S1813) will now be described in detail with reference to FIG. 22. FIG. 22 is a sequence diagram illustrating one example of a processing flow carrying-out process for implementing a receipt registration service according to the present embodiment.

First, after receiving the processing flow carrying-out request from the client application 210, the flow carrying-out unit 301 transmits a processing flow information acquisition request to the application management unit 111 (step S2201). The processing flow information acquisition request includes the flow ID “flow002” acquired from the processing flow carrying-out request.

After receiving the processing flow information acquisition request, the application management unit 111 acquires the set of processing flow information 1100, identified by the flow ID “flow002” included in the processing flow information acquisition request, from the application information 1000 stored in the application information storage unit 130 (step S2202). That is, the application management unit 111 acquires the set of processing flow information 1100 illustrated in FIG. 16 from the application information storage unit 130.

Then, the application management unit 111 returns the set of processing flow information 1100 acquired from the application information storage unit 130 to the logic processing unit 112.

The flow carrying-out unit 301 in the logic processing unit 112 transmits a component acquisition request based on the set of processing flow information 1100 illustrated in FIG. 16 to the component management unit 302 (step S2203). That is, the flow carrying-out unit 301 transmits the component acquisition request for a component having the component name “iterate” defined for “component” included in the processing definition 1311 of the set of processing flow information 1100 illustrated in FIG. 16 to the component management unit 302.

After receiving the component acquisition request, the component management unit 302 generates a component having the component name “iterate” (that is, the “iterate” component 430) (step S2204). Generating the iterate component 430 can be implemented by using the API prepared for generating components defined in the component common I/F 400.

Then, the component management unit 302 returns the generated iterate component 430 to the flow carrying-out unit 301. That is, the component management unit 302 returns, for example, an address at which the iterate component 430 is loaded in a memory (for example, the RAM 14) to the flow carrying-out unit 301.

Then, the flow carrying-out unit 301 transmits a component carrying-out request to the iterate component 430 (step S2205).

Note that, the component carrying-out request includes one or more sets of data. The sets of data are the photographed image files included in the processing flow carrying-out request received from the client application 210.

The component carrying-out request also includes the respective sets of parameter information defined for “parameters” included in the processing definition 1311 of the set of processing flow information 1100 illustrated in FIG. 16. That is, the component carrying-out request includes the parameter information ‘“flowid”: “flow102”’.

After receiving the component carrying-out request, the iterate component 430 transmits a processing flow carrying-out request for each of the one or more sets of data (that is, each of the one or more photographed image files) included in the component carrying-out request to the flow carrying-out unit 301 (step S2206). That is, the iterate component 430 iteratively carries out the receipt image extraction process of step S2207 the number of times equal to the number of the photographed image files. Note that, the processing flow carrying-out request includes the data (that is, the photographed image files) and the flow ID “flow102”.

After receiving the processing flow carrying-out request, the flow carrying-out unit 301 extracts the receipt images from the photographed image files, and carries out a process (i.e., a receipt image extraction process) for generating receipt image files (step S2207). Then, the flow carrying-out unit 301 returns the processing result of the receipt image extraction process (that is, sets of data indicating the receipt image files extracted from the photographed image files) to the iterate component 430.

Thereafter, the iterate component 430 returns data indicating the processing result of iteratively carrying out the receipt image extraction process of step S2207 to the flow carrying-out unit 301.

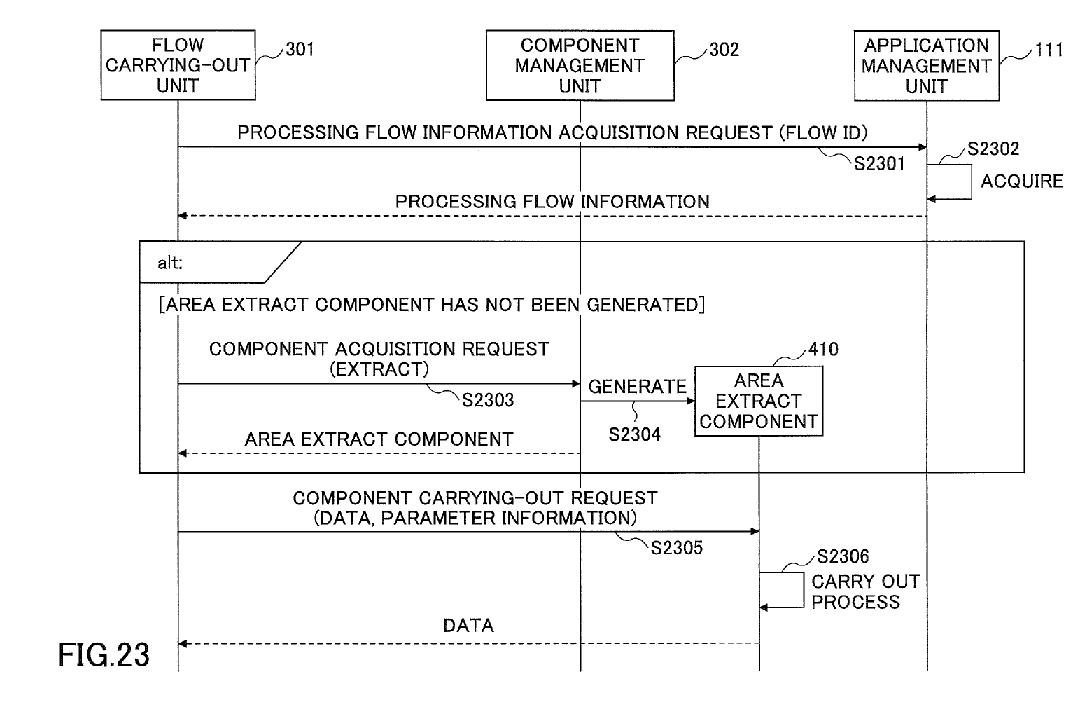

The receipt image extraction process (in step S2207) will now be described in detail with reference to FIG. 23. FIG. 23 is a sequence diagram illustrating one example of a receipt image extraction process according to the present embodiment.

First, after receiving the processing flow carrying-out request from the iterate component 430, the flow carrying-out unit 301 transmits a processing flow information acquisition request to the application management unit 111 (step S2301). The processing flow information acquisition request includes the flow ID “flow102” acquired from the processing flow carrying-out request.

After receiving the processing flow information acquisition request, the application management unit 111 acquires the set of processing flow information 1100 identified by the flow ID “flow102” included in the processing flow information acquisition request from the application information 1000 stored in the application information storage unit 130 (step S2302). That is, the application management unit 111 acquires the set of processing flow information 1100 illustrated in FIG. 17 from the application information storage unit 130.

Then, the application management unit 111 returns the set processing flow information 1100 acquired from the application information storage unit 130 to the logic processing unit 112.

If the area extract component 410 has not been generated yet, the flow carrying-out unit 301 carries out step S2303. That is, the flow carrying-out unit 301 transmits a component acquisition request for a component identified by the component name “extract” defined for “component” included in the processing definition 1411 of the set of processing flow information 1100 illustrated in FIG. 17 to the component management unit 302 (step S2303).

On the other hand, if the area extract component 410 has been already generated, the flow carrying-out unit 301 does not carry out step S2303 described above.

After receiving the component acquisition request, the component management unit 302 generates a component having the component name “extract” (that is, the area extract component 410) (step S2304). Generating the area extract component 410 can be implemented by using the API prepared for generating components defined in the component common I/F 400.

Then, the component management unit 302 returns the generated area extract component 410 to the flow carrying-out unit 301. That is, the component management unit 302 returns, for example, an address at which the area extract component 410 is loaded in a memory (for example, the RAM 14) to the flow carrying-out unit 301.

Then, the flow carrying-out unit 301 transmits a component carrying-out request to the area extract component 410 (step S2305).

The component carrying-out request includes data indicating the photographed image files. Also, the component carrying-out request includes the respective sets of parameter information defined for “parameters” included in the processing definition 1411 of the set of processing flow information 1100.

After receiving the component carrying-out request, the area extract component 410 carries out a process on the data included in the component carrying-out request using the parameter information (step S2306). That is, the area extract component 410 extracts the area of the image of the receipt included in the photographed image file through the area extraction unit 121 of the document service unit 120, and generate a receipt image file. Note that if the photographed image file includes a plurality of the areas of images of the receipts, the area extract component 410 extracts the respective areas of images of the receipts to generate respective receipt image files.

Also, if an area where a “simple receipt” appears is included in the scanned image file, the area extract component 410 may extract the area where the simple receipt appears to generate a simple receipt image file. In this case, the receipt registration service registers the simple receipt image file in the expense reimbursement service.

Further, for example, if the area of the image of the receipt included in the scanned image file is inclined, or the like, the area is rotated to correct the inclination, or the like, and then, is extracted. Thereafter, the receipt image file is generated.

Then, the area extract component 410 returns data indicating the generated receipt image file to the flow carrying-out unit 301.

Returning to FIG. 22, after receiving data indicating the processing result of the iterate component 430 (i.e., the processing result of iteratively carrying out the receipt image extraction process), the flow carrying-out unit 301 transmits a component acquisition request based on the set of processing flow information 1100 illustrated in FIG. 16 to the component management unit 302 (step S2208). That is, the flow carrying-out unit 301 transmits a component acquisition request for a component having the component name “expense” defined for “component” included in the processing definition 1312 of the set of processing flow information 1100 illustrated in FIG. 16 to the component management unit 302.

After receiving the component acquisition request, the component management unit 302 generates a component having the component name “expense” (that is, the expense reimbursement component 420) (step S2209). Generating the expense reimbursement component 420 can be implemented using the API prepared for generating components defined in the component common I/F 400.

Then, the component management unit 302 returns the generated expense reimbursement component 420 to the flow carrying-out unit 301. That is, the component management unit 302 returns, for example, an address at which the expense reimbursement component 420 is loaded in a memory (for example, the RAM 14) to the flow carrying-out unit 301.

Then, the flow carrying-out unit 301 transmits a component carrying-out request to the expense reimbursement component 420 (step S2210). The component carrying-out request includes respective sets of parameter information defined for “parameters” included in the processing definition 1312 of the set of processing flow information 1100 illustrated in FIG. 16.

That is, the component carrying-out request includes parameter information acquired as a result of authentication information being set to parameter information “auth”: null′. For example, it is assumed that the OK button G830 is pressed after a user name “fugafuga@hoge.com” and a password “xxxxxx” are input in the user name input field G810 and the password input field G820 of the authentication information inputting screen page G800. In this case, the parameter information is, for example, ‘“auth”: “fugafuga@hoge.com/xxxxxx”’.

Also, the component carrying-out request includes parameter information for transmitting a ledger generation request to the expense reimbursement system 40.

After receiving the component carrying-out request, the expense reimbursement component 420 carries out a process using the parameter information (step S2211). That is, the expense reimbursement component 420 transmits the ledger generation request to the expense reimbursement system 40. For example, the expense reimbursement component 420 can transmit the ledger generation request using, for example, a WebAPI disclosed by the expense reimbursement system 40. Also, the ledger generation request includes authentication information.

Then, the expense reimbursement system 40 generates a ledger to register the receipt image file, and returns a ledger ID for identifying the generated ledger to the expense reimbursement component 420 as the processing result. Then, the expense reimbursement component 420 returns data indicating the ledger ID to the flow carrying-out unit 301.

Then, the flow carrying-out unit 301 transmits a component carrying-out request to the iterate component 430 (step S2212).

The component carrying-out request includes data indicating the receipt image file generated by the area extract component 410. Therefore, the component carrying-out request includes a plurality of sets of data respectively indicating a plurality of receipt image files if the area extract component 410 has generated the plurality of the receipt image files.

Also, the component carrying-out request includes respective sets of parameter information defined for “parameters” included in the processing definition 1313 of the set of processing flow information 1100 illustrated in FIG. 16. That is, the component carrying-out request includes the parameter information ‘“flowid”: “flow101”’ and the parameter information indicating the ledger ID returned in step S2211.

After receiving the component carrying-out request, the iterate component 430 transmits a processing flow carrying-out request to the flow carrying-out unit 301 for each of the sets of data included in the component carrying-out request (that is, for each receipt image file) (step S2213). That is, the iterate component 430 carries out the receipt registration process of step S2214 iteratively the number of times equal to the number of the receipt image files. Note that, the component carrying-out request includes the data (that is, the receipt image files), the flow ID “flow101”, and the ledger ID.

After receiving the processing flow carrying-out request, the flow carrying-out unit 301 carries out a process (i.e., a receipt registration process) for registering the receipt image files in the ledger identified by the ledger ID concerning the expense reimbursement service (step S2214). Then, the flow carrying-out unit 301 returns the processing result of the receipt registration process to the iterate component 430.

Thereafter, the iterate component 430 returns data indicating the processing result of interactively carrying out the receipt registration process of step S2214 to the flow carrying-out unit 301. Note that, the receipt registration process of step S2214 is the same as the receipt registration process of step S1115 of FIG. 11, and thus, the description will be omitted.

### Third Embodiment

A third embodiment will now be described. According to the third embodiment, the service providing system 10 carries out authentication cooperation using, for example, “OAuth” technology, with the expense reimbursement system 40. As a result of the service providing system 10 carrying out authentication cooperation with the expense reimbursement system 40, the user of the apparatus 20 is free from inputting authentication information (the user name and the password, or the like, for using the expense reimbursement service) each time when using a receipt registration service.

Concerning the third embodiment, mainly the differences from the first embodiment will be described, and description of the parts having substantially the same functional configurations as those in the first embodiment and description of the parts implementing substantially the same processes as those in the first embodiment will be appropriately omitted. Also, the same reference numerals as those in the first embodiment are given to the systems/apparatuses/devices/units corresponding to those in the first embodiment.

### <Functional Configuration>

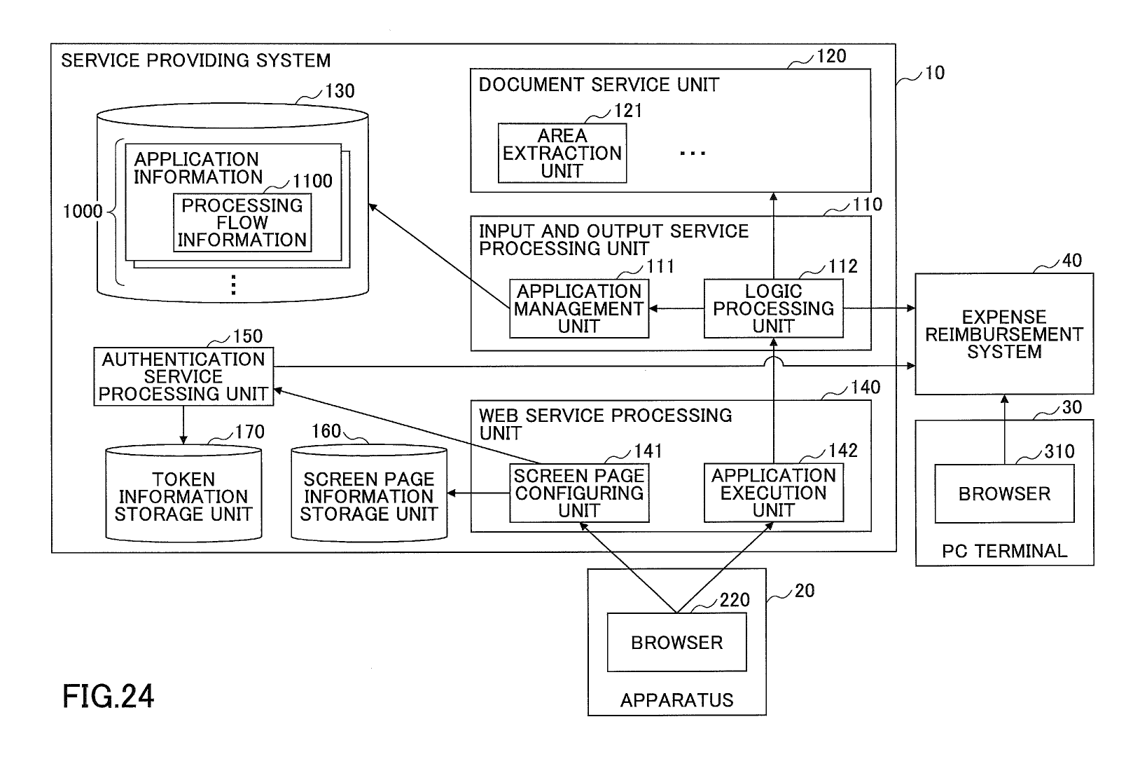

First, the information processing system 1 according to the present embodiment will now be described with reference to FIG. 24. FIG. 24 illustrates one example of a functional configuration of the information processing system 1 according to the present embodiment.

The apparatus 20 illustrated in FIG. 24 includes a browser 220 implemented by, for example, the CPU 31, and so forth. The user of the apparatus 20 can use a receipt registration service provided by the service providing system 10 via the browser 220. The service providing system 10 illustrated in FIG. 24 further includes a Web service processing unit 140 and an authentication service processing unit 150. These functional units are implemented by processes carried out by the CPU 16 according to one or more programs installed in the service providing system 10.

The service providing system 10 illustrated in FIG. 24 further includes a screen page information storage unit 160 and a token information storage unit 170. These storage units can be implemented by the HDD 18. However, at least one of the screen page information storage unit 160 and the token information storage unit 170 may be implemented by a storage device connected with the service providing system 10 via the network N1, or the like.

The Web service processing unit 140 carries out processes for the user of the apparatus 20 to use a service (for example, a receipt registration service) provided by the service providing system 10, by using the browser 220. That is, the Web service processing unit 140 functions as an application server to provide a Web application (that is, the application information 1000) to the browser 220. The Web service processing unit 140 includes a screen page configuring unit 141 and an application execution unit 142.

The screen page configuring unit 141 responds to a request from the browser 220 of the apparatus 20 to return screen page information stored in the screen page information storage unit 160. In the screen page information, screen pages for the user to use a service (for example, a receipt registration service) provided by the application information 1000 is defined. In the screen page information, the screen pages are defined in a type interpretable by the browser 220, for example, using HTML, XHTML (Extensible HyperText Markup Language), CSS (Cascading Style Sheets), JavaScript (registered trademark), or the like. Thus, the operation panel 22 of the apparatus 20 displays, through the browser 220, various screen pages for the user to user services provided by the service providing system 10.

The application execution unit 142 responds to a request from the browser 220 of the apparatus 20 to transmit a processing flow carrying-out request to the logic processing unit 112 of the input and output service processing unit 110.

The authentication service processing unit 150 carries out processes for implementing authentication cooperation with the expense reimbursement system 40. That is, if authentication for the expense reimbursement system 40 is successful, the authentication service processing unit 150 acquires an access token from the expense reimbursement system 40 using a temporary token that is returned in response to the fact that the authentication is successful. Then, the authentication service processing unit 150 stores token information in which the access token is associated with the user ID in the token information storage unit 170.

The screen page information storage unit 160 stores the screen page information concerning the various screen pages for the user to use services provided by the service providing system 10.

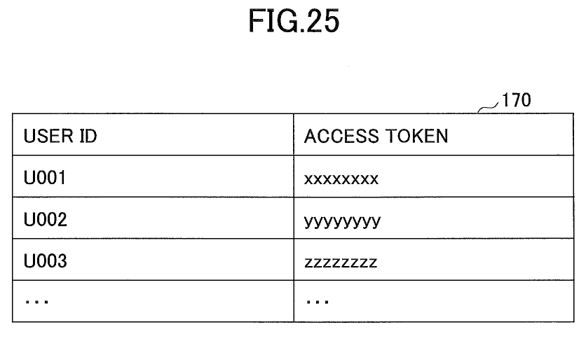

The token information storage unit 170 stores the token information in which user IDs for using the service providing system 10 are associated with access tokens for using an expense reimbursement service. The token information stored in the token information storage unit 170 will now be described with reference to FIG. 25. FIG. 25 illustrates one example of the token information.

As illustrated in FIG. 25, in the token information stored in the token information storage unit 170, user IDs are associated with access tokens. Thus, the user (that is, the user who use the service providing system 10 through the browser 220) of the service providing system 10 can use a receipt registration service by using the access token associated with the user ID of the user.

### <Process Details>

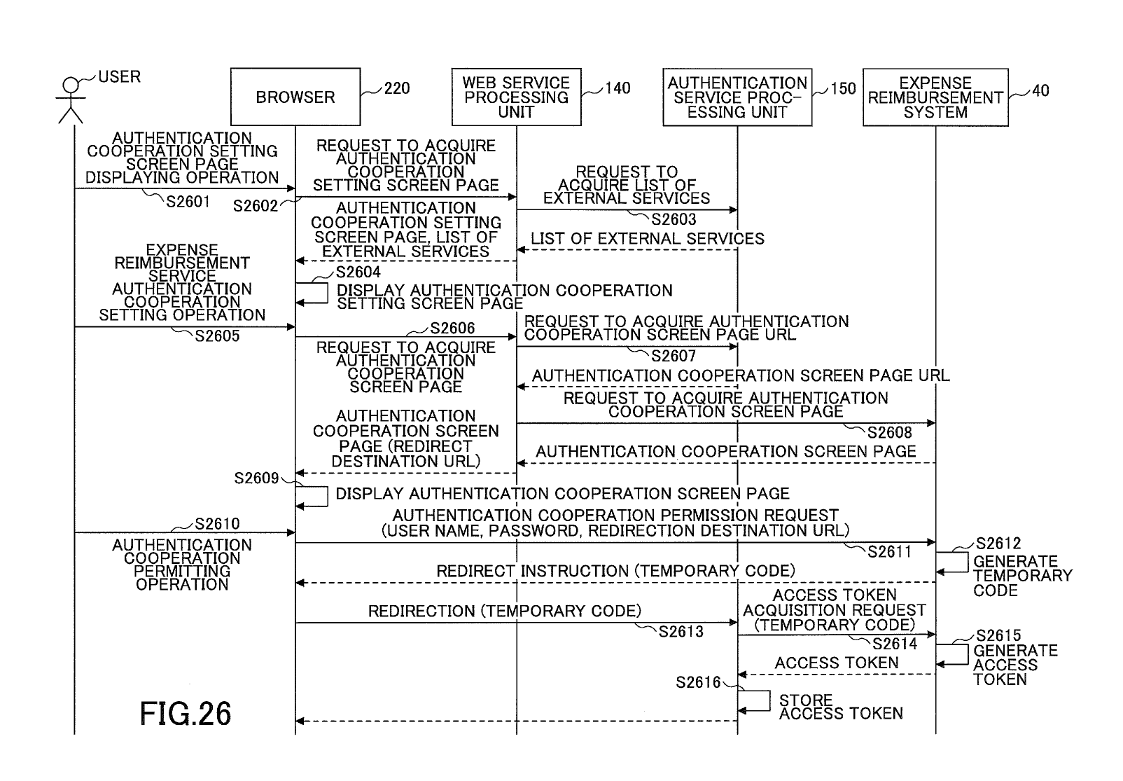

Processes of the information processing system 1 according to the present embodiment will now be described in detail. A process of setting authentication cooperation with the expense reimbursement system 40 before the user of the apparatus 20 use a receipt registration service will now be described with reference to FIG. 26. FIG. 26 is a sequence diagram illustrating one example of an authentication cooperation setting process according to the present embodiment.

First, the user uses the browser 220 of the apparatus 20 to perform an authentication cooperation setting screen page displaying operation (step S2601). The user can perform the authentication cooperation setting screen page displaying operation by, for example, pressing a display component of a link for an authentication cooperation setting screen page on a screen page displayed by the browser 220. It is also possible that the user performs the authentication cooperation setting screen page displaying operation by, for example, inputting the URL (Uniform Resource Locator) of the authentication cooperation setting screen page in an address bar of the browser 220, or the like.

After receiving the authentication cooperation setting screen page displaying operation, the browser 220 of the apparatus 20 transmits a request to acquire the authentication cooperation setting screen page to the Web service processing unit 140 of The service providing system 10 (step S2602).

After receiving the request to acquire the authentication cooperation setting screen page, the screen page configuring unit 141 of the Web service processing unit 140 acquires information for displaying the authentication cooperation setting screen page from the screen page information storage unit 160. Then, the screen page configuring unit 141 transmits a service list acquisition request based on the information for displaying the authentication cooperation setting screen page to the authentication service processing unit 150 (step S2603). The service list acquisition request is a request for acquiring a list of external services for which it is possible to carry out authentication cooperation with the service providing system 10 (for example, an expense reimbursement service provided by the expense reimbursement system 40).

After receiving the service list acquisition request, the authentication service processing unit 150 returns a list of external services for which it is possible to carry out authentication cooperation with the service providing system 10 to the Web service processing unit 140. Then, the screen page configuring unit 141 returns the list of external services and the information for displaying the authentication cooperation setting screen page to the browser 220.

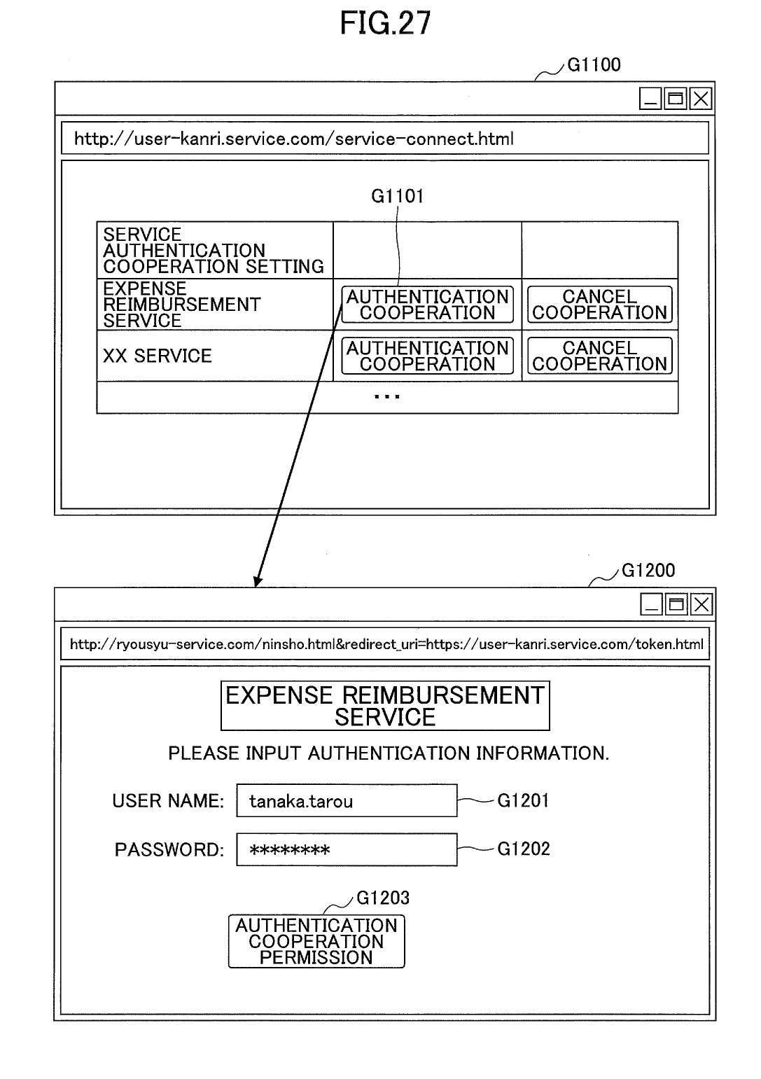

After receiving the list of external services and the information for displaying the authentication cooperation setting screen page, the browser 220 displays the authentication cooperation setting screen page G1100, for example, as illustrated in FIG. 27, based on the list of external services and the information for displaying the authentication cooperation setting screen page (step S2604).

The authentication cooperation setting screen page G1100 illustrated in FIG. 27 includes an “authentication cooperation” button for setting authentication cooperation, and a “cooperation cancel” button for canceling (or removing) setting authentication cooperation, for each of the external services included in the list of external services. The user can perform an operation to set authentication cooperation for an expense reimbursement service (i.e., an expense reimbursement service authentication cooperation setting operation) by pressing the “authentication cooperation button” G1101.

The user uses the browser 220 to perform the expense reimbursement service authentication cooperation setting operation (step S2605).

After receiving the expense reimbursement service authentication cooperation setting operation, the browser 220 transmits a request to acquire an authentication cooperation screen page for inputting authentication information, or the like, for the expense reimbursement service to the Web service processing unit 140 (step S2606).

After receiving the request to acquire the authentication cooperation screen page, the screen page configuring unit 141 of the Web service processing unit 140 transmits a request to acquire a URL for the expense reimbursement service authentication cooperation screen page (i.e., a request to acquire an authentication cooperation screen page URL) to the authentication service processing unit 150 (step S2607). After receiving the request to acquire an authentication cooperation screen page URL, the authentication service processing unit 150 returns the authentication cooperation screen page URL to the Web service processing unit 140.

Note that, the authentication cooperation screen page URL is a URL for an authentication cooperation screen page provided by the expense reimbursement system 40. However, instead of a URL, for example, a URI (Uniform Resource Identifier), a URN (Uniform Resource Name), or the like, may be used.

After receiving the authentication cooperation screen page URL, The screen page configuring unit 141 of the Web service processing unit 140 transmits a request to acquire the authentication cooperation screen page indicated by the URL to the expense reimbursement system 40 (step S2608). After receiving the request to acquire the authentication cooperation screen page, the expense reimbursement system 40 returns screen page information for displaying the authentication cooperation screen page to the Web service processing unit 140.

Then, after receiving the screen page information for displaying the authentication cooperation screen page from the expense reimbursement system 40, the screen page configuring unit 141 of the Web service processing unit 140 returns the screen page information to the browser 220 after adding a redirect destination URL to the screen page information. Note that, the redirect destination URL thus added to the screen page information is, for example, a URL for transmitting a temporary code to the authentication service processing unit 150.

After receiving the screen page information (for displaying the authentication cooperation screen page) to which the redirect destination URL is added, the browser 220 displays the authentication cooperation screen page G1200, for example, as illustrated in FIG. 27, based on the received screen page information (step S2609).

The authentication cooperation screen page G1200 illustrated in FIG. 27 includes a user name input field G1201 for the user to input the user name of the authentication information for the expense reimbursement service, and a password input field G1202 for the user to input the password of the authentication information.

The user can perform an authentication cooperation permitting operation by pressing an “authentication cooperation permission” button G1203 after inputting the user name and the password for the expense reimbursement service in the user name input field G1201 and the password input field G1202, respectively. The authentication cooperation permitting operation is an operation for permitting authentication cooperation for the expense reimbursement service.

It is also possible that, by using the authentication cooperation screen page G1200 illustrated in FIG. 27, the user can set, for example, a scope to be used for authentication cooperation according to OAuth technology or the like.

The user uses the browser 220 to perform the authentication cooperation permitting operation (step S2610). After receiving the user's authentication cooperation permitting operation, the browser 220 transmits an authentication cooperation permission request to the expense reimbursement system 40 (step S2611). Note that, the authentication cooperation permission request includes the authentication information (that is, the user name and the password for the expense reimbursement service) that has been input in the authentication cooperation screen page G1200 as well as the redirect destination URL.

After receiving the authentication cooperation permission request, the expense reimbursement system 40 carries out authentication based on the authentication information included in the authentication cooperation permission request. Then, if the authentication is successful, the expense reimbursement system 40 generates a temporary code to be used to generate an access token (step S2612) and transmits a redirection instruction that includes the generated temporary code to the browser 220.

However, if the authentication is failed, the expense reimbursement system 40 returns information indicating that the authentication is failed to the browser 220. Below, the description will be continued assuming that the authentication for the expense reimbursement system 40 is successful.

After receiving the redirection instruction from the expense reimbursement system 40, the browser 220 causes the authentication service processing unit 150 to carry out redirection (step S2613). That is, the browser 220 transmits the temporary code received from the expense reimbursement system 40 to the redirect destination URL.

After receiving the temporary code from the browser 220, the authentication service processing unit 150 transmits an access token acquisition request to the expense reimbursement system 40 (step S2614). The access token acquisition request includes the temporary code. The access token acquisition request can be transmitted as a result of a request being transmitted to a WebAPI prepared for acquiring an access token disclosed by the expense reimbursement system 40.

After receiving the access token acquisition request, the expense reimbursement system 40 determines whether the temporary code included in the access token acquisition request is valid. If the temporary code included in the access token acquisition request is valid, the expense reimbursement system 40 generates an access token (step S2615), and returns the generated access token to the authentication service processing unit 150.

After receiving the access token, the authentication service processing unit 150 generates token information in which the user ID of the user (that is, the user who has logged in to the service providing system 10 using the browser 220) who is using the browser 220 is associated with the access token. Then, the authentication service processing unit 150 stores the generated token information in the token information storage unit 170 (step S2616).

Thus, the service providing system 10 according to the present embodiment stores the access token for carrying out authentication cooperation with the expense reimbursement system 40 in the state where the access token is associated with the user ID of the user who has logged in to the service providing system 10. Thus, the user can use a receipt registration service in authentication cooperation with the expense reimbursement system 40 through the browser 220.

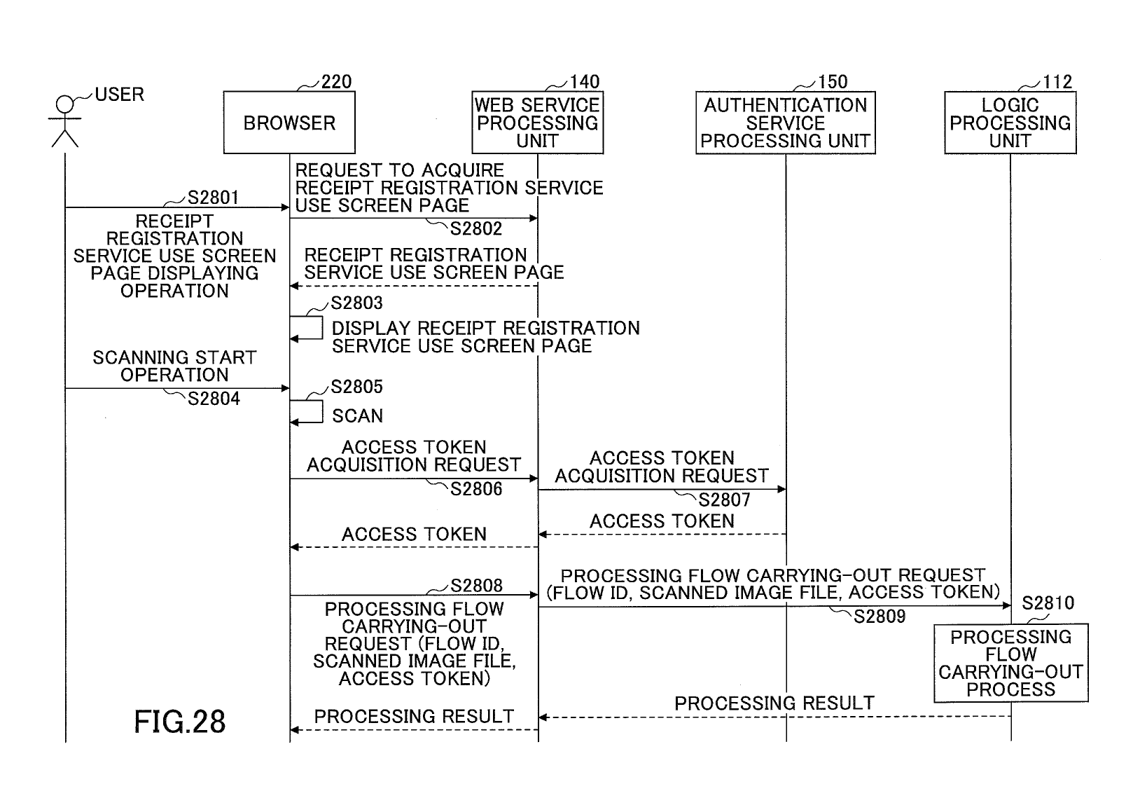

Now, a process where the user of apparatus 20 uses a receipt registration service, and registers receipt image files (i.e., image files of receipts) in an expense reimbursement service will be described with reference to FIG. 28. FIG. 28 is a sequence diagram illustrating one example of an overall process carried out when the user uses a receipt registration service according to the present embodiment.

First, the user uses the browser 220 of the apparatus 20 to perform a receipt registration service use screen page displaying operation (step S2801). The user can perform the receipt registration service use screen page displaying operation by pressing a display component of a link for a receipt registration service use screen page, for example, in a screen page displayed by the browser 220. It is also possible that the user performs the receipt registration service use screen page displaying operation by inputting, for example, the URL of the receipt registration service use screen page in the address bar of the browser 220, or the like.

After receiving the receipt registration service use screen page displaying operation, the browser 220 of the apparatus 20 transmits a request to acquire a receipt registration service use screen page to the Web service processing unit 140 of the service providing system 10 (step S2802).

After receiving the request to acquire a receipt registration service use screen page, the screen page configuring unit 141 of the Web service processing unit 140 acquires screen page information for displaying the receipt registration service use screen page from the screen page information storage unit 160. Then, the screen page configuring unit 141 returns the screen page information for displaying the receipt registration service use screen page to the browser 220.

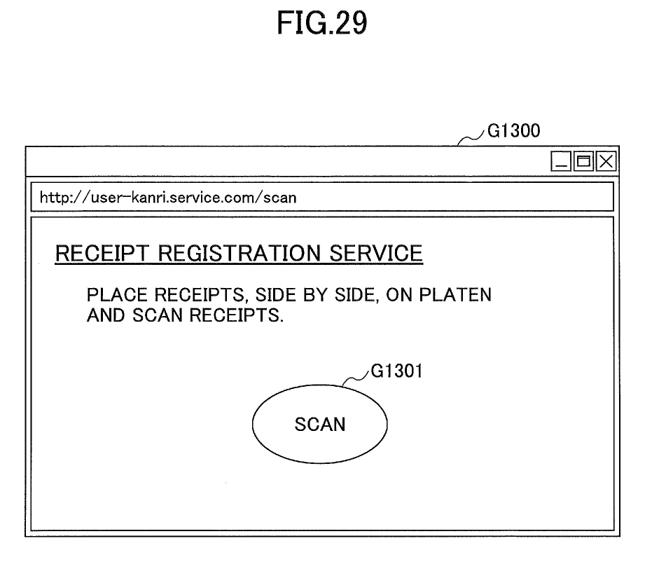

After receiving the screen page information for displaying the receipt registration service use screen page, the browser 220 displays the receipt registration service use screen page G1300, for example, as illustrated in FIG. 29, based on the screen page information for displaying the receipt registration service use screen page (step S2803).

The receipt registration service use screen page G1300 illustrated in FIG. 29 includes a scan button G1301 for generating a scanned image file. The user can perform a scanning start operation by pressing the scan button G1301 after placing one or more receipts on the scanner 26 of the apparatus 20.

The user uses the browser 220 to perform the scanning start operation (step S2804). After receiving the scanning start operation, the browser 220 reads each receipt from the scanner 26, and generates a scanned image file including areas where the respective receipts appear (step S2805). Note that, the browser 220 controls the scanner 26 by, for example, executing JavaScript included in the receipt registration service use screen page in response to the scanning start operation.

After the scanned image file is thus generated, the browser 220 transmits an access token acquisition request for an access token to be used to carry out authentication cooperation for an expense reimbursement service to the Web service processing unit 140 (step S2806).

After receiving the access token acquisition request from the browser 220, the screen page configuring unit 141 of the Web service processing unit 140 transmits the access token acquisition request to the authentication service processing unit 150 (step S2807).

After receiving the access token acquisition request, the authentication service processing unit 150 acquires the user ID of the user who is using the browser 220 that has transmitted the access token acquisition request in step S2806. Then, the authentication service processing unit 150 acquires the access token associated with the user ID from the token information storage unit 170, and returns the acquired access token to the Web service processing unit 140. Then, the Web service processing unit 140 returns the access token having been returned from the authentication service processing unit 150 to the browser 220.

For example, the user ID of the user who is using the browser 220 may be included in the access token acquisition request, or may be determined from the session ID or the like included in the access token acquisition request.

After receiving the access token, the browser 220 transmits a processing flow carrying-out request to the Web service processing unit 140 (step S2808). The processing flow carrying-out request includes the flow ID of the set of processing flow information 1100 for implementing a receipt registration service, the scanned image file, and the access token. The flow ID is, for example, associated with the scan button G1301 of the receipt registration service use screen page G1300.

After receiving the processing flow carrying-out request, the application execution unit 142 of the Web service processing unit 140 transmits the processing flow carrying-out request to the logic processing unit 112 (step S2809).

After receiving the processing flow carrying-out request, the logic processing unit 112 carries out a processing flow carrying-out process (step S2810). That is, the logic processing unit 112 carries out the sequence of processes based on the set of processing flow information 1100 identified by the flow ID included in the processing flow carrying-out request. At this time, the logic processing unit 112 uses the access token included in the processing flow carrying-out request to request the expense reimbursement system 40 to carry out various processes.

Actually, for example, the expense reimbursement component 420 uses the access token to transmit a ledger generation request to the expense reimbursement system 40. Also, for example, the expense reimbursement component 420 uses the access token to transmit a receipt registration request to the expense reimbursement system 40.

Thus, the user of the apparatus 20 can use a receipt registration service using the access token that has been previously stored in the service providing system 10. Therefore, the user of the apparatus 20 can use a receipt registration service without inputting the authentication information (i.e., the user name and the password, or the like, for the expense reimbursement system 40).

### Fourth Embodiment

A fourth embodiment will now be described. An expense reimbursement service may provide a service where an agent registers a receipt, or the like. This is because, for example, in some case, a person in charge of general affairs in a company performs receipt registration on behalf of all the other persons in the company. Therefore, according to the fourth embodiment, the expense reimbursement system 40 provides services where agents perform receipt registration, or the like, on behalf of other persons.

In the description of the fourth embodiment below, mainly points different from the first embodiment will be described, and the description for the functional configurations substantially the same as those in the first embodiment and the description for the processes substantially the same as those in the first embodiment will be appropriately omitted. Also, the same reference numerals as those in the first embodiment are given to the systems/apparatuses/devices/units corresponding to those in the first embodiment.

### <Functional Configuration>

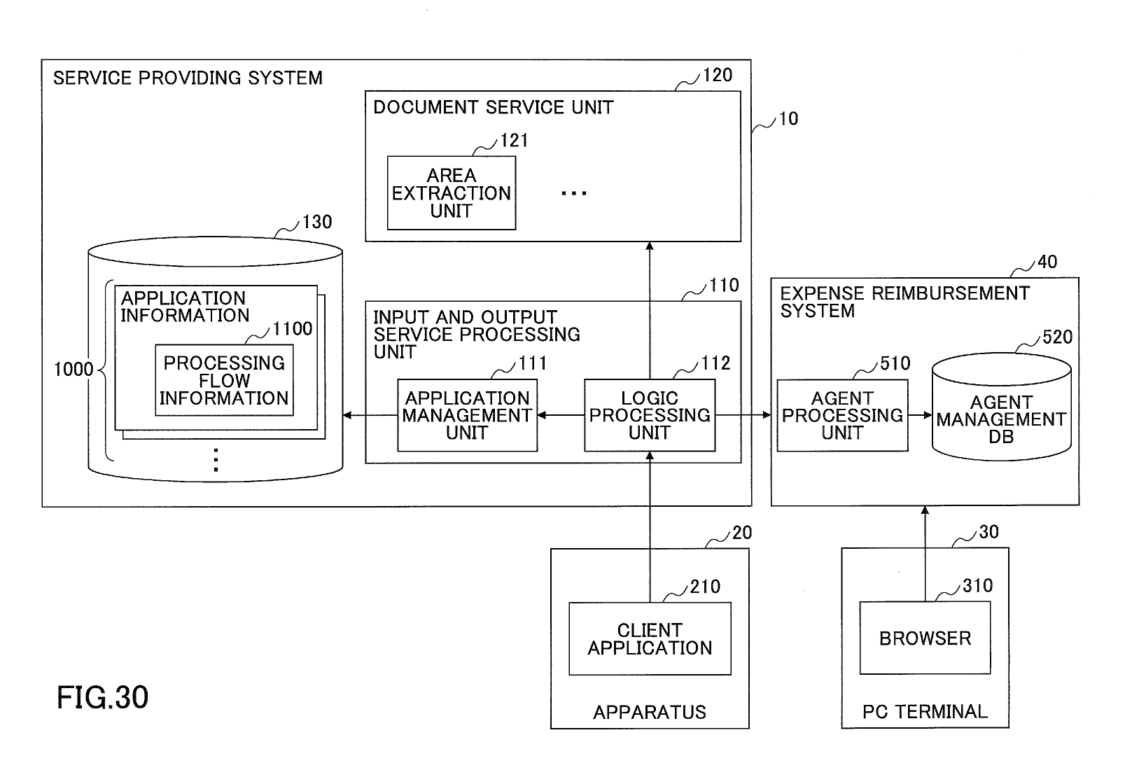

First, a functional configuration of the information processing system 1 according to the present embodiment will be described with reference to FIG. 30. FIG. 30 illustrates one example of a functional configuration of the information processing system 1 according to the present embodiment.

The expense reimbursement system 40 illustrated in FIG. 30 includes, for example, an agent processing unit 510 carrying out processes concerning receipt registration by an agent, and so forth, and an agent management DB 520 managing agents and to-be-represented persons. In the agent management DB 520, for example, user names of to-be-represented persons (who set agents) as well as user names and authorities of agents are stored in a state where the user names of to-be-represented persons are associated with the user names and the authorities of the agents. The authorities mean the scopes of functions that the agents are allowed to carry out, respectively.

The agent processing unit 510 carries out processes to store, for example, the user names of the to-be-represented persons (the persons who set the agents) as well as the user names and authorities of the agents in a state where the user names of the to-be-represented persons are associated with the user names and the authorities of the agents in the agent management DB 520. The agent processing unit 510 also carries out, for example, processes to check the authorities of the agents.

The logic processing unit 112 of the service providing system 10 according to the present embodiment responds to a request from the client application 210 to acquire a list (i.e., a to-be-represented person list) of other users for each of whom a user can act as an agent.

### <Process Details>

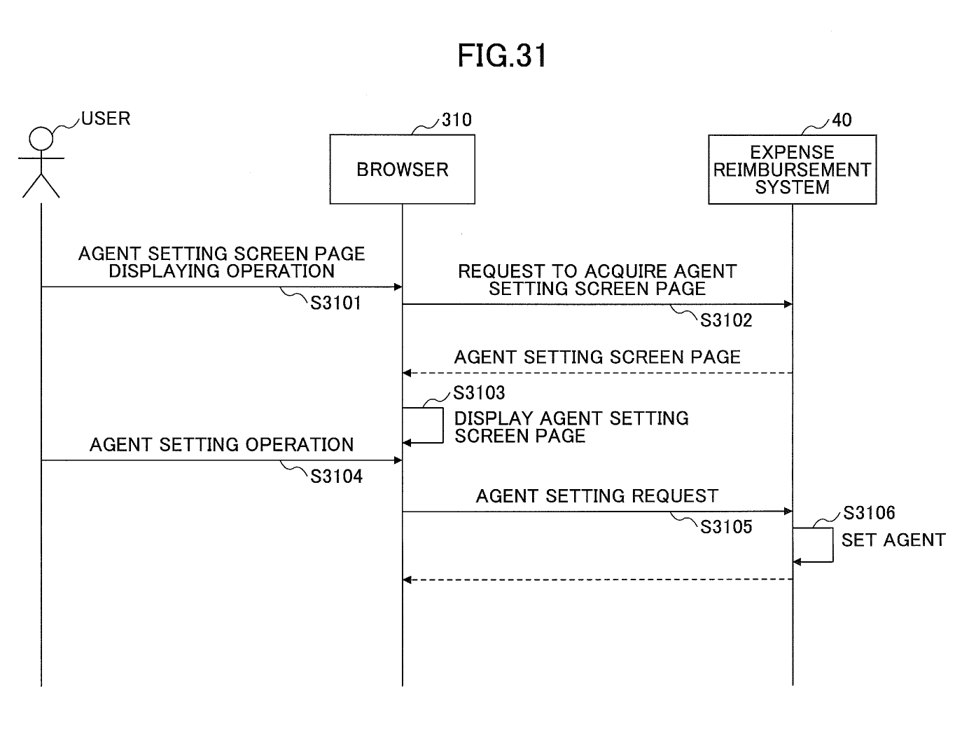

Then, processes of the information processing system 1 according to the present embodiment will now be described in detail. Below, a process in a case where the user of the PC terminal 30 sets an agent (in other words, in a case where the user sets an agent by whom the user will be represented) will be described with reference to FIG. 31. FIG. 31 is a sequence diagram illustrating one example of an agent setting process according to the present embodiment.

First, the user uses the browser 310 of the PC terminal 30 to perform an agent setting screen page displaying operation (step S3101). The user can actually perform the agent setting screen page displaying operation by, for example, pressing a display component of a link for an agent setting screen page in a certain screen page displayed by the browser 310. It is also possible for the user to perform the agent setting screen page displaying operation by, for example, inputting the URL of the agent setting screen page in the address bar of the browser 310, or the like.

After receiving the agent setting screen page displaying operation, the browser 310 of the PC terminal 30 transmits a request to acquire an agent setting screen page to the expense reimbursement system 40 (step S3102). After receiving the request to acquire an agent setting screen page, the expense reimbursement system 40 returns screen page information for displaying the agent setting screen page to the browser 310.

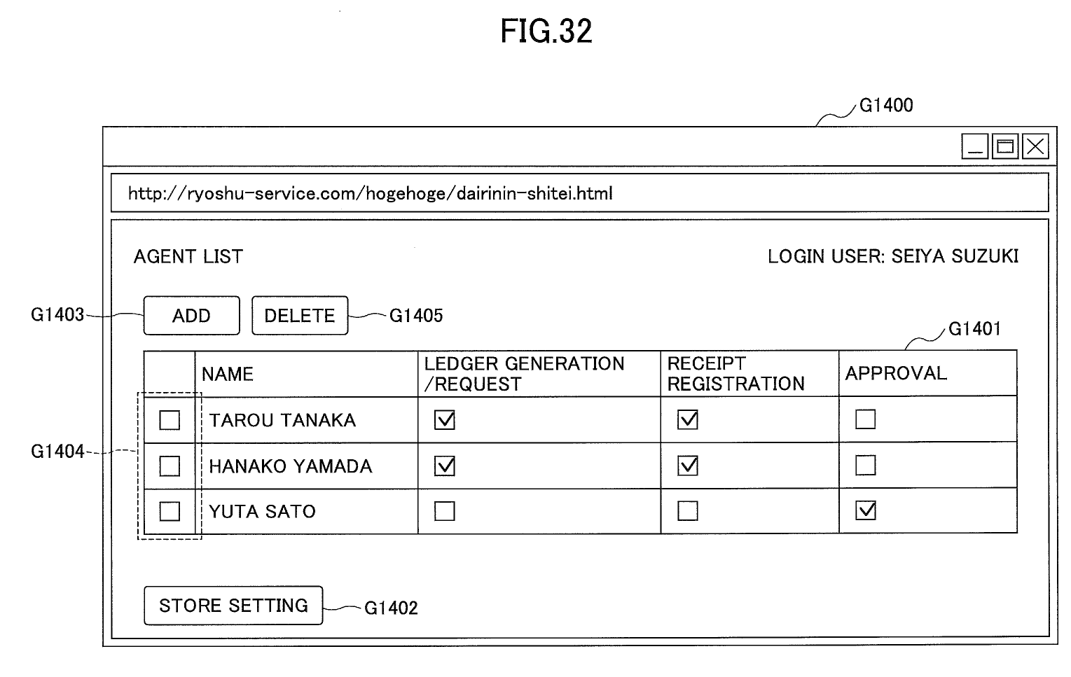

After receiving the screen page information for displaying the agent setting screen page, the browser 310 displays the agent setting screen page G1400, for example, illustrated in FIG. 32, based on the screen page information for displaying the agent setting screen page (step S3103).

The agent setting screen page G1400 illustrated in FIG. 32 includes an agent setting field G1401. The user selects a desired agent from the agent setting field G1401, and sets authority on the selected agent. Concerning the agent setting screen page G1400, hereinafter, a user who sets an agent may be referred to as a “to-be-represented user”, and a user who is set as an agent may be referred to as an “agent user”.

The authority in the agent setting field G1401 of the agent setting screen page G1400 illustrated in FIG. 32 includes “ledger generation/request”, “receipt registration”, and “approval”.

As a result of the to-be-represented user setting the authority (i.e., checking the corresponding check box), the agent user comes to be able to use the function that is thus set.

For example, it will be assumed that the to-be-represented user is “Seiya Suzuki”. At this time, if the authority “ledger generation/request” and the authority “receipt registration” are set for the agent user “Tarou Tanaka” by the to-be-represented user, as illustrated in FIG. 32, the agent user “Tarou Tanaka” can perform functions of “ledger generation/request” and “receipt registration” as the agent of the to-be-represented user “Seiya Suzuki”.

In the same way, for example, if the authority “approval” is set by the to-be-represented user for the agent user “Sato Yuta”, the agent user “Sato Yuta” comes to be able to perform a function of “approval” of registering receipts as the agent of the to-be-represented user “Seiya Suzuki”.

The to-be-represented user can perform the agent setting operation by pressing a “store setting” button G1402 after setting the agent and the authority in the agent setting field G1401. The to-be-represented user can add the agent user in the agent setting field G1401 by pressing an “add” button G1403. Also, the to-be-represented user can delete an agent user from the agent setting field G1401 by pressing a “delete” button G1405 after selecting the agent user in a checking field G1404.

The user (i.e., the to-be-represented user) uses the browser 310 to thus perform the agent setting operation (step S3104).

After receiving the agent setting operation, the browser 310 transmits an agent setting request to the expense reimbursement system 40 (step S3105). The agent setting request includes, for example, the user name of the agent user, the user name of the to-be-represented user, and the authority that has been set by the to-be-represented user.

After receiving the agent setting request, the agent processing unit 510 of the expense reimbursement system 40 carries out an agent setting process (step S3106). That is, the agent processing unit 510 associates the user name of the agent user, the user name of the to-be-represented user, and the authority that has been set by the to-be-represented user, included in the setting request, with each other, and stores the thus associated information in the agent management DB 520. Thus, the agent user for the to-be-represented user and the authority that is set for agent user are managed.

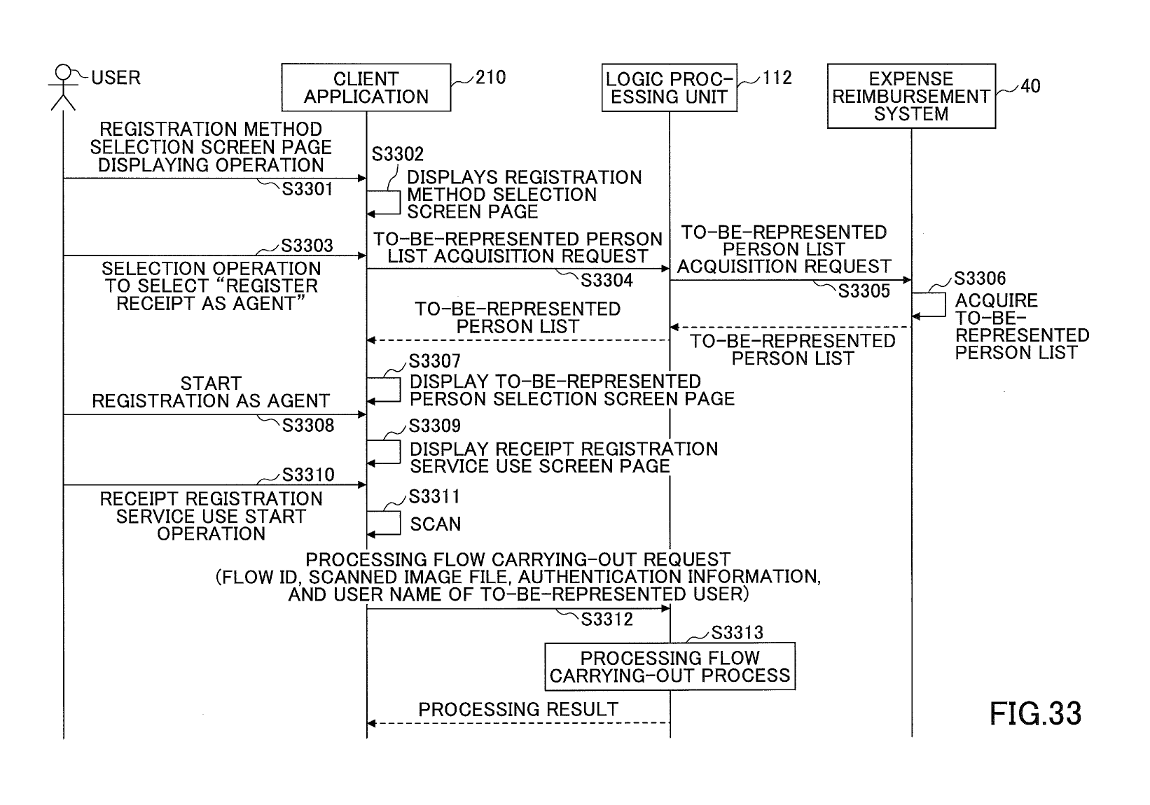

Now, a process where the user of the apparatus 20 uses a receipt registration service as an agent to register a receipt image file in an expense reimbursement service will be described with reference to FIG. 33. FIG. 33 is a sequence diagram illustrating one example of an overall process for a case where a user uses a receipt registration service as an agent according to the present embodiment.

First, the user uses the apparatus 20 to perform a registration method selection screen page displaying operation for selecting as an agent whether to register a receipt (step S3301). Then, the client application 210 of the apparatus 20 receives the registration method selection screen page displaying operation. The user can perform the registration method selection screen page displaying operation by, for example, selecting a certain icon in a certain screen page displayed by the client application 210. Note that, the registration method selection screen page displaying operation may be, actually, for example, the user's operation to start the client application 210.

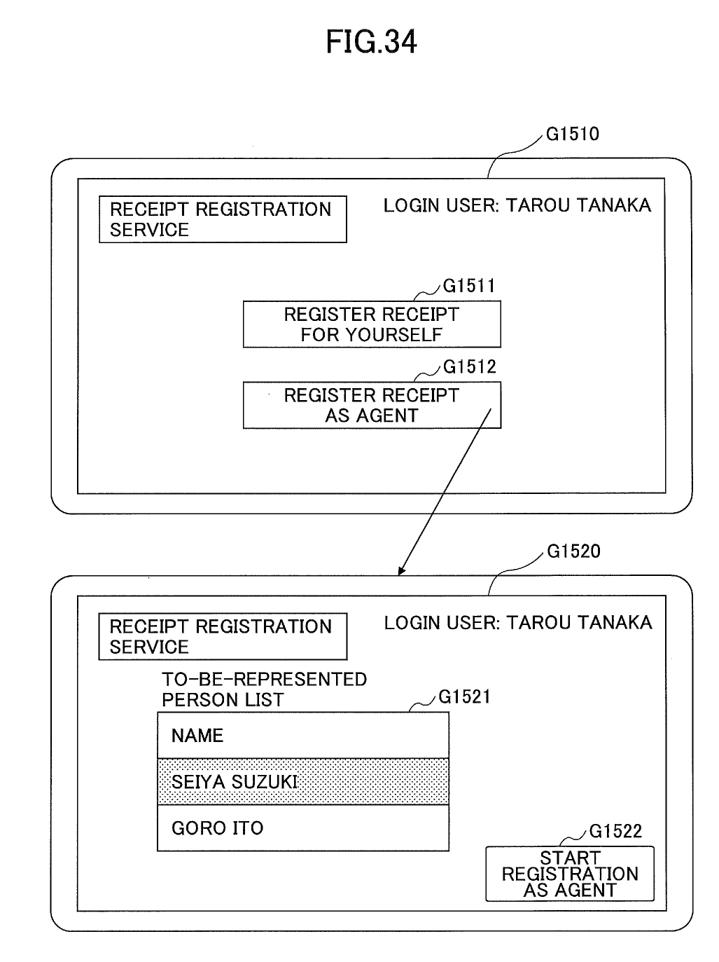

After receiving the registration method selection screen page displaying operation, the client application 210 displays a registration method selection screen page G1510, for example, illustrated in FIG. 34 (step S3302).

The registration method selection screen page G1510 illustrated in FIG. 34 includes a “register receipt for yourself” button G1511, and a “register receipt as agent” button G1512. The user can register a receipt in an expense reimbursement service by selecting the “register receipt as agent” button G1512 as an agent for another user. On the other hand, the user can register a receipt in an expense reimbursement service for himself or herself (that is, not as an agent for another user), as in the first embodiment, by selecting the “register receipt for yourself” button G1511. Below, the description will be continued assuming that the user selects the “register receipt as agent” button G1512.

The user uses the apparatus 20 to perform a selection operation by pressing the “register receipt as agent” button G1512 (step S3303). Then, the client application 210 receives the selection operation.

After receiving the selection operation, the client application 210 transmits a to-be-represented person list acquisition request for a to-be-represented person list that includes other users for each of whom the user can act as an agent to the logic processing unit 112 (step S3304). Note that, the to-be-represented person list acquisition request includes, for example, the user name of the user (that is, the user name of the user of the expense reimbursement system 40). It is also possible that the client application 210 transmits the to-be-represented person list acquisition request to the logic processing unit 112 via the application management unit 111.

After receiving the to-be-represented person list acquisition request, the logic processing unit 112 transmits the to-be-represented person list acquisition request to the expense reimbursement system 40 (step S3305).

After receiving the to-be-represented person list acquisition request, the agent processing unit 510 of the expense reimbursement system 40 acquires the user names of the to-be-represented users for each of whom the user of the user name included in the to-be-represented person list acquisition request is set as an agent user, from the agent management DB 520 (step S3306). In other words, the agent processing unit 510 acquires the other users each of whom the user of the user name included in the to-be-represented person list acquisition request can represent, from the agent management DB 520.

Then, the agent processing unit 510 of the expense reimbursement system 40 returns the acquired the list (i.e., the to-be-represented person list) of the user names (i.e., the user names of the to-be-represented users) to the logic processing unit 112. Thereafter, the logic processing unit 112 returns the received to-be-represented person list to the client application 210.

After receiving to-be-represented person list, the client application 210 displays a to-be-represented person selection screen page G1520, for example, illustrated in FIG. 34 (step S3307). The to-be-represented person selection screen page G1520 illustrated in FIG. 34 includes a to-be-represented person selection field G1521. The to-be-represented person selection field G1521 includes the user names or the like (that is, the user names or the like of the other users each of whom the user can represent) included in the to-be-represented person list returned from the logic processing unit 112. The user (i.e., the agent user) can perform an operation to start registration as an agent by pressing a “start registration as agent” button G1522 after selecting the other user whom the agent user will represent from the to-be-represented person selection field G1521.

The user (i.e., the agent user) uses the apparatus 20 to start registration as an agent (step S3308). Then, the client application 210 receives the agent user's operation to start registration as an agent.

After receiving the agent user's operation to start registration as an agent, the client application 210 displays a receipt registration service use start screen page G200, for example, illustrated in FIG. 10, as in the first embodiment (step S3309). Steps S3310-S3311 are the same as steps S903-S904 of FIG. 9, and therefore, duplicate description will be omitted.

After a scanned image file is generated in step S3311, the client application 210 transmits a processing flow carrying-out request to the logic processing unit 112 (step S3312). Note that, the processing flow carrying-out request includes the flow ID of the set of processing flow information 1100 implementing a receipt registration service, the scanned image file, the authentication information, and the user name of the to-be-represented user. The user name of the to-be-represented user is the user name of the other user selected from the to-be-represented person selection field G1521 of the to-be-represented person selection screen page G1520.

The description has been made such that the processing flow carrying-out request includes the authentication information (that is, the user name and the password of the user of the expense reimbursement system 40). However, alternatively, it is also possible that, for example, as in the third embodiment, the processing flow carrying-out request includes the access token. Note that, as the authentication information or the access token, the authentication information or the access token of the agent user is used.

Then, after receiving the processing flow carrying-out request, the logic processing unit 112 carries out a processing flow carrying-out process (step S3313). That is, the logic processing unit 112 carries out the sequence of processes based on the set of processing flow information 1100 having the flow ID included in the processing flow carrying-out request. At this time, the logic processing unit 112 carries out generation of a ledger, and registration of receipts using the name of the to-be-represented user.

Actually, for example, the expense reimbursement component 420 transmits a ledger generation request that includes the user name of the to-be-represented user to the expense reimbursement system 40. Also, for example, the expense reimbursement component 420 transmits a receipt registration request that includes the user name of the to-be-represented user to the expense reimbursement system 40. Thus, in the expense reimbursement system 40, a ledger is generated for the user name of the to-be-represented user, and receipts are registered in the ledger for the user name of the to-be-represented user.

The expense reimbursement system 40 checks the authority of the agent user through the agent processing unit 510 when, for example, the ledger generation or the receipt registration is carried out. That is, the agent processing unit 510 determines whether the authority for the requested function (i.e., the ledger generation, the receipt registration, or the like) has been set to the agent user. Then, if the authority for the requested function has been set to the agent user, the agent processing unit 510 carries out the requested function. If the authority for the requested function has not been set to the agent user, the agent processing unit 510 returns an error, for example, to the logic processing unit 112.

Thus, according to the fourth embodiment, the user of the apparatus 20 can use a receipt registration service as an agent of another user. Therefore, for example, when a person in charge of general affairs will perform receipt registration of all persons in a company, for example, the person in charge of general affairs can perform receipt registration of other persons as an agent of the other persons by previously setting the person in charge of general affairs as the agent.

With reference to FIG. 33, a case where the apparatus 20 is an image forming apparatus has been described. However, in the same way as the second embodiment, the apparatus 20 may be, for example, a smartphone, a tablet terminal, a digital camera, or the like.

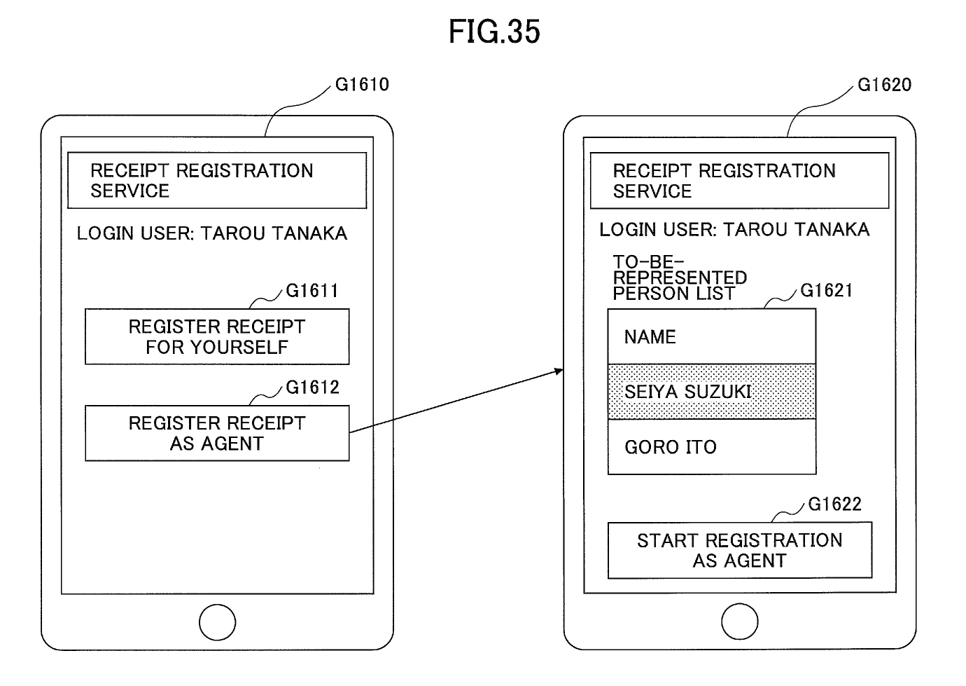

In this case, in step S3302 of FIG. 33, the apparatus 20 displays a registration method selection screen page G1610, for example, illustrated in FIG. 35. The registration method selection screen page G1610 illustrated in FIG. 35 includes, in the same way as the registration method selection screen page G1510 illustrated in FIG. 34, a “register receipt for yourself” button G1611, and a “register receipt as agent” button G1612.

Also, in step S3307 of FIG. 33, the apparatus 20 displays a to-be-represented person selection screen page G1620, for example, illustrated in FIG. 35. The to-be-represented person selection screen page G1620 illustrated in FIG. 35 includes, in the same way as the to-be-represented person selection screen page G1510 illustrated in FIG. 34, a to-be-represented person selection field G1621, and a “start registration as agent” button G1622.

Thus, the present embodiment can be applied also to a case where, in the same way as the second embodiment, the apparatus 20 is a smartphone, a tablet terminal, a digital camera, or the like, in the same way.

### Fifth Embodiment

A fifth embodiment will now be described. There is such a type of an expense reimbursement service that, in addition to a receipt image file, other information (i.e., meta information) such as a money amount, a date, or the like, of a receipt, is registered. According to the fifth embodiment, a template is used, and meta information is registered in the expense reimbursement system 40, in addition to a receipt image file, after the meta information is extracted from a receipt image file.

In the following description of the fifth embodiment, mainly the points different from the first embodiment will be described, and description of the parts having substantially the same functional configurations as those the first embodiment and description of the parts implementing substantially the same processes as those in the first embodiment will be appropriately omitted. Also, the same reference numerals as those in the first embodiment are given to the systems/apparatuses/devices/units corresponding to those in the first embodiment.

### <Functional Configuration>

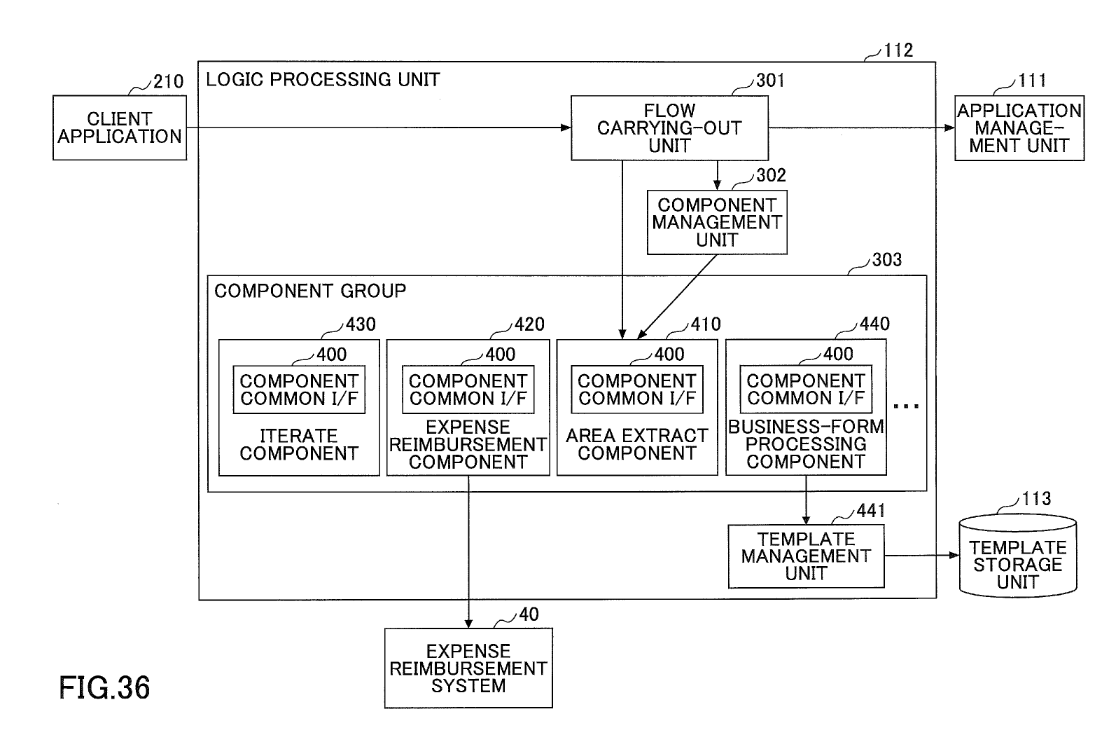

First, a functional configuration of the logic processing unit 112 of the apparatus 20 of the information processing system 1 according to the present embodiment will be described with reference to FIG. 36. FIG. 36 illustrates one example of a functional configuration of the logic processing unit 112 according to the present embodiment.

The logic processing unit 112 illustrated in FIG. 36 includes a template management unit 441. Also, the component group 303 of the logic processing unit 112 illustrated in FIG. 36 includes a business-form processing component 440.

The template management unit 441 manages templates stored in a template storage unit 113. The templates mean information for extracting meta information (for example, money amounts, dates, or the like of receipts) from receipt image files. The template storage unit 113 is included in the service providing system 10, and can be implemented by the HDD 18.

The business-form processing component 440 acquires meta information from receipt image files using a template. As described above, meta information includes, for example, information such as money amounts or dates included in receipt images in receipt image files. Meta information may be, for example, numerals, characters (that may be alphabetical characters, Chinese characters, or the like), or the like. Meta information further may be combinations of numerals, characters, and so forth.

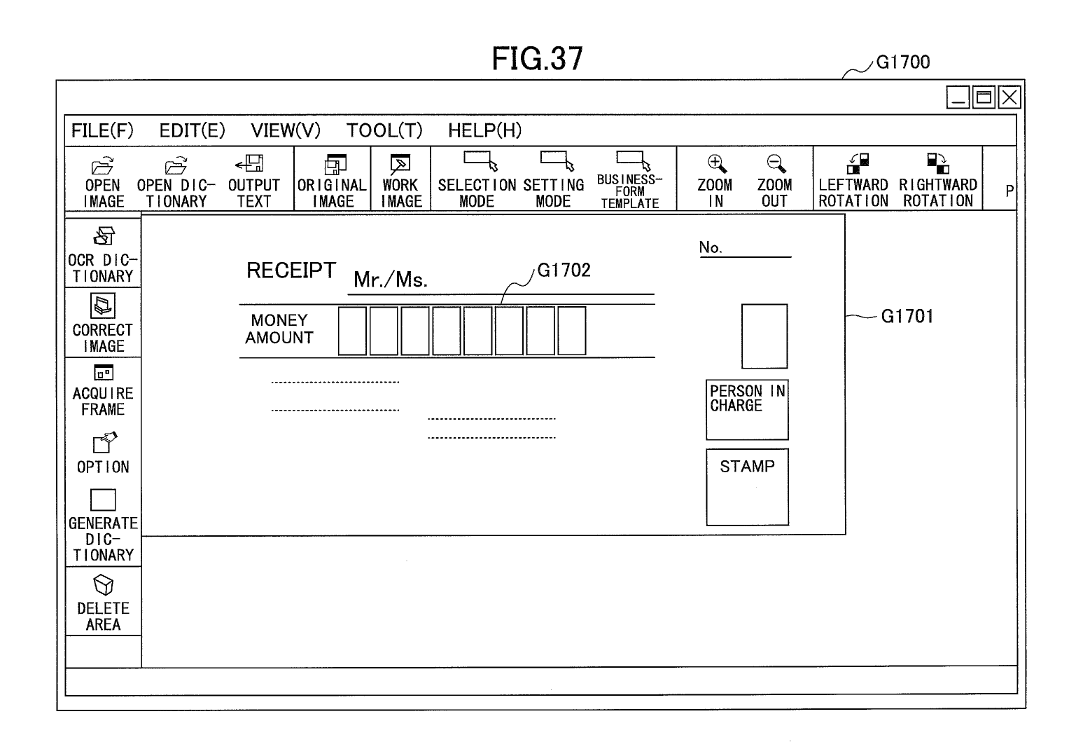

The respective templates stored in the template storage unit 113 can be registered in the service providing system 10, using, for example, a template registration screen page G1700 illustrated in FIG. 37. The template registration screen page G1700 illustrated in FIG. 37 includes a receipt image G1701. The receipt image G1701 includes extracting positions G1702 that define positions for extracting meta information.

The user can generate and register a template by displaying the template registration screen page G1700, for example, illustrated in FIG. 37, on the apparatus 20 or the PC terminal 30, and then, defining the extracting positions G1702 in the receipt image G1701.

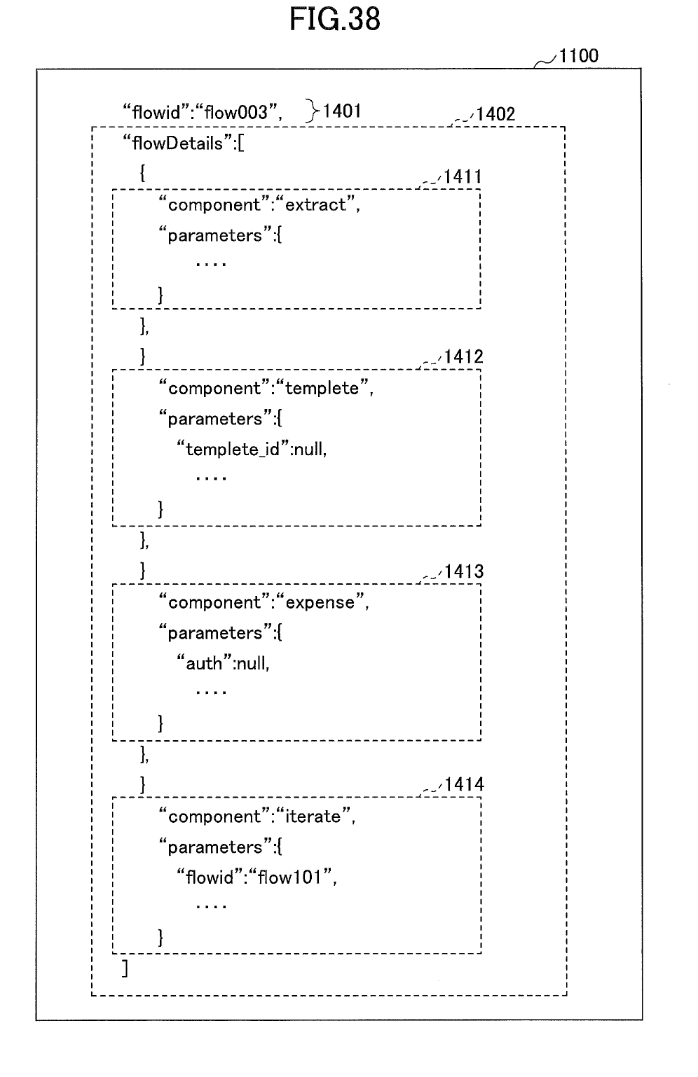

A set of processing flow information 1100 in which a sequence of processes (i.e., a processing flow) for implementing a receipt registration service according to the present embodiment are defined will now be described with reference to FIG. 38. FIG. 38 illustrates one example of a set of processing flow information 1100 in which s sequence of processes for implementing a receipt registration service according to the present embodiment are defined.

The set of processing flow information 1100 illustrated in FIG. 38 includes a flow ID 1401 identifying the set of processing flow information 1100, and a flow detail 1402 in which the process contents of each of the processes included in the processing flow are defined.

The flow detail 1402 includes processing definitions 1411-1414 in which the process contents of the processes included in the processing flow are defined, respectively. From among the processing definitions 1411-1414, the processing definitions 1411, 1413, and 1414 are the same as the processing definitions 1111, 1112, and 1113 of the set of processing flow information 1100 illustrated in FIG. 7, respectively.

For “component” of the processing definition 1412, the component name “template” of the business-form processing component 440 is defined. For “parameters” of the processing definition 1412, parameter information for the business-form processing component 440 is defined.

For “parameters” of the processing definition 1412, parameter information ‘“template_id”: null’ for setting identification information (i.e., a template ID) identifying a template used by the business-form processing component 440 is defined.

Thus, in the set of processing flow information 1100, the components carrying out the respective processes included in the sequence of processes, and the parameter information for the components are defined.

Thus, the expense reimbursement component 420 registers meta information extracted by the business-form processing component 440, and receipt image files extracted by the area extract component 410 in a generated ledger.

### <Process Details>

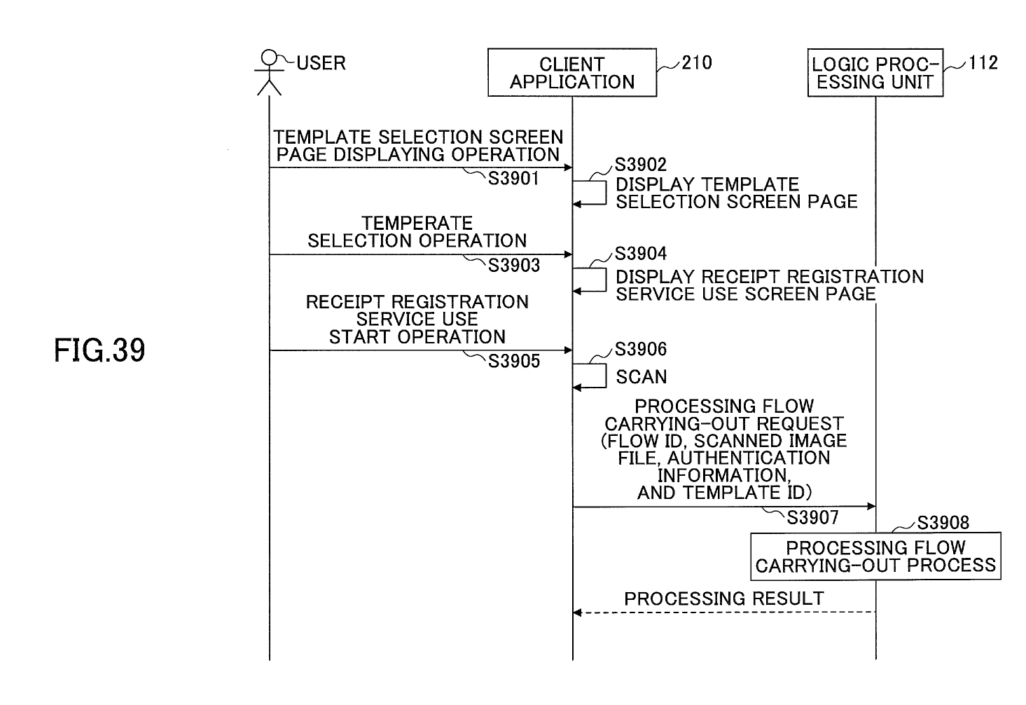

Now, processes of the information processing system 1 according to the present embodiment will be described in detail. Below, a process where the user of the apparatus 20 uses a receipt registration service to register receipt image files and meta information extracted from the receipt image files in an expense reimbursement service will be described with reference to FIG. 39. FIG. 39 is a sequence diagram illustrating one example of an overall process carried out when a receipt registration service according to the present embodiment is used.

First, the user uses the apparatus 20 to perform a template selection screen page displaying operation for selecting a template (step S3901). Then, the client application 210 of the apparatus 20 receives the template selection screen page displaying operation. The user can perform the template selection screen page displaying operation by, for example, selecting a certain icon in a certain screen page displayed by the client application 210. Note that, the template selection screen page displaying operation may be, actually, for example, an operation to start the client application 210.

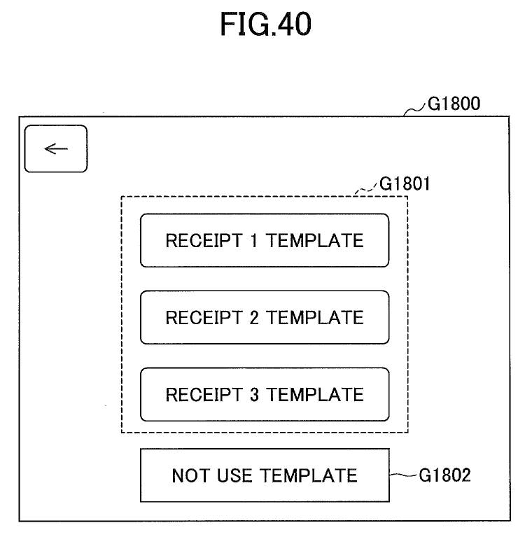

After receiving the template selection screen page displaying operation, the client application 210 displays a template selection screen page G1800, for example, illustrated in FIG. 40 (step S3902).

The template selection screen page G1800 illustrated in FIG. 40 includes a template selection field G1801. The user can perform a template selection operation by selecting a desired template from the template selection field G1801.

The user can use a receipt registration service without using a template by pressing a “not use template” button G1802. Below, the description will be continued assuming that the user performs the template selection operation.

The user uses the apparatus 20 to perform the template selection operation (step S3903). Then, the client application 210 receives the template selection operation. Because steps S3904-S3906 are the same as steps S902-S904 of FIG. 9, duplicate description will be omitted.

After a scanned image file is generated in step S3904, the client application 210 transmits a processing flow carrying-out request to the logic processing unit 112 (step S3907). The processing flow carrying-out request includes the flow ID “flow003” of the set of processing flow information 1100 illustrated in FIG. 38, the scanned image file, and the authentication information. Also, the processing flow carrying-out request includes the template ID of the template selected from the template selection field G1801 of the template selection screen page G1800 illustrated in FIG. 40.

It has been described that the processing flow carrying-out request includes the authentication information (that is, the user name and the password for the expense reimbursement system 40). However, instead, it is also possible that, for example, in the same way as the third embodiment, the processing flow carrying-out request includes the access token.

Then, after receiving the processing flow carrying-out request, the logic processing unit 112 carries out a processing flow carrying-out process (step S3908). That is, the logic processing unit 112 carries out the sequence of processes based on the set of processing flow information 1100 of the flow ID included in the processing flow carrying-out request.

Then, the logic processing unit 112 returns the processing result of the processing flow carrying-out process to the client application 210. Thus, the service providing system 10 according to the present embodiment can provide, to the apparatus 20, a receipt registration service implemented by the sequence of processes based on the set of processing flow information 1100 illustrated in FIG. 38.

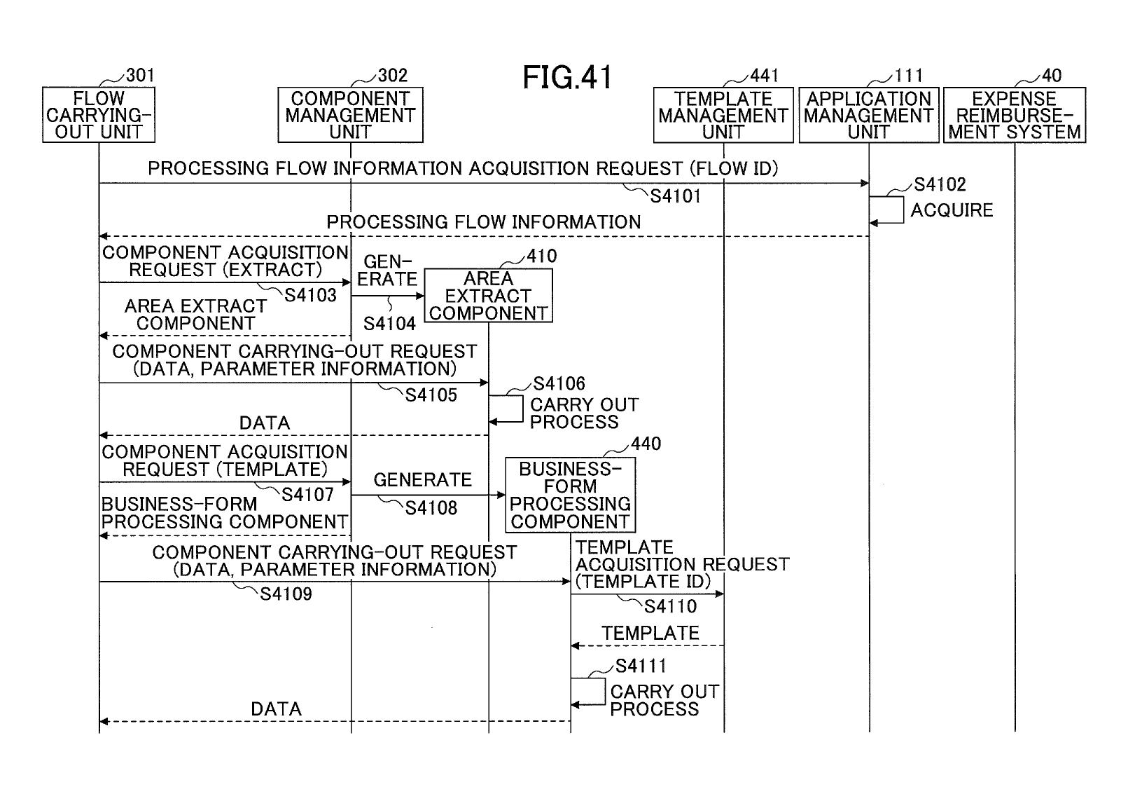

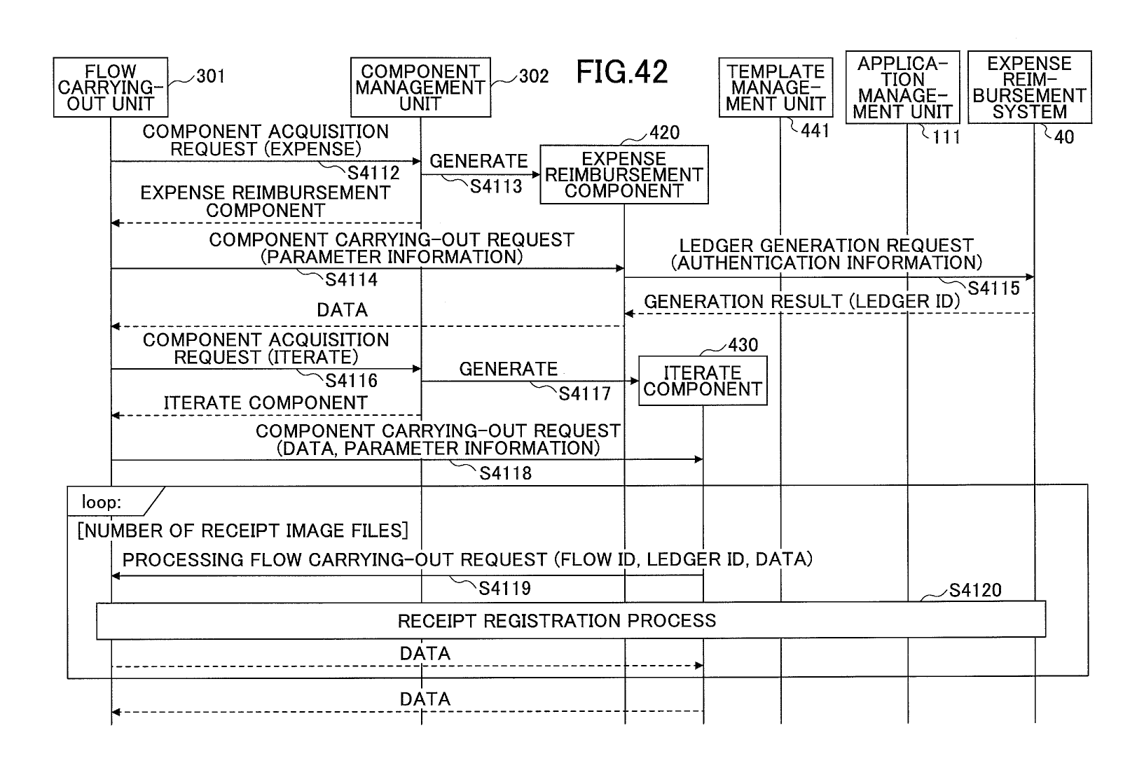

A process of the processing flow carrying-out process illustrated in FIG. 39 (i.e., step S3908) will now be described in detail, with reference to FIGS. 41 and 42. FIGS. 41 and 42 are a sequence diagram illustrating one example of the processing flow carrying-out process that implements a receipt registration service according to the present embodiment.

First, after receiving the processing flow carrying-out request from the client application 210, the flow carrying-out unit 301 transmits a processing flow information acquisition request to the application management unit 111 (step S4101). The processing flow information acquisition request includes the flow ID “flow003” acquired from the processing flow carrying-out request.

After receiving the processing flow information acquisition request, the application management unit 111 acquires the set of processing flow information 1100 of the flow ID “flow003” included in the processing flow information acquisition request from the application information 1000 stored in the application information storage unit 130 (step S4102). That is, the application management unit 111 acquires the set of processing flow information 1100 illustrated in FIG. 38 from the application information storage unit 130.

Then, the application management unit 111 returns the set of processing flow information 1100 acquired from the application information storage unit 130 to the logic processing unit 112.

The flow carrying-out unit 301 transmits a component acquisition request based on the set of processing flow information 1100 illustrated in FIG. 38 to the component management unit 302 (step S4103). That is, the flow carrying-out unit 301 transmits a component acquisition request having the component name “extract” defined for “component” included in the processing definition 1411 of the set of processing flow information 1100 illustrated in FIG. 38 to the component management unit 302.

Steps S4104-S4106 are the same as steps S1104-S1106 of FIG. 11, and therefore, duplicate description will be omitted.

Subsequent to step S4106, the flow carrying-out unit 301 transmits a component acquisition request based on the set of processing flow information 1100 illustrated in FIG. 38 to the component management unit 302 (step S4107). That is, the flow carrying-out unit 301 transmits a component acquisition request having the component name “template” defined for “component” included in the processing definition 1412 of the set of processing flow information 1100 illustrated in FIG. 38 to the component management unit 302.

After receiving the component acquisition request, the component management unit 302 generates a component having the component name “template” (that is, the business-form processing component 440) (step S4108). Note that, generating the business-form processing component 440 can be implemented by using the API prepared for generating components defined in the component common I/F 400.

Then, the component management unit 302 returns the generated business-form processing component 440 to the flow carrying-out unit 301. That is, the component management unit 302 returns, for example, an address at which the business-form processing component 440 is loaded in a memory (for example, the RAM 14) to the flow carrying-out unit 301.

Then, the flow carrying-out unit 301 transmits a component carrying-out request to the business-form processing component 440 (step S4109).

The component carrying-out request includes data indicating a receipt image file generated by the area extract component 410. Therefore, the component carrying-out request includes respective sets of data indicating a plurality of the receipt image files if the area extract component 410 generates the plurality of the receipt image files.

Also, the component carrying-out request includes respective sets of parameter information defined for “parameters” included in the set of processing definition 1412 of the set of processing flow information 1100 illustrated in FIG. 38. That is, the component carrying-out request includes parameter information in which the template ID of the template selected from the template selection screen page G1800 illustrated in FIG. 40 is set to parameter information ‘“template_id”: null’. For example, if the “receipt 1 template” having the parameter ID “temp1” is selected, the parameter information is ‘“template_id”: “temp1”’.

After receiving the component carrying-out request, the business-form processing component 440 transmits a template acquisition request for acquiring the template having the template ID included in the component carrying-out request to the template management unit 441 (step S4110). After receiving the template acquisition request, the template management unit 441 acquires the template having the template ID included in the template acquisition request from the template storage unit 113, and returns the acquired template to the business-form processing component 440.

After receiving the template from the template management unit 441, the business-form processing component 440 extracts meta information from the receipt image file indicated by the data, based on the template (step S4111). That is, the business-form processing component 440 extracts meta information (for example, a money amount, a date, and so forth) from the image area indicated by the receipt image file at the extracting positions defined by the template.

Then, the business-form processing component 440 returns the extracted meta information to the flow carrying-out unit 301.

Then, the flow carrying-out unit 301 transmits a component acquisition request based on the set of processing flow information 1100 illustrated in FIG. 38 to the component management unit 302 (step S4112). That is, the flow carrying-out unit 301 transmits a component acquisition request for a component having the component name “expense” defined for “component” include in the processing definition 1413 of the set of processing flow information 1100 illustrated in FIG. 38 to the component management unit 302.

After receiving the component acquisition request, the component management unit 302 generates a component having the component name “expense” (that is, the expense reimbursement component 420) (step S4113). Generating the expense reimbursement component 420 can be implemented by using the API prepared for generating components defined in the component common I/F 400.

Then, the component management unit 302 returns the generated expense reimbursement component 420 to the flow carrying-out unit 301. That is, the component management unit 302 returns, for example, an address at which the expense reimbursement component 420 is loaded in a memory (for example, the RAM 14) to the flow carrying-out unit 301.

Steps S4114-S4115 are the same as steps S1109-S1110 of FIG. 11, and therefore, duplicate description will be omitted.

Subsequent to step S4115, the flow carrying-out unit 301 transmits a component acquisition request based on the set of processing flow information 1100 illustrated in FIG. 38 to the component management unit 302 (step S4116). That is, the flow carrying-out unit 301 transmits the component acquisition request for a component having the component name “iterate” defined for “component” included in the processing definition 1414 of the set of processing flow information 1100 illustrated in FIG. 38 to the component management unit 302.

After receiving the component acquisition request, the component management unit 302 generates a component having the component name “iterate” (that is, the iterate component 430) (step S4117). Generating the iterate component 430 can be implemented by using the API prepared for generating components defined in the component common I/F 400.

Then, the component management unit 302 returns the generated iterate component 430 to the flow carrying-out unit 301. That is, the component management unit 302 returns, for example, an address at which the iterate component 430 is loaded in a memory (for example, the RAM 14) to the flow carrying-out unit 301.

Then, the flow carrying-out unit 301 transmits a component carrying-out request to the iterate component 430 (step S4118).

The component carrying-out request includes the receipt image file generated by the area extract component 410 and data indicating the meta information extracted from the receipt image file by the business-form processing component 440. Therefore, the component carrying-out request includes respective sets of data indicating a plurality of receipt image files and a plurality of sets of meta information if the area extract component 410 has generated the plurality of receipt image files.

Also, the component carrying-out request includes respective sets of parameter information defined for “parameters” included in the set of processing definition 1113 of the set of processing flow information 1100 illustrated in FIG. 38. That is, the component carrying-out request includes parameter information ‘“flowid”: “flow101”’, and parameter information indicating the ledger ID returned in step S4115.

After receiving the component carrying-out request, the iterate component 430 transmits a processing flow carrying-out request to the flow carrying-out unit 301 (step S4119) for each of the sets of data (that is, each of the receipt image files and each of the sets of meta information extracted from the receipt image files) included in the component carrying-out request. That is, the iterate component 430 carries out the receipt registration process of step S4120 iteratively the number of times equal to the number of the receipt image files. The processing flow carrying-out request includes the data (that is, the receipt image files and the sets of meta information), the flow ID “flow101”, and the ledger ID.

After receiving the processing flow carrying-out request, the flow carrying-out unit 301 carries out a receipt registering process for registering the receipt image files and the sets of meta information in the ledger identified by the ledger ID concerning the expense reimbursement service (step S4120). Then, the flow carrying-out unit 301 returns the processing result of the receipt registration process to the iterate component 430.

Thereafter, the iterate component 430 returns data indicating the processing result of iteratively carrying out the receipt registration process of step S4120 to the flow carrying-out unit 301.

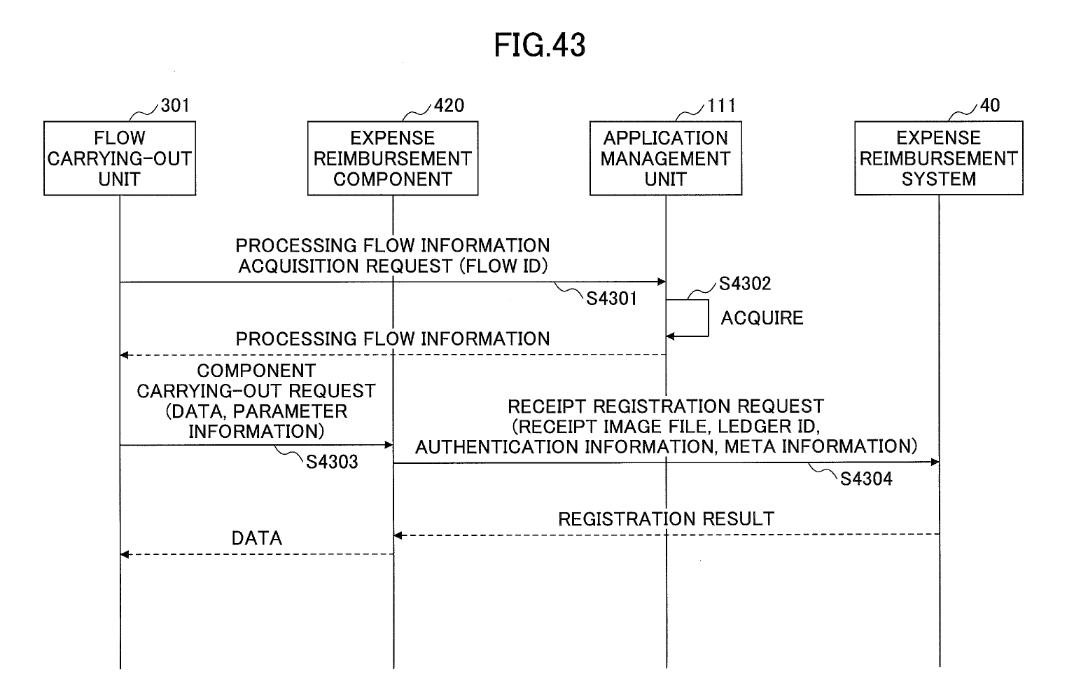

The receipt registration process in step S4120 will now be described in detail with reference to FIG. 43. FIG. 43 is a sequence diagram illustrating one example of a receipt registration process according to the present embodiment. Steps S4301-S4302 of FIG. 43 are the same as steps S1201-S1202 of FIG. 12, and therefore, duplicate description will be omitted.

Subsequent to step S4302, the flow carrying-out unit 301 transmits a component carrying-out request to the component having the component name “expense” defined for “component” included in the processing definition 1211 of the set of processing flow information 1100 illustrated in FIG. 8 (step S4303). That is, the flow carrying-out unit 301 transmits the component carrying-out request to the expense reimbursement component 420.

The component carrying-out request includes the data (that is, the receipt image files and the sets of meta information). Also, the component carrying-out request includes parameter information in which the authentication information is set to parameter information ‘“auth”: null’, and parameter information for requesting the expense reimbursement system 40 to register the receipts, and parameter information indicating the ledger ID.

After receiving the component carrying-out request, the expense reimbursement component 420 uses the data and the parameter information to carry out a process (step S4304). That is, the expense reimbursement component 420 transmits a receipt registration request to the expense reimbursement system 40. The expense reimbursement component 420 can transmit the receipt registration request by using, for example, a WebAPI disclosed by the expense reimbursement system 40. Also, the receipt registration request includes the receipt image files, the sets of meta information, the ledger ID, and the authentication information.

Then, the expense reimbursement system 40 registers the receipt image files and the sets of meta information in the ledger identified by the ledger ID, and returns the registration result to the expense reimbursement component 420. Then, the expense reimbursement component 420 returns data indicating the registration result to the flow carrying-out unit 301.

Thus, the expense reimbursement component 420 can register the receipt image files and the sets of meta information in the ledger concerning the expense reimbursement service by requesting the expense reimbursement system 40 to register the receipts.

Thus, the case where the user selects the template from, for example, the template selection screen page G1800 illustrated in FIG. 40 has been described. However, the service providing system 10 according to the present embodiment is not limited to the described case. For example, it is also possible that a template to be used in step S4111 is determined, and the business-form processing component 440 transmits a template acquisition request for acquiring the determined template to the template management unit 411 in step S4110. Determining a template in this case can be implemented in such a manner that, for example, after respective similarities are calculated between the receipt image files and the templates stored in the template storage unit 113, the template having the highest similarity (or the template having a similarity higher than a certain value) will be determined to be used.

### Summary of First Through Fifth Embodiments

The service providing system 10 according to the first embodiment provides, to the apparatus 20, a receipt registration service that is in cooperation with the expense reimbursement system 40. Therefore, the user of the apparatus 20 can register an image file of an piece of paper for evidence in the expense reimbursement system 40 by scanning, using the apparatus 20, the piece of paper for evidence such as a receipt, a simple receipt, or the like, usable as evidence for an expense.

According to the service providing system 10 of the second embodiment, the user of the apparatus 20 can register an image file of an piece of paper for evidence such as a receipt, a simple receipt, or the like, usable as evidence for an expense in the expense reimbursement system 40 by photographing, using the apparatus 20, the piece of paper for evidence.

Therefore, when a user will make expense reimbursement using an expense reimbursement service provided by the expense reimbursement system 40, the user can easily register an piece of paper for evidence such as a receipt, a simple receipt, or the like, usable as evidence for an expense in the expense reimbursement system 40 using the service providing system 10 according to the first or second embodiment.

The service providing system 10 according to the third embodiment carries out authentication cooperation with the expense reimbursement system 40 using, for example, OAuth, or the like. Thus, by using the service providing system 10 according to third embodiment, the user of the apparatus 20 can use a receipt registration service without inputting authentication information (i.e., the user name and the password, or the like, for using the expense reimbursement service) each time when using the expense reimbursement service.

Also, by using the service providing system 10 according to the fourth embodiment, the user of the apparatus 20 can use a receipt registration service as an agent of another user. By using the service providing system 10 according to the fourth embodiment, a person in charge of general affairs in a company, for example, can perform a receipt registration work for all the persons in the company, for example.

The service providing system 10 according to the fifth embodiment registers also meta information (for example, a money amount, a date, or the like) in the expense reimbursement system 40, the meta information being extracted from a receipt image file using a template.

### Sixth Embodiment

### <System Configuration>

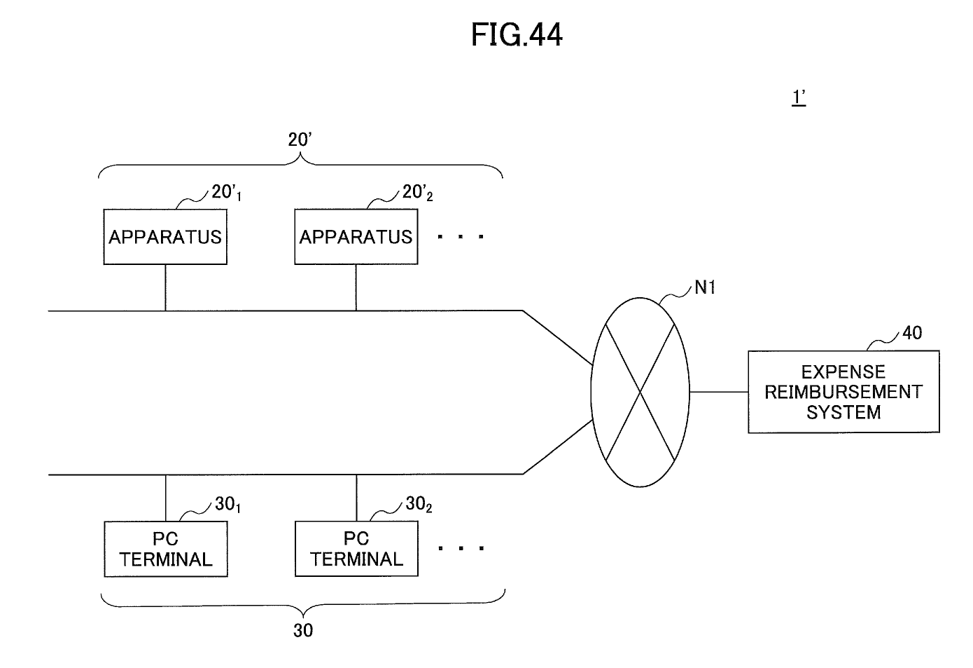

A system configuration of an information processing system 1′ according to a sixth embodiment will now be described with reference to FIG. 44. FIG. 44 illustrates one example of a system configuration of the information processing system 1′ according to the sixth embodiment.

The information processing system 1′ illustrated in FIG. 44 includes apparatuses 20′, PC terminals 30, and an expense reimbursement system 40. These system elements are communicatably connected together via a wide-area network N1 such as the Internet.

The apparatuses 20′ may be various electronic apparatuses that users use. For example, the apparatuses 20 may be various electronic apparatuses, for example, image forming apparatuses such as MFPs (MultiFunction Peripherals), smartphones, tablet terminals, digital cameras, projectors, electronic blackboards, and so forth.

Each of the apparatuses 20′ provides various services, each service being implemented by a sequence of processes, i.e., combinations of one or more processes from among a plurality of processes that implement various functions, respectively.

Actual examples of the various functions are, for example, a printing function, a scanning function, a facsimile transmission function, a data format conversion function, a mail delivery function, an OCR (Optical Character Recognition) function, a function to modify information, an information compressing/decompression function, a function to store information in a repository, and so forth. The actual examples of the various functions further include a function to cooperate with an external service (for example, an expense reimbursement service provided by the expense reimbursement system 40).

Below, each of the apparatuses 20′ provides a service (which may be referred to as a “receipt registration service”) implemented by a sequence of processes that include a process to incorporate with an expense reimbursement service. Hereinafter, a “sequence of processes” may be referred to as a “processing flow”.

Hereinafter, for distinguishing the respective apparatuses 20′, the apparatuses 20′ may be referred to as an “apparatus 20′₁”, an “apparatus 20′₂”, and so forth, using subscripts.

The PC terminals 30 may be, for example, desktop PCs (Personal Computers), notebook-type PCs, smartphones, tablet terminals, or the like, used by users. The users can use expense reimbursement services provided by the expense reimbursement system 40.

Hereinafter, for distinguishing the respective PC terminals 30, the PC terminals 30 may be referred to as “a PC terminal 30₁”, a “PC terminal 30₂”, and so forth, using subscripts.

The expense reimbursement system 40 is a computer system providing expense reimbursement services via the network N1. Expense reimbursement services are services for reimbursing expenses such as travelling expenses, costs of entertaining clients, or the like. The users use, for example, browsers installed in the PC terminals 30, to access the expense reimbursement system 40, and use expense reimbursement services.

The configuration of the information processing system 1′ illustrated in FIG. 44 is one example, and the information processing system 1′ may have another configuration. For example, the information processing system 1′ according to the present embodiment may include various devices that carry out at least one of inputting and outputting electronic data, and the devices provide receipt registration services.

### <Hardware Configuration>

A hardware configuration of each of the apparatuses 20′ included in the information processing system 1′ according to the present embodiment in a case where the apparatus 20′ is an image forming apparatus, may be the same as the hardware configuration of the apparatus 20 described above with reference to FIG. 3 concerning the first embodiment. Therefore, duplicate description will be omitted.

The apparatus 20′ according to the present embodiment implements various processes described later with the hardware configuration illustrated in FIG. 3 in a case where the apparatus 20′ is an image forming apparatus.

A hardware configuration of the apparatus 20′ included in the information processing system 1′ according to the present embodiment in a case where the apparatus 20′ is a smartphone, may be the same as the hardware configuration of the apparatus 20 described above with reference to FIG. 15 concerning the second embodiment. Therefore, duplicate description will be omitted.

The apparatus 20′ according to the present embodiment implements various processes described later with the hardware configuration illustrated in FIG. 15 in a case where the apparatus 20′ is a smartphone.

A hardware configuration of each of the PC terminals 30 included in the information processing system 1′ according to the present embodiment, may be the same as the hardware configuration of the PC terminal 30 described above with reference to FIG. 2 concerning the first embodiment. Therefore, duplicate description will be omitted.

Each of the PC terminals 30 according to the present embodiment implement various processes described below by having the hardware configuration illustrated in FIG. 2.

According to the sixth embodiment, each of the apparatuses 20′ that are image forming apparatuses provides a receipt registration service.

### <Outline of Receipt Registration Service>

First, an outline of a receipt registration service that each apparatus 20′ according to the present embodiment provides will now be described.

The apparatus 20′ according to the present embodiment provides a receipt registration service by extracting areas including images of receipts from a scanned image file generated from scanning the receipts put on the platen (i.e., the scanner 26) to generate receipt image files, and registering the receipt image files in an expense reimbursement service.

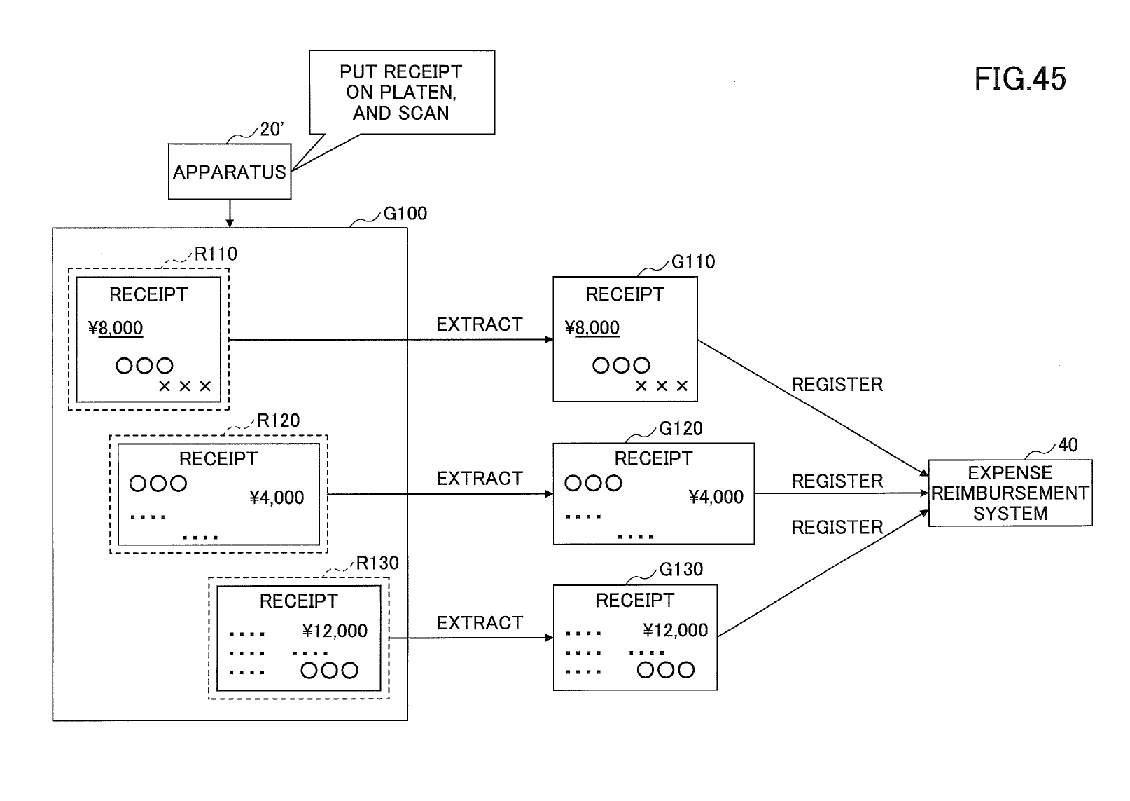

That is, the apparatus 20′ according to the present embodiment scans, for example, three receipts, as illustrated in FIG. 45, to generate a scanned image file G100, and extracts areas R110-R130 including the images of the respective receipts to generate respective receipt image files G110-G130. Then, the apparatus 20′ according to the present embodiment registers the generated receipt image files G110-G130 in the expense reimbursement service (in the expense reimbursement system 40).

However, services provided by the apparatus 20′ are not limited to receipt registration services. the apparatus 20′ may provide a service of, for example, carrying out an OCR process or an enciphering process on receipt image files generated from extracting areas including images of respective receipts from a scanned image file, and registering the receipt image files on which the OCR process or the enciphering process has been carried out in an expense reimbursement service.

### <Functional Configuration>

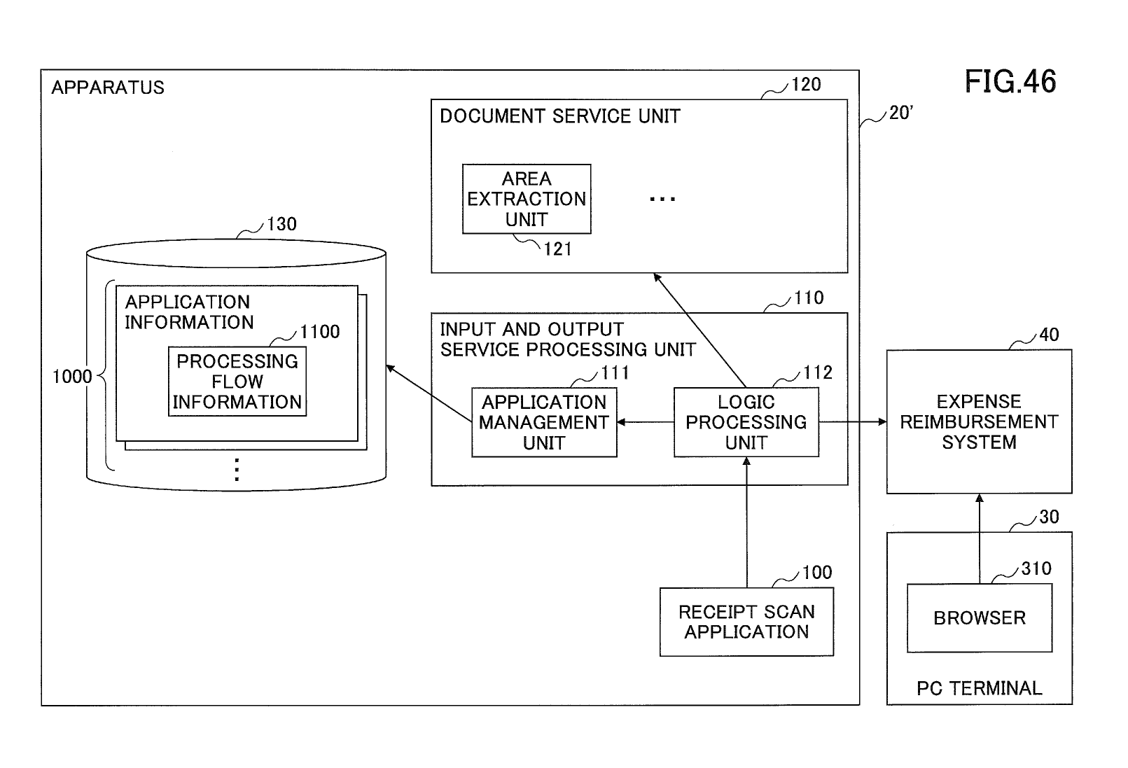

A functional configuration of the information processing system 1′ according to the present embodiment will now be described with reference to FIG. 46. FIG. 46 illustrates a functional configuration of one example of the information processing system 1′ according to the present embodiment.

The PC terminal 30 illustrated in FIG. 46 includes a browser 310 implemented by, for example, the CPU 16, and so forth. The user of the PC terminal 30 can use an expense reimbursement service provided by the expense reimbursement system 40 through the browser 310.

The apparatus 20′ illustrated in FIG. 46 includes a receipt scan application 100 implemented by, for example, the CPU 31, and so forth. The receipt scan application 100 is an application program for the user of the apparatus 20′ to use a receipt registration service. The user uses the receipt scan application 100 installed in the apparatus 20′ to use a receipt registration service.

Also, the apparatus 20′ illustrated in FIG. 46 includes an input and output service processing unit 110 and a document service unit 120. The respective functional units are implemented by processes carried out by the CPU 31 according to one or more programs installed in the apparatus 20′.

Also, the apparatus 20′ illustrated in FIG. 46 includes an application information storage unit 130. The application information storage unit 130 can be implemented by the HDD 35.

The input and output service processing unit 110 carries out processes concerning services provided by the apparatus 20′. The input and output service processing unit 110 includes an application management unit 111 and a logic processing unit 112.

The application management unit 111 manages application information 1000 stored in an application information storage unit 130. The application information 1000 is an application for providing services implemented by sequences of processes. That is, the application information 1000 provides various services (for example, a receipt registration service) provided by the apparatus 20′.

In response to a request from the logic processing unit 112, the application management unit 111 returns a set of processing flow information 1100 included in the application information 1000. The set of processing flow information 1100 is information in which a sequence of processes for implementing a service provided by the application information 1000 are defined.

In response to a request from the client application 210, the logic processing unit 112 acquires a set of processing flow information 1100 included in the application information 1000 through the application management unit 111. Then, the logic processing unit 112 carries out a sequence of processes (i.e., a processing flow) for implementing a service provided by the application information 100 based on the set of processing flow information 1100 acquired from the application management unit 111.

Thus, the apparatus 20′ according to the present embodiment provides various services (for example, a receipt registration service).

The document service unit 120 carries out processes included in a sequence of processes (a processing flow) based on a set of processing flow information 1100. The document service unit 120 includes an area extraction unit 121.

The area extraction unit 121 extracts areas (for example, areas including images of receipts) from a scanned image file to generate image files (for example, receipt image files). The area extraction unit 121 extracts the areas by using image processing technology such as template matching technology, for example.

The document service unit 120 may include, for example, an enciphering/deciphering unit that enciphers and deciphers electronic files, a compressing/decompressing unit that compresses and decompresses electronic files, an OCR processing unit that carries out an OCR process on electronic files, or the like.

Thus, the document service unit 120 includes various functional units to carry out processes included in a sequence of processes (a processing flow). Therefore, the document service unit 120 is implemented by a group of programs (or modules) that carry out various functions.

The application information storage unit 130 stores the application information 1000. The application information 1000 is stored in the application information storage unit 130 in a state of being associated with an application ID that identifies the application information 1000. It is also possible that the application information 1000 is associated with an application name.

The application information 1000 includes sets of processing flow information 1100. For example, the application information 1000 for providing a receipt registration service includes processing flow information 1100 in which a sequence of processes to implement a receipt registration service are defined.

It is possible that the application information 1000 includes two or more sets of processing flow information 1100.

In a set of processing flow information 1100, a sequence of processes (i.e., a processing flow) to implement a service to be provided by the application information 1000 are defined. A set of processing flow information 1100 will be described later in detail.

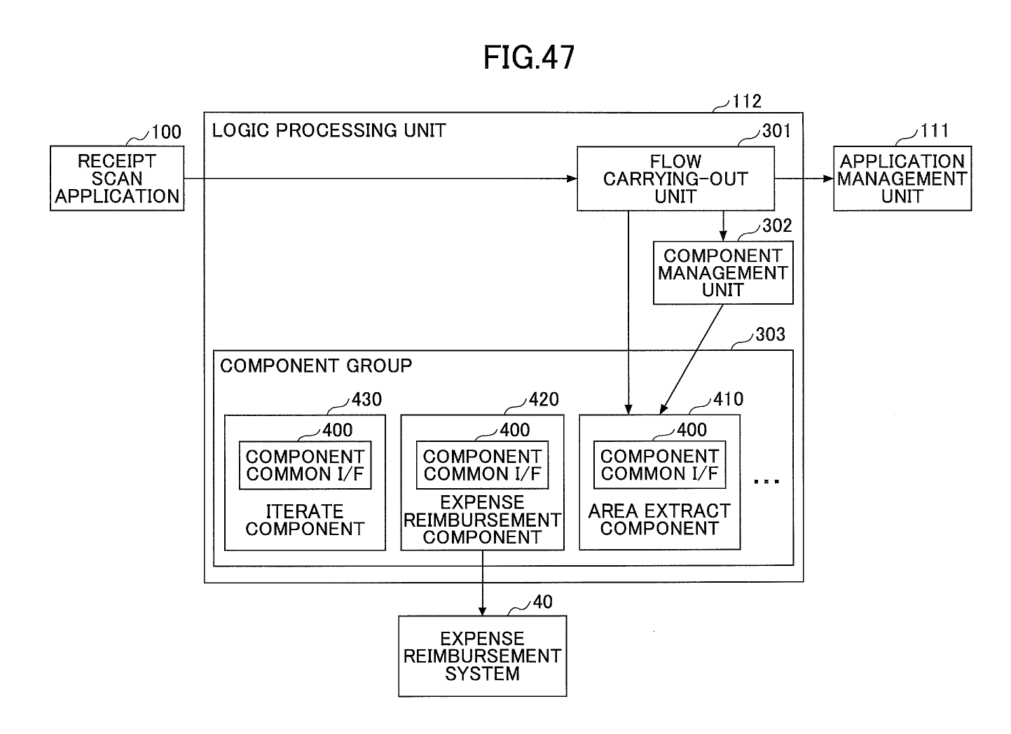

A detailed functional configuration of the logic processing unit 112 will now be described with reference to FIG. 47. FIG. 47 illustrates one example of a functional configuration of the logic processing unit 112 according to the present embodiment.

The logic processing unit 112 illustrated in FIG. 47 includes a flow carrying-out unit 301, a component management unit 302, and a component group 303.

The flow carrying-out unit 301 responds to a request from an application of the receipt scan application 100, or the like, to acquire a set of processing flow information 1100 included in the application information 1000 through the application management unit 111. Then, the flow carrying-out unit 301 carries out a sequence of processes (i.e., a processing flow) based on the set of processing flow information 1100 acquired from the application management unit 111.

The sequence of processes (i.e., the processing flow) based on the set of processing flow information 1100 are implemented as a result of components for carrying out the respective processes included in the sequence of processes being combined. A component is implemented by a program or a module for implementing a function, and defined by, for example, classes, functions, and so forth.

The component management unit 302 manages components. The component management unit 302 responds to a request from the flow carrying-out unit 301 to generate a component, and return the generated component to the flow carrying-out unit 301. Generating a component means loading the component defined by, for example, classes, functions, and so forth, in a memory (for example, the RAM 32).

The component group 303 is a collection of components. The component group 303 includes an area extract component 410, an expense reimbursement component 420, and an iterate component 430.

The area extract component 410 generates receipt image files. That is, the area extract component 410 requests the area extraction unit 121 of the document service unit 120 to carry out a process to extract areas including images of receipts from a scanned image file, and generates the receipt image files, respectively.

The expense reimbursement component 420 transmits a request to the expense reimbursement system 40. That is, the expense reimbursement component 420 requests the expense reimbursement system 40 to generate a ledger in which receipt image files will be registered. Also, the expense reimbursement component 420 requests registration of the receipt image files in the ledger.

The iterate component 430 iteratively carries out one or more processes. That is, the iterate component 430 iteratively carries out one or more processes by iteratively carrying out another sequence of processes (i.e., another processing flow) including the one or more processes a certain number of times.

It is possible that the component group 303 includes, other than the above-mentioned components, for example, various components such as a compression component for compressing electronic files, conversion components for converting the data formats of electronic files, and so forth.

Each of the components included in the component group 303 has a component common I/F 400. The component common I/F 400 includes APIs (Application Program Interfaces) defined in common for the respective components, including an API for generating the components, and an API for carrying out the processes of the components.

It is possible that the component management unit 302 generates the respective components included in the component group 303 using the component common I/F 400 when, for example, the service providing system 10 is started.

A set of processing flow information 1100 in which a sequence of processes (i.e., a processing flow) for implementing a receipt registration service according to the present embodiment are defined may be the same as a set of processing flow information 1100 described above with reference to FIG. 7 concerning the first embodiment. Therefore, duplicate description will be omitted.

According to the set of processing flow information 1100 illustrated in FIG. 7, the area extract component 410 can generate one or more receipt image files by extracting areas of images of receipts included in a scanned image file. Also, the expense reimbursement component 420 can generate a ledger in which receipt image files are registered concerning an expense reimbursement service.

The processing definition 1113 of the set of processing flow information 1100 illustrated in FIG. 7 defines that the iterate component 430 will carry out a sequence of processes based on a set of processing flow information 1100 identified by the flow ID “flow101” iteratively. The set of processing flow information 1100 of the flow ID “flow101” may be the same as the set of processing flow information 1100 of the flow ID “flow101” described above with reference to FIG. 8 concerning the first embodiment. Therefore, duplicate description will be omitted.

The iterate component 430 can register one or more receipt image files in an expense reimbursement service through the expense reimbursement component 420 by iteratively carrying out the sequence of processes based on the set of processing flow information 1100 illustrated in FIG. 8.

### <Process Details>

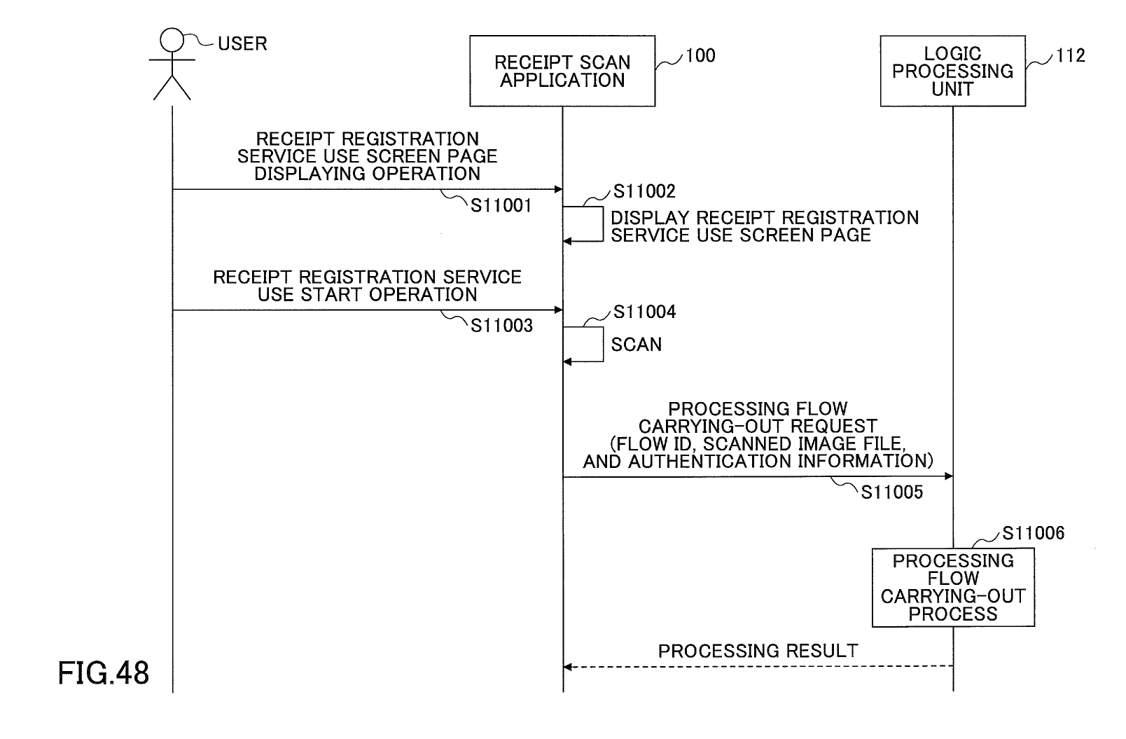

Next, processes of the information processing system 1′ according to the present embodiment will be described in detail. First, a process of registering receipt image files in an expense reimbursement service using a receipt registration service by the user of the apparatus 20′, with reference to FIG. 48. FIG. 48 is a sequence diagram illustrating one example of an overall process carried out when a user uses a receipt registration service according to the present embodiment.

First, the user uses the apparatus 20′ and performs a receipt registration service use screen page displaying operation to display a receipt registration service use screen page (step S11001). Then, the receipt scan application 100 of the apparatus 20′ receives the operation to display a receipt registration service use screen page. Note that, an operation to display a receipt registration service use screen page is, actually, for example, an operation to start the receipt scan application 100.

After receiving the user's operation to display a receipt registration service use screen page, the receipt scan application 100 displays, for example, the receipt registration service use screen page G200 illustrated in FIG. 10 (step S11002).

The receipt registration service use screen page G200 illustrated in FIG. 10 includes a user name input field G210, a password input field G220, and a scanning button G230. The user name input field G210 and the password input field G220 are used to input a user name and a password, respectively, concerning an expense reimbursement service, as examples of authentication information for using the expense reimbursement service. The scanning button G230 is a display component for scanning receipts to generate a scanned image file.

Then, the user uses the apparatus 20′ and performs a receipt registration service use start operation to start using a receipt registration service (step S11003). That is, the user sets, on the scanner 26 of the apparatus 20′, one or more receipts, and also, inputs the user name and the password in the user name input field G210 and the password input field G220 of the receipt registration service use screen page G200 illustrated in FIG. 10. Then, the user presses the scanning button G230, and thus, performs a receipt registration service use start operation to start using a receipt registration service. Then, the receipt scan application 100 receives the receipt registration service use start operation. Note that, the user can set various types of pieces of paper for evidence such as receipts that may be pieces of paper that are output from cash registers or the like usable as evidence for expenses on the scanner 26.

After receiving the receipt registration service use start operation performed by the user, the receipt scan application 100 reads the receipts through the scanner 26, and generates a scanned image file including areas of images of the receipts (step S11004).

Then, the receipt scan application 100 transmits a processing flow carrying-out request to the logic processing unit 112 (step S11005). Note that, the processing flow carrying-out request includes a flow ID “flow001” of a set of processing flow information 1100 for implementing a receipt registration service according to the embodiment, the scanned image file, and authentication information (that is, the user name and the password). The processing flow carrying-out request may include, instead of the scanned image file, a storage destination path (i.e., a file path) in a storage device (for example, the HDD 35, or the like) that stores the scanned image file.

The flow ID “flow001” has been associated with, for example, the scanning button G230 of the receipt registration service use screen page G200. However, it is also possible that the flow ID “flow001” has been associated with, for example, the receipt registration service use screen page G200.

Then, after receiving the processing flow carrying-out request, the logic processing unit 112 carries out a processing flow carrying-out process (step S11006). That is, the logic processing unit 112 carries out a sequence of processes based on the set of processing flow information 1100 identified by the flow ID “flow001” included in the processing flow carrying-out request.

After thus carrying out the processing flow, the logic processing unit 112 returns the processing result of the processing flow that has been thus carried out. Thus, the service providing system 10 according to the present embodiment provides the receipt registration service to the apparatus 20′.

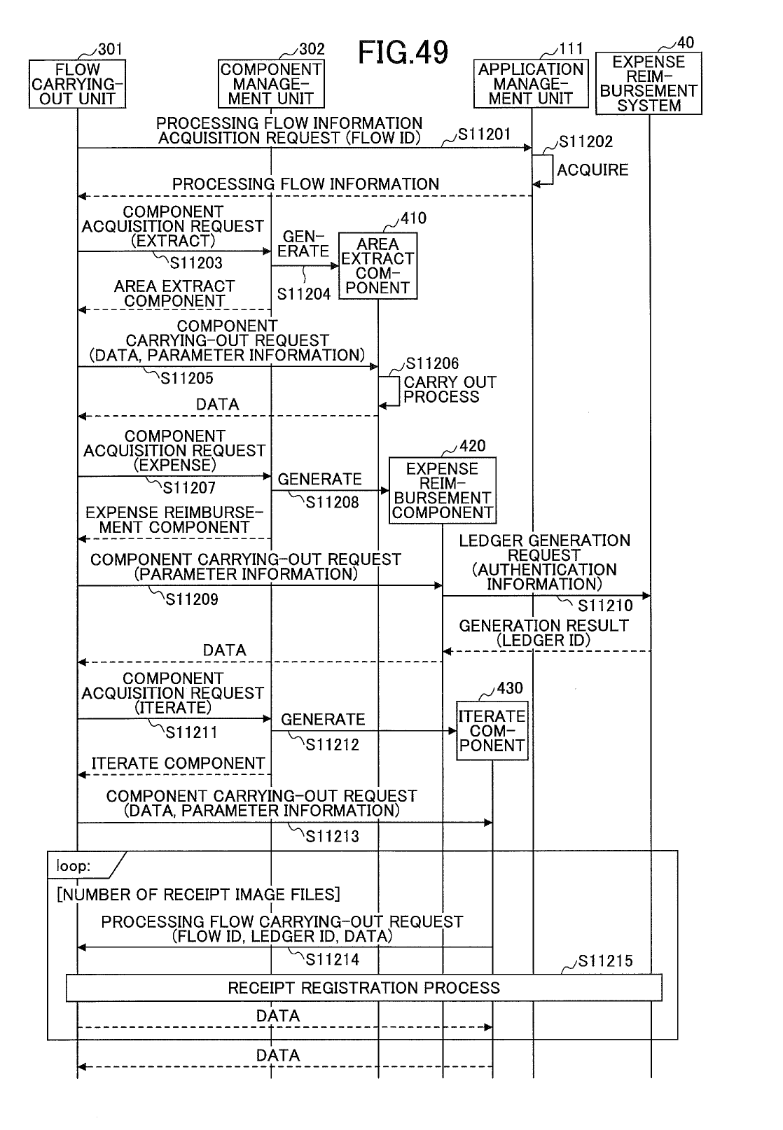

Details of step S11006 will now be described with reference to FIG. 49. FIG. 49 is a sequence diagram illustrating one example of a sequence of processes of a processing flow to implement a receipt registration service according to the present embodiment.

First, after receiving the processing flow carrying-out request from the receipt scan application 100, the flow carrying-out unit 301 transmits a processing flow information acquisition request to the application management unit 111 (step S11201). Note that, the processing flow information acquisition request includes the flow ID “flow001” acquired from the processing flow carrying-out request.

After receiving the processing flow information acquisition request, the application management unit 111 acquires the set of processing flow information 1100 identified by the flow ID “flow001” included in the processing flow information acquisition request from the application information 1000 stored in the application information storage unit 130 (step S11202). That is, the application management unit 111 acquires the set of processing flow information 1100 illustrated in FIG. 7 from the application information storage unit 130.

Then, the application management unit 111 returns the set of processing flow information 1100 acquired from the application information storage unit 130 to the logic processing unit 112.

The flow carrying-out unit 301 transmits a component acquisition request based on the set of processing flow information 1100 illustrated in FIG. 7 to the component management unit 302 (step S11203). That is, the flow carrying-out unit 301 transmits a component acquisition request having the component name “extract” defined for “component” included in the processing definition 1111 of the set of processing flow information 1100 illustrated in FIG. 7 to component management unit 302.

After receiving the component acquisition request, the component management unit 302 generates a component having the component name “extract” (that is, the area extract component 410) (step S11204). Note that, generating the area extract component 410 can be implemented by using the API prepared for generating components defined in the component common I/F 400.

Then, the component management unit 302 returns the generated area extract component 410 to the flow carrying-out unit 301. That is, the component management unit 302, for example, returns an address at which the area extract component 410 is loaded in a memory (for example, the RAM 32) to the flow carrying-out unit 301.

Then, the flow carrying-out unit 301 transmits a component carrying-out request to the area extract component 410 (step S11205).

Note that, the component carrying-out request includes data. The data included in the component carrying-out request is a scanned image file (or the storage destination path for the scanned image file) included in the processing flow carrying-out request received from the receipt scan application 100. Thus, the flow carrying-out unit 301 transmits electronic data such as an image file (or the storage destination path for the image file) simply as “data” (that is, without paying attention to the data format) to each component.

Also, the component carrying-out request includes each set of parameter information defined for “parameters” included in the processing definition 1111 of the set of processing flow information 1100 illustrated in FIG. 7.

After receiving the component carrying-out request, the area extract component 410 carries out a process using the parameter information on the data included in the component carrying-out request (step S11206). That is, the area extract component 410 uses the area extraction unit 121 of the document service unit 120 to extract the areas of images of the receipts included in the scanned image file, and generates receipt image files. That is, if the scanned image file includes a plurality of the areas of images of the receipts, the area extract component 410 extracts each of the plurality of areas of images of the receipts to generate the respective receipt image files.

Also, for example, if the areas of images of “simple receipts” are included in the scanned image file, the area extract component 410 may extract the areas of images of the simple receipts to generate receipt image files. Also in this case, the receipt registration service registers the receipt image files in the expense reimbursement service.

Further, for example, if the areas of the images of the receipts included in the scanned image file are inclined, or the like, the areas are rotated to correct the inclination, or the like, then, are extracted. Thereafter, the receipt image files are generated.

Then, the area extract component 410 returns data indicating the generated receipt image files (or storage destination paths for the receipt image files) to the flow carrying-out unit 301.

Then, the flow carrying-out unit 301 transmits a component acquisition request based on the set of processing flow information 1100 illustrated in FIG. 7 to the component management unit 302 (step S11207). That is, the flow carrying-out unit 301 transmits the component acquisition request having the component name “expense” defined in the “component” included in the processing definition 1112 of the set of processing flow information 1100 to the component management unit 302.

After receiving the component acquisition request, the component management unit 302 generates a component having the component name “expense” (that is, the expense reimbursement component 420) (step S11208). Note that generating the expense reimbursement component 420 can be implemented by using the API prepared for generating components defined in the component common I/F 400.

Then, the component management unit 302 returns the generated expense reimbursement component 420 to the flow carrying-out unit 301. That is, the component management unit 302 returns, for example, an address at which the expense reimbursement component 420 is loaded in a memory (for example, the RAM 32) to the flow carrying-out unit 301.

Then, the flow carrying-out unit 301 transmits a component carrying-out request to the expense reimbursement component 420 (step S11209).

Note that, the component carrying-out request includes each set of parameter information defined for “parameters” included in the processing definition 1112 of the set of processing flow information 1100 illustrated in FIG. 7.

That is, the component carrying-out request includes parameter information in which authentication information is set to parameter information “auth”: null′. For example, if a user name “user001” and a password “abcde” are input to the user name input field G210 and the password input field G220, respectively, of the receipt registration service use screen page G200, the parameter information has the contents ‘“auth”: “user001/abcde”’.

Also, the component carrying-out request includes parameter information for transmitting a ledger generation request to the expense reimbursement system 40.

After receiving the component carrying-out request, the expense reimbursement component 420 carries out a process using the parameter information (step S11210). That is, the expense reimbursement component 420 transmits a ledger generation request to the expense reimbursement system 40. Note that, the expense reimbursement component 420 can transmit the ledger generation request by using, for example, a WebAPI disclosed by the expense reimbursement system 40. Also, the ledger generation request includes authentication information.

Then, the expense reimbursement system 40 generates a ledger to register receipt image files, and returns a ledger ID for identifying the generated ledger to the expense reimbursement component 420 as the processing result. Then, the expense reimbursement component 420 returns data indicating the ledger ID to the flow carrying-out unit 301.

Thus, the expense reimbursement component 420 generates the ledger for registering receipt image files concerning the expense reimbursement service by requesting the expense reimbursement system 40 to generate a ledger.

Then, the flow carrying-out unit 301 transmits a component acquisition request based on the set of processing flow information 1100 illustrated in FIG. 7 to the component management unit 302 (step S11211). That is, the flow carrying-out unit 301 transmits the component acquisition request for the component having the component name “iterate” defined for “component” included in the processing definition 1113 of the set of processing flow information 1100 illustrated in FIG. 7 to the component management unit 302.

After receiving the component acquisition request, the component management unit 302 generates a component having the component name “iterate” (that is, the iterate component 430) (step S11212). Note that, generating the iterate component 430 can be implemented by using the API prepared for generating components defined in the component common I/F 400.

Then, the component management unit 302 returns the generated iterate component 430 to the flow carrying-out unit 301. That is, the component management unit 302 returns, for example, an address at which the iterate component 430 is loaded in a memory (for example, the RAM 32) to the flow carrying-out unit 301.

Then, the flow carrying-out unit 301 transmits a component carrying-out request to the iterate component 430 (step S11213).

Note that, the component carrying-out request includes data indicating the receipt image files (or the storage destination paths for the receipt image files) generated by the area extract component 410. Therefore, if the area extract component 410 generates a plurality of the receipt image files, the component carrying-out request includes the corresponding sets of data indicating the receipt image files (or the respective storage destination paths for the plurality of receipt image files).

Also, the component carrying-out request includes each set of parameter information defined for “parameters” included the processing definition 1113 of the set of processing flow information 1100 illustrated in FIG. 7. That is, the component carrying-out request includes parameter information ‘“flowid”: “flow101”’ and parameter information indicating the ledger ID returned in step S11210.

After receiving the component carrying-out request, the iterate component 430 transmits a processing flow carrying-out request to the flow carrying-out unit 301 for each set of data included in the component carrying-out request (that is, for each receipt image file or the storage destination path for the receipt image file) (step S11214). That is, the iterate component 430 carries out the receipt registration process of step S11215 iteratively the number of times equal to the number of the receipt image files. Note that, the processing flow carrying-out request includes data (that is, the receipt image files or the storage destination paths for the receipt image files), the flow ID “flow101”, and the ledger ID.

After receiving the processing flow carrying-out request, the flow carrying-out unit 301 carries out, concerning an expense reimbursement service, a process for registering the receipt image files in the ledger identified by the ledger ID (i.e., a receipt registration process) (step S11215). Then, the flow carrying-out unit 301 returns the processing result of the receipt registration process to the iterate component 430.

Thereafter, the iterate component 430 returns data indicating the processing result of iteratively carrying-out of the receipt registration process of step S11215 to the flow carrying-out unit 301.

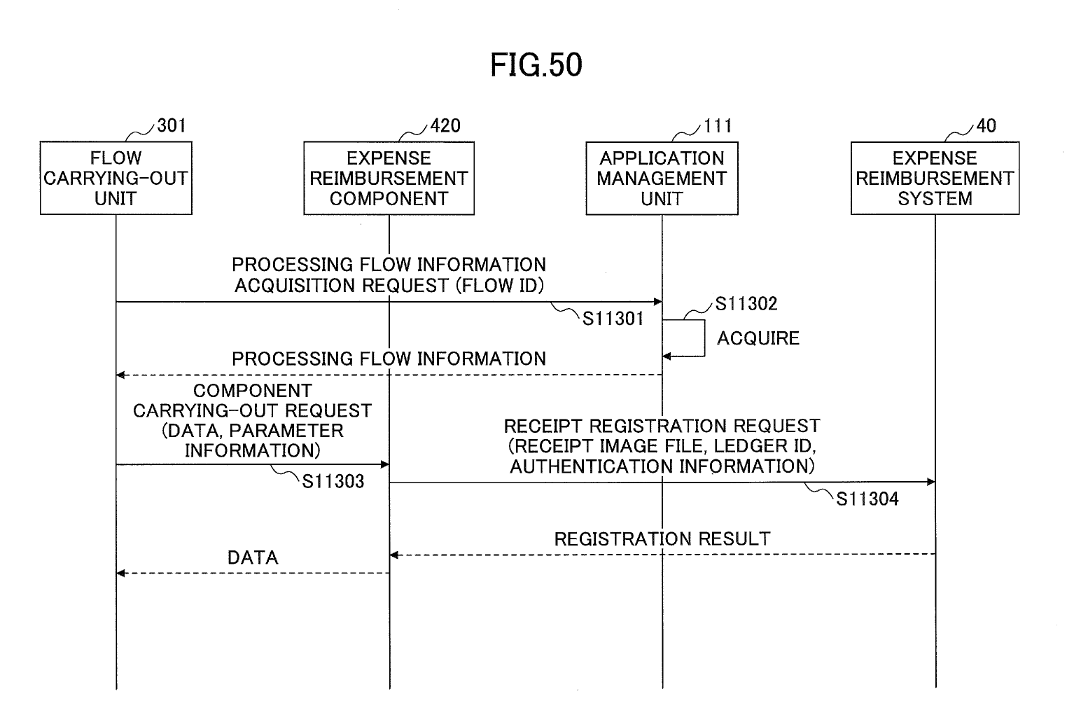

Details of the receipt registration process (i.e., step S11215) will now be described with reference to FIG. 50. FIG. 50 is a sequence diagram illustrating one example of a receipt registration process according to the present embodiment.

First, after receiving the processing flow carrying-out request from the iterate component 430, the flow carrying-out unit 301 transmits a processing flow information acquisition request to the application management unit 111 (step S11301). Note that, the processing flow information acquisition request includes the flow ID “flow101” received from the processing flow carrying-out request.

After receiving the processing flow information acquisition request, the application management unit 111 acquires the set of processing flow information 1100 identified by the flow ID “flow101” included in the processing flow information acquisition request from the application information 1000 stored in the application information storage unit 130 (step S11302). That is, the application management unit 111 acquires the set of processing flow information 1100 illustrated in FIG. 8 from the application information storage unit 130.

Then, the application management unit 111 returns the set of processing flow information 1100 acquired from the application information storage unit 130 to the logic processing unit 112.

Then, the flow carrying-out unit 301 transmits component carrying-out request to a component having the component name “expense” defined for “component” included in the processing definition 1211 of the set of processing flow information 1100 illustrated in FIG. 8 (step S11303). That is, the flow carrying-out unit 301 transmits the component carrying-out request to the expense reimbursement component 420.

Note that, the component carrying-out request includes data (that is, the receipt image files or the storage destination paths for the receipt image files). Also, the component carrying-out request includes parameter information in which authentication information is set to parameter information ‘“auth”: null’; parameter information for requesting the expense reimbursement system 40 to register receipts (i.e., a receipt registration request); and parameter information indicating the ledger ID.

After receiving the component carrying-out request, the expense reimbursement component 420 carries out a process using the data and the parameter information (step S11304). That is, the expense reimbursement component 420 transmits a receipt registration request to the expense reimbursement system 40. Note that, the expense reimbursement component 420 can transmit the receipt registration request by using, for example, a WebAPI disclosed by the expense reimbursement system 40. Also, the receipt registration request includes the receipt image files, the ledger ID, and the authentication information.

Then, the expense reimbursement system 40 registers the receipt image files in the ledger identified by the ledger ID, and returns the registration result to the expense reimbursement component 420. Then, the expense reimbursement component 420 returns data indicating the registration result to the flow carrying-out unit 301.

Thus, the expense reimbursement component 420 can register the receipt image files in the ledger concerning the expense reimbursement service by requesting the expense reimbursement system 40 to register the receipt (i.e., a receipt registration request).

In this regard, as a result of the receipt image files being registered in the ledger concerning the expense reimbursement service, receipt data corresponding to the receipt image files is registered in the ledger. Note that, the receipt data includes, for example, items such as account items, dates, and so forth. Respective items included in the receipt data may include, for example, respective items (for example, item values of the account items, item values of dates, and so forth) acquired from carrying out an OCR process on the receipt image files.

Processes for when the user of the PC terminal 30 uses an expense reimbursement service may be the same as the processes described above with reference to FIG. 13 concerning the first embodiment, and therefore, duplicate description will be omitted. According to the present embodiment described above, the apparatus 20′ extracts areas of images of receipts included in a scanned image file (see step S11206 of FIG. 49). However, it is also possible that a server apparatus connected with the apparatus 20′ via the network N1 instead carries out the process of extracting areas of images of receipts included in a scanned image file. In this case, for example, in the sequence diagram of FIG. 48, after carrying out step S11004, the apparatus 20′ transmits the processing flow carrying-out request including a scanned image file to the server apparatus. In this example, the server apparatus then extracts a plurality of areas of images of receipts from the scanned image file to generate respective receipt image files. The apparatus 20′ then acquires the receipt image files from the server apparatus.

### Seventh Embodiment

A seventh embodiment will now be described. According to the seventh embodiment, in a case where the apparatus 20′ is, for example, a smartphone, a tablet terminal, a digital camera, or the like, receipt image files are generated from a photographed image file generated as a result of the apparatus 20′ photographing receipts, and the generated receipt image files are then registered in an expense reimbursement service.

In the description of the seventh embodiment, mainly differences from the sixth embodiment will be described, and description of the parts having substantially the same functional configurations as those in the sixth embodiment and description of the parts implementing substantially the same processes as those in the sixth embodiment will be appropriately omitted. Also, the same reference numerals as those in the sixth embodiment are given to the systems/apparatuses/devices/units corresponding to those in the sixth embodiment.

### <Receipt Registration Service>

An outline of a receipt registration service provided by the apparatus 20′ according to the present embodiment will now be described. According to the present embodiment, it is assumed that the apparatus 20′ is a smartphone or a tablet terminal. However, the apparatus 20′ may be, for example, a digital camera, a game apparatus, a wearable-type information terminal, or the like, as long as the apparatus 20′ includes the camera device 48.

The apparatus 20′ according to the present embodiment provides a receipt registration service of generating receipt image files from a photographed image file generated by the apparatus 20′ as a result of photographing receipts by the camera device 48, and registering the receipt image files in an expense reimbursement service.

### <Functional Configuration>

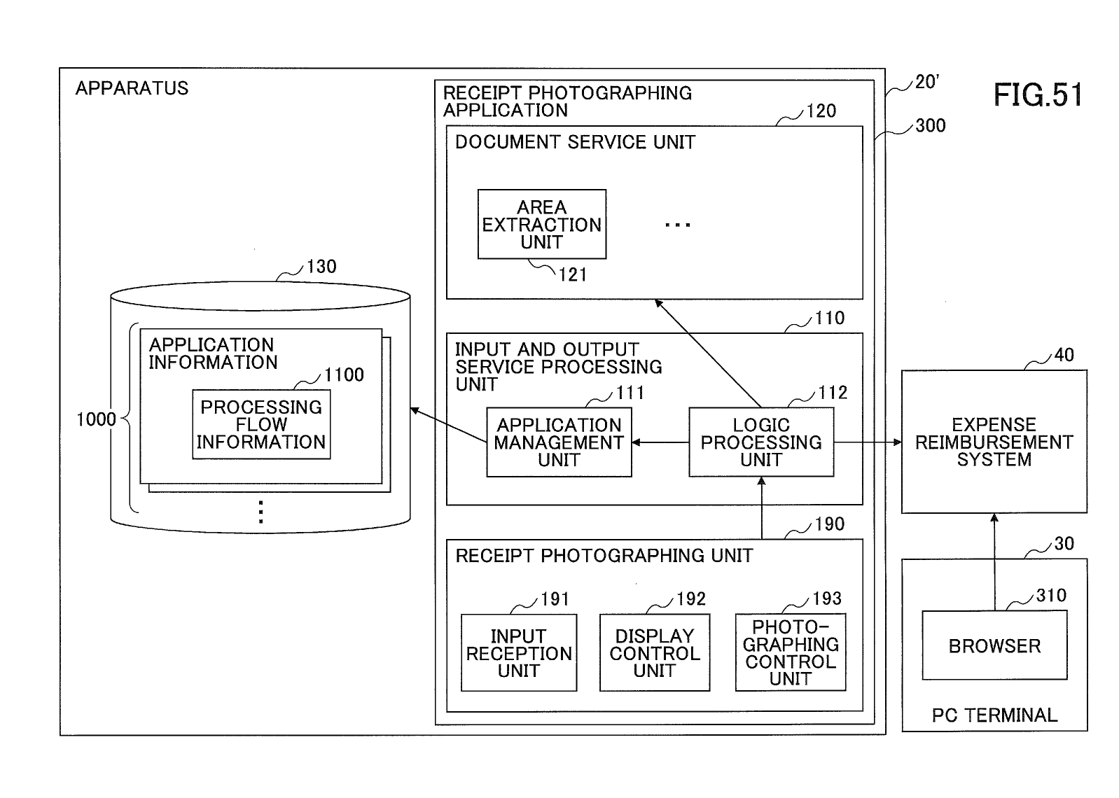

A functional configuration of the information processing system 1′ according to the present embodiment will now be described with reference to FIG. 51. FIG. 51 illustrates a functional configuration of one example of the information processing system 1′ according to the seventh embodiment.

The apparatus 20′ illustrated in FIG. 51 includes a receipt photographing application 300, implemented by, for example, the CPU 46, and so forth. The receipt photographing application 300 is an application program used by the user of the apparatus 20′ to use a receipt registration service. The user uses a receipt registration service through the apparatus 20′ using the receipt photographing application 300 installed in the apparatus 20′.

The apparatus 20′ illustrated in FIG. 51 further includes an input and output service processing unit 110, a document service unit 120, and a receipt photographing unit 190. These functional units are implemented by processes carried out by the CPU 46 according to the receipt photographing application 300 installed in the apparatus 20′.

The receipt photographing unit 190 carries out processes for the user to use a receipt registration service. The receipt photographing unit 190 includes an input reception unit 191, a display control unit 192, and a photographing control unit 193.

The input reception unit 191 receives various operations (for example, an operation to photograph receipts, and so forth) that are input by the user. The display control unit 192 displays various screen pages (for example, a photographing start screen page for starting photographing receipts). The photographing control unit 193 photographs receipts by controlling the camera device 48.

A set of processing flow information 1100 in which a sequence of processes (i.e., a processing flow) for implementing a receipt registration service according to the present embodiment are defined is the same as the set of processing flow information 1100 described above with reference to FIG. 16 for the second embodiment, and therefore, duplicate description will be omitted.

In the processing definition 1311 of the set of processing flow information 1100 illustrated in FIG. 16, it is defined that, through the iterate component 430, the sequence of processes based on the set of processing flow information 1100 identified by the flow ID “flow102”, described later, are to be iteratively carried out.

In the processing definition 1312 of the set of processing flow information 1100 illustrated in FIG. 16, it is defined that, through the expense reimbursement component 420, the expense reimbursement system 40 is requested to generate a ledger.

In the set of processing flow information 1313 of the set of processing flow information 1100 illustrated in FIG. 16, in the same way as the processing definition 1113 of the set of processing flow information 1100 illustrated in FIG. 7, it is defined that the sequence of processes based on the set of processing flow information 1100 identified by the flow ID “flow101” are to be iteratively carried out.

In the processing definition 1311 of the set of processing flow information 1100 illustrated in FIG. 16, it is defined that, through the iterate component 430, the sequence of processes based on the set of processing flow information 1100 identified by the flow ID “flow102” are to be iteratively carried out, as mentioned above. The set of processing flow information 1100 identified by the flow ID “flow102” is the same as the set of processing flow information 1100 identified by the flow ID “flow102” described above with reference to FIG. 17. Therefore, duplicate description will be omitted.

The iterate component 430 extracts respective receipt image files from one or more photographed image files by using the area extract component 410 as a result of the sequence of processes based on the set of processing flow information 1100 illustrated in FIG. 17 being iteratively carried out.

### <Process Details>

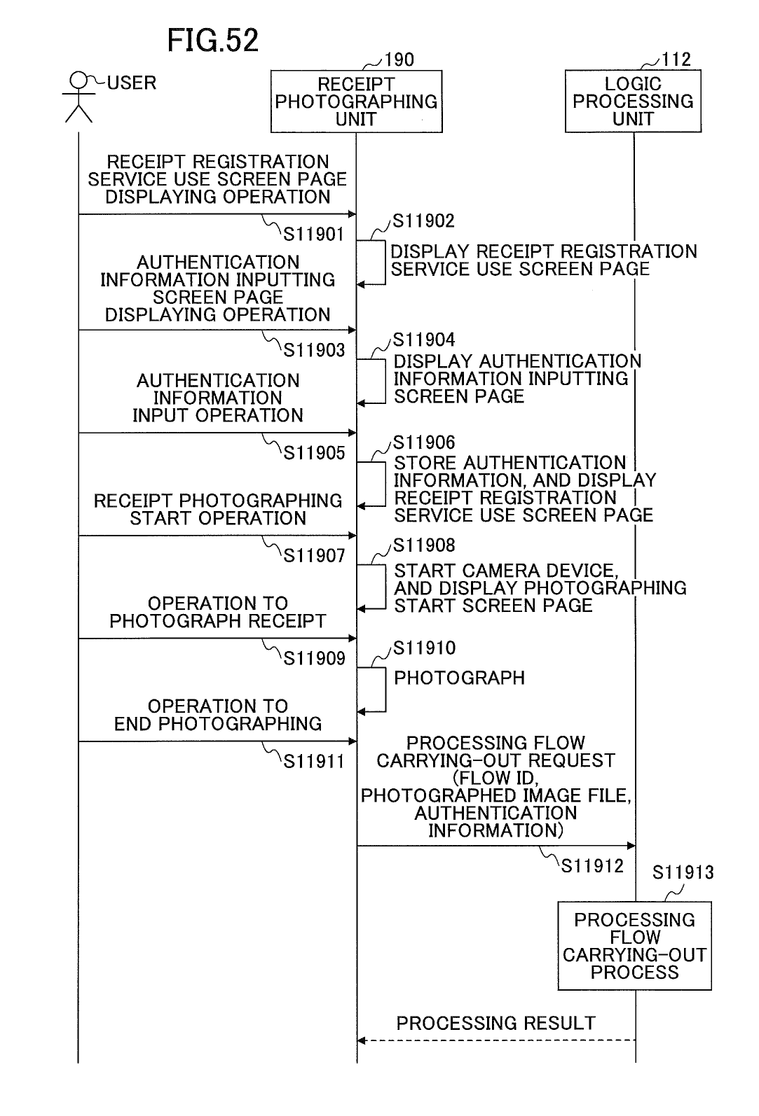

Processes of the information processing system 1′ according to the present embodiment will now be described in detail. Below, processes where the user of the apparatus 20′ uses a receipt registration service to generate receipt image files from a photographed image file generated from photographing receipts, and register the receipt image files in an expense reimbursement service will be described with reference to FIG. 52. FIG. 52 is a sequence diagram illustrating one example of an overall process carried out when a receipt registration service according to the present embodiment is used.

First, the user uses the apparatus 20′ to perform a receipt registration service use screen page displaying operation (step S11901). Then, the input reception unit 191 of the receipt photographing unit 190 of the apparatus 20′ receives the receipt registration service use screen page displaying operation. Note that, actually, the receipt registration service use screen page displaying operation may be, for example, an operation to start the receipt photographing application 300.

After receiving the user's receipt registration service use screen page displaying operation, the display control unit 192 of the receipt photographing unit 190 displays a receipt registration service use screen page G700, for example, illustrated in FIG. 19 (step S11902).

The receipt registration service use screen page G700 illustrated in FIG. 19 includes an authentication information input button G710 and a receipt photographing start button G720. The authentication information input button G710 is a display component for the user to cause a transition to an authentication information inputting screen page for using an expense reimbursement service. The receipt photographing start button G720 is a display component for the user to start the camera device 48, and causing a transition to a photographing start screen page to photograph receipts.

It is assumed that the user presses the authentication information input button G710 in the receipt registration service use screen page G700 illustrated in FIG. 19 to perform an authentication information inputting screen page displaying operation (step S11903). Then, the input reception unit 191 of the receipt photographing unit 190 receives the authentication information inputting screen page displaying operation.

After the input reception unit 191 receives the user's the authentication information inputting screen page displaying operation, the display control unit 192 of the receipt photographing unit 190 displays an authentication information inputting screen page G800, for example, as illustrated in FIG. 19 (step S11904).

The authentication information inputting screen page G800 includes a user name input field G810, a password input field G820, an OK button G830, and a cancel button G840. The user name input field G810 and the password input field G820 are used by the user to input the user name and the password, respectively, as examples of authentication information for using an expense reimbursement service.

The OK button G830 is a display component for the user to store the user name and the password having been input in the user name input field G810 and the password input field G820, and return to the receipt registration service use screen page G700 illustrated in FIG. 19. The cancel button G840 is a display component for the user to return to the receipt registration service use screen page G700 illustrated in FIG. 19 without storing the user name and the password having been input in the user name input field G810 and the password input field G820.

It is assumed that the user inputs the user name and the password in the user name input field G810 and the password input field G820, respectively, in the authentication information inputting screen page G800 illustrated in FIG. 19, presses the OK button G830, and thus, performs an authentication information input operation (step S11905). Then, the input reception unit 191 of the receipt photographing unit 190 receives the authentication information input operation.

After the input reception unit 191 receives the authentication information input operation, the receipt photographing unit 190 stores the user name and the password having been input in the user name input field G810 and the password input field G820, and displays the receipt registration service use screen page G700 using the display control unit 192 (step S11906). Actually, the receipt photographing unit 190 may store the user name and the password having been input in the user name input field G810 and the password input field G820, for example, in a certain storage area of the flash memory 47.

Note that, for example, if the authentication information (for example, the user name and the password, or the like) has been already stored, steps S11903-S11906 may be omitted. That is, in this case, the user may perform a receipt photographing start operation of step S11907 that will be described later, by pressing the receipt photographing start button G720 without pressing the authentication information input button G710 in the receipt registration service use screen page G700 illustrated in FIG. 19.

It is assumed that the user presses the receipt photographing start button G720 in the receipt registration service use screen page G700 illustrated in FIG. 19, to perform the receipt photographing start operation (step S11907). Then, the input reception unit 191 of the receipt photographing unit 190 receives the receipt photographing start operation.

After the input reception unit 191 receives the receipt photographing start operation, the display control unit 192 of the receipt photographing unit 190 starts the camera device 48, and displays a photographing start screen page G900, for example, as illustrated in FIG. 19 (step S11908).

The photographing start screen page G900 illustrated in FIG. 19 includes a reference frame G910, a receipt photographing button G920, and a photographing end button G930. The reference frame G910, the receipt photographing button G920, and the photographing end button G930 are displayed on an image corresponding to the photographing area of the camera device 48 in a superimposition manner.

The reference frame G910 acts as a marker for the user to use as a reference position for photographing a receipt. The user can photograph a receipt in such a manner that the receipt to be photographed will fall within the reference frame G910, by adjusting the distance between the receipt and the apparatus 20′, zooming in and out, and so forth. The receipt photographing button G920 is a display component for the user to generate a photographed image file by photographing the photographing area through the camera device 48. The photographing end button G930 is a display component for the user to end photographing the receipt.

Photographing a receipt will now be described with reference to FIG. 20 also described above. FIG. 20 illustrates one example of photographing a receipt.

As illustrated in the left hand of FIG. 20, the user can photograph a receipt R140 by performing such adjustment that the receipt R140 to be photographed falls within the reference frame G910, and pressing the receipt photographing button G920.

Also, as illustrated in the right hand of FIG. 20, the user can photograph a receipt R150 continuously after, for example, photographing the receipt R140 by pressing the receipt photographing button G920. Thus, the user can photograph a plurality of receipts, one by one, before pressing the photographing end button G930.

Note that, it is also possible that the user photographs a plurality of receipts through a single photographing operation. That is, for example, as illustrated in FIG. 21, the user may press the receipt photographing button G920 after making adjustment such that both the receipt R140 and the receipt R150 fall within the reference frame G910.

Returning to the description of the sequence diagram of FIG. 52, it is assumed that the user performs adjustment such that the receipt to be photographed will fall within the reference frame G910 in the photographing start screen page G900 illustrated in FIG. 19, then presses the receipt photographing button G920, and thus, performs an operation of photographing the receipt (step S11909). Then, the receipt photographing unit 190 receives the operation of photographing the receipt.

After receiving the operation of photographing the receipt, the receipt photographing unit 190 photographs the photographing area using the camera device 48 through the photographing control unit 143, and generates a photographed image file (step S11910).

Note that, as described above, the user may iterate an operation of photographing a receipt of step S11910 before pressing the photographing end button G930.

It is assumed that the user presses the photographing end button G930 in the photographing start screen page G900 of FIG. 19, and performs an operation to end photographing (step S11911). Then, the input reception unit 191 of the receipt photographing unit 190 receives the operation to end photographing.

After receiving the operation to end photographing, the receipt photographing unit 190 transmits a processing flow carrying-out request to the logic processing unit 112 (step S11912). Note that the processing flow carrying-out request includes the flow ID “flow002” of the set of processing flow information 1100 for implementing a receipt registration service according to the present embodiment, and authentication information (that is, the user name and the password). Also, the processing flow carrying-out request includes the one or more photographed image files generated in step S11910 mentioned above. It is also possible that, instead of the one or more photographed image files, the processing flow carrying-out request includes a storage destination path (file path) in a storage device (for example, the flash memory 47) where the one or more photographed image files are stored.

The flow ID “flow002” has been associated with, for example, the photographing end button G930 in the photographing start screen page G900. However, it is also possible that the flow ID “flow002” has been associated with, for example, the photographing start screen page G900.

Then, after receiving the processing flow carrying-out request, the logic processing unit 112 carries out a processing flow carrying-out process (step S11913). That is, the logic processing unit 112 carries out a sequence of processes based on the set of processing flow information 1100 of the flow ID “flow002” included in the processing flow carrying-out request.

Then, the logic processing unit 112 returns the processing result of the processing flow carrying-out process to the receipt photographing unit 190. Thus, the service providing system 10 according to the present embodiment can provide the receipt registration service to the user.

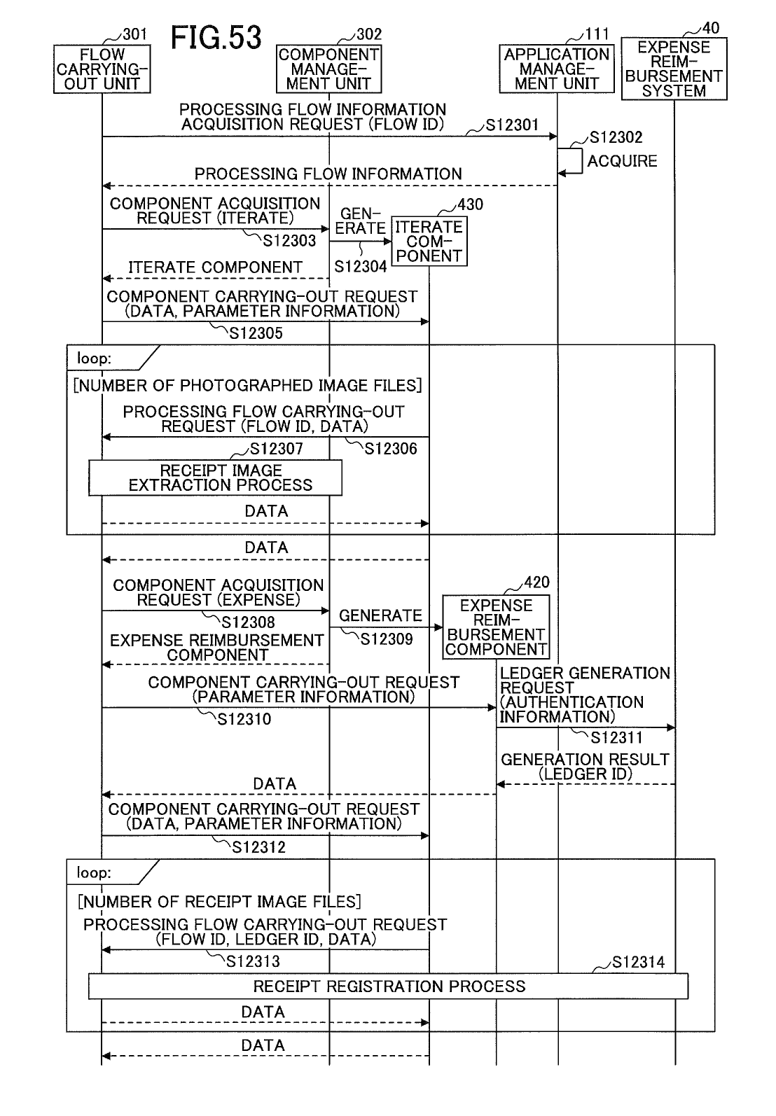

The processing flow carrying-out process (step S11913) illustrated in FIG. 52 will now be described in detail with reference to FIG. 53. FIG. 53 is a sequence diagram illustrating one example of a processing flow carrying-out process for implementing a receipt registration service according to the present embodiment.

First, after receiving the processing flow carrying-out request from the receipt photographing unit 190, the flow carrying-out unit 301 transmits a processing flow information acquisition request to the application management unit 111 (step S12301). Note that, the processing flow information acquisition request includes the flow ID “flow002” acquired from the processing flow carrying-out request.

After receiving the processing flow information acquisition request, the application management unit 111 acquires the set of processing flow information 1100 identified by the flow ID “flow002” included in the processing flow information acquisition request from the application information 1000 stored in the application information storage unit 130 (step S12302). That is, the application management unit 111 acquires the set of processing flow information 1100 illustrated in FIG. 16 from the application information storage unit 130.

Then, the application management unit 111 returns the set of processing flow information 1100 acquired from the application information storage unit 130 to the logic processing unit 112.

The flow carrying-out unit 301 transmits a component acquisition request based on the set of processing flow information 1100 illustrated in FIG. 16 to the component management unit 302 (step S12303). That is, the flow carrying-out unit 301 transmits the component acquisition request for a component having the component name “iterate” defined for “component” included in the processing definition 1311 of the set of processing flow information 1100 illustrated in FIG. 16 to the component management unit 302.

After receiving the component acquisition request, the component management unit 302 generates a component having the component name “iterate” (that is, the iterate component 430) (step S12304). Note that, generating the iterate component 430 can be implemented by using the API prepared for generating components defined in the component common I/F 400. Then, the component management unit 302 returns the generated iterate component 430 to the flow carrying-out unit 301. That is, the component management unit 302 returns, for example, an address at which the iterate component 430 is loaded in a memory (for example, the RAM 32) to the flow carrying-out unit 301.

Then, the flow carrying-out unit 301 transmits a component carrying-out request to the iterate component 430 (step S12305).

Note that, the component carrying-out request includes one or more sets of data. The one or more sets of data are the photographed image files (or the storage destination paths for the photographed image files) included in the processing flow carrying-out request received from the receipt photographing unit 190.

Also, the component carrying-out request includes respective sets of parameter information defined for “parameters” included in the processing definition 1311 of the set of processing flow information 1100 illustrated in FIG. 16. That is, the component carrying-out request includes parameter information ‘“flowid”: “flow102”’.

After receiving the component carrying-out request, the iterate component 430 transmits a processing flow carrying-out request for each of the one or more sets of data (that is, the one or more photographed image files) included in the component carrying-out request to the flow carrying-out unit 301 (step S12306). That is, the iterate component 430 iteratively carries out a receipt image extraction process of step S12307 the number of times equal to the number of the photographed image files. Note that, the processing flow carrying-out request includes the data (that is, the photographed image files or the storage destination paths for the photographed image files) and the flow ID “flow102”.

After receiving the processing flow carrying-out request, the flow carrying-out unit 301 carries out a process (i.e., a receipt image extraction process) for extracting the receipt images from the photographed image files and generating receipt image files (step S12307). Then, the flow carrying-out unit 301 returns the processing result (that is, data indicating the receipt image files extracted from the photographed image files or the storage destination paths for the receipt image files) of the receipt image extraction process to the iterate component 430.

Thereafter, the iterate component 430 returns data indicating the processing result of iteratively carrying out the receipt image extraction process of step S12307 to the flow carrying-out unit 301.

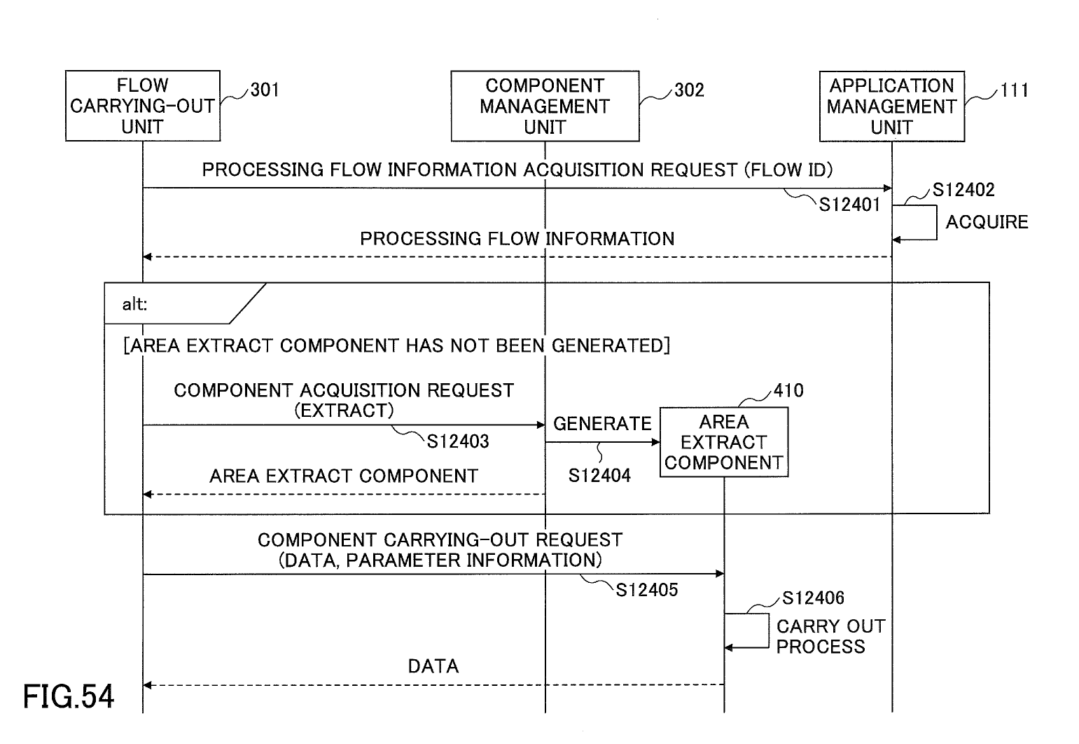

The receipt image extraction process (step S12307) will now be described in detail with reference to FIG. 54. FIG. 54 is a sequenced diagram illustrating one example of the receipt image extraction process according to the present embodiment.

First, after receiving the processing flow carrying-out request from the iterate component 430, the flow carrying-out unit 301 transmits a processing flow information acquisition request to the application management unit 111 (step S12401). Note that, the processing flow information acquisition request includes the flow ID “flow102” acquired from the processing flow carrying-out request.

After receiving the processing flow information acquisition request, the application management unit 111 acquires the set of processing flow information 1100 identified by the flow ID “flow102” included in the processing flow information acquisition request from the application information 1000 stored in the application information storage unit 130 (step S12402). That is, the application management unit 111 acquires the set of processing flow information 1100 illustrated in FIG. 17 from the application information storage unit 130.

Then, the application management unit 111 returns the set of processing flow information 1100 acquired from the application information storage unit 130 to the logic processing unit 112.

If the area extract component 410 has not been generated yet, the flow carrying-out unit 301 carries out step S12403. That is, the flow carrying-out unit 301 transmits a component acquisition request for a component identified by the component name “extract” defined for “component” included in the processing definition 1411 of the set of processing flow information 1100 illustrated in FIG. 17 to the component management unit 302 (step S12403).

If the area extract component 410 has been already generated, the flow carrying-out unit 301 does not carry out step S12403 described above.

After receiving the component acquisition request, the component management unit 302 generates a component having the component name “extract” (that is, the area extract component 410) (step S12404). Note that generating the area extract component 410 can be implemented by using the API prepared for generating components defined in the component common I/F 400.

Then, the component management unit 302 returns the generated area extract component 410 to the flow carrying-out unit 301. That is, the component management unit 302 returns, for example, an address at which the area extract component 410 is loaded in a memory (for example, the RAM 32) to the flow carrying-out unit 301.

Then, the flow carrying-out unit 301 transmits a component carrying-out request to the area extract component 410 (step S12405).

Note that, the component carrying-out request includes data indicating the photographed image files (or the storage destination paths for the photographed image files). Also, the component carrying-out request includes respective sets of parameter information defined for “parameters” included in the processing definition 1411 of the set of processing flow information 1100 illustrated in FIG. 17.

After receiving the component carrying-out request, the area extract component 410 carries out a process on the data included in the component carrying-out request using the parameter information (step S12406). That is, the area extract component 410 extracts the areas of the images of the receipts included in the photographed image file through the area extraction unit 121 of the document service unit 120, and generates receipt image files. Note that if the photographed image file includes a plurality of the areas of images of the receipts, the area extract component 410 extracts the respective areas of images of the receipts to generate a plurality of receipt image files.

Also, if areas of images of “simple receipts” are included in the photographed image file, the area extract component 410 may extract the areas of images of simple receipts to generate receipt image files. Also in this case, the receipt registration service registers the receipt image files in an expense reimbursement service.

Further, for example, if the areas of images of receipts included in the scanned image file are inclined, or the like, the areas are rotated to correct the inclination, or the like, and then, are extracted. Thereafter, the receipt image files are generated.

Then, the area extract component 410 returns data indicating the generated receipt image files (or the storage destination paths for the generated receipt image files) to the flow carrying-out unit 301.

Returning to FIG. 53, after receiving data indicating the processing result of the iterate component 430 (i.e., the processing result of iteratively carrying out the receipt image extraction process), the flow carrying-out unit 301 transmits a component acquisition request based on the set of processing flow information 1100 illustrated in FIG. 16 to the component management unit 302 (step S12308). That is, the flow carrying-out unit 301 transmits the component acquisition request for a component having the component name “expense” defined for “component” included in the processing definition 1312 of the set of processing flow information 1100 illustrated in FIG. 16 to the component management unit 302.

After receiving the component acquisition request, the component management unit 302 generates a component having the component name “expense” (that is, the expense reimbursement component 420) (step S12309). Note that, generating the expense reimbursement component 420 can be implemented using the API prepared for generating components defined in the component common I/F 400.

Then, the component management unit 302 returns the generated expense reimbursement component 420 to the flow carrying-out unit 301. That is, the component management unit 302 returns, for example, the address at which the expense reimbursement component 420 is loaded in a memory (for example, the RAM 32) to the flow carrying-out unit 301.

Then, the flow carrying-out unit 301 transmits a component carrying-out request to the expense reimbursement component 420 (step S12310).

Note that, the component carrying-out request includes respective sets of parameter information defined for “parameters” included in the processing definition 1312 of the set of processing flow information 1100 illustrated in FIG. 16.

That is, the component carrying-out request includes parameter information acquired as a result of authentication information being set to parameter information “auth”: null′. For example, it is assumed that the parameter information is acquired as a result of, after a user name “fugafuga@hoge.com” and a password “xxxxxx” are input in the user name input field G810 and the password input field G820 of the authentication information inputting screen page G800, the OK button G830 being pressed. In this case, the parameter information has the contents of, for example, ‘“auth”: “fugafuga@hoge.com/xxxxxx”’.

Also, the component carrying-out request includes parameter information for transmitting a ledger generation request to the expense reimbursement system 40.

After receiving the component carrying-out request, the expense reimbursement component 420 carries out a process using the parameter information (step S12311). That is, the expense reimbursement component 420 transmits the ledger generation request to the expense reimbursement system 40. Note that for example, the expense reimbursement component 420 can transmit the ledger generation request by using, for example, a WebAPI disclosed by the expense reimbursement system 40. The ledger generation request includes authentication information.

Then, the expense reimbursement system 40 generates a ledger to register receipt image files, and returns a ledger ID for identifying the generated ledger to the expense reimbursement component 420 as the processing result. Then, the expense reimbursement component 420 returns data indicating the ledger ID to the flow carrying-out unit 301.

Then, the flow carrying-out unit 301 transmits a component carrying-out request to the iterate component 430 (step S12312).

Note that, the component carrying-out request includes data indicating the receipt image files or the storage destination paths for the photographed image files generated by the area extract component 410. Therefore, the component carrying-out request includes a plurality of sets of data indicating a plurality of receipt image files if the area extract component 410 has generated a plurality of the receipt image files (or a plurality of the storage destination paths for the photographed image files).

Also, the component carrying-out request includes respective sets of parameter information defined for “parameters” included in the processing definition 1313 of the set of processing flow information 1100 illustrated in FIG. 16. That is, the component carrying-out request includes parameter information ‘“flowid”: “flow101”’ and parameter information indicating the ledger ID returned in step S12311.

After receiving the component carrying-out request, the iterate component 430 transmits a processing flow carrying-out request to the flow carrying-out unit 301 for each of the sets of data included in the component carrying-out request (that is, for each of the receipt image files or for each of the storage destination paths for receipt image files) (step S12313). That is, the iterate component 430 carries out the receipt registration process of step S12314 iteratively the number of times equal to the number of the receipt image files. Note that, the component carrying-out request includes the data (that is, the receipt image files or the storage destination paths for the receipt image files), the flow ID “flow101”, and the ledger ID.

After receiving the processing flow carrying-out request, the flow carrying-out unit 301 carries out a process (i.e., a receipt registration process) for registering the receipt image files in the ledger identified by the ledger ID concerning an expense reimbursement service (step S12314). Then, the flow carrying-out unit 301 returns the processing result of the receipt registration process to the iterate component 430.

Thereafter, the iterate component 430 returns data indicating the processing result of interactively carrying out the receipt registration process of step S12314 to the flow carrying-out unit 301. Note that, the receipt registration process of step S12314 is the same as the receipt registration process of step S11215 of FIG. 49, and thus, duplicate description will be omitted.

### Eighth Embodiment

An eighth embodiment will be now described. According to the eighth embodiment, the apparatus 20′ carries out authentication cooperation with the expense reimbursement system 40. Concerning the eighth embodiment, mainly the differences from the sixth embodiment will be described, and description of the parts having substantially the same functional configurations as those in the sixth embodiment and description of the parts implementing substantially the same processes as those in the sixth embodiment will be appropriately omitted. Also, the same reference numerals as those in the sixth embodiment are given to the systems/apparatuses/devices/units corresponding to those in the sixth embodiment.

### <Hardware Configuration>

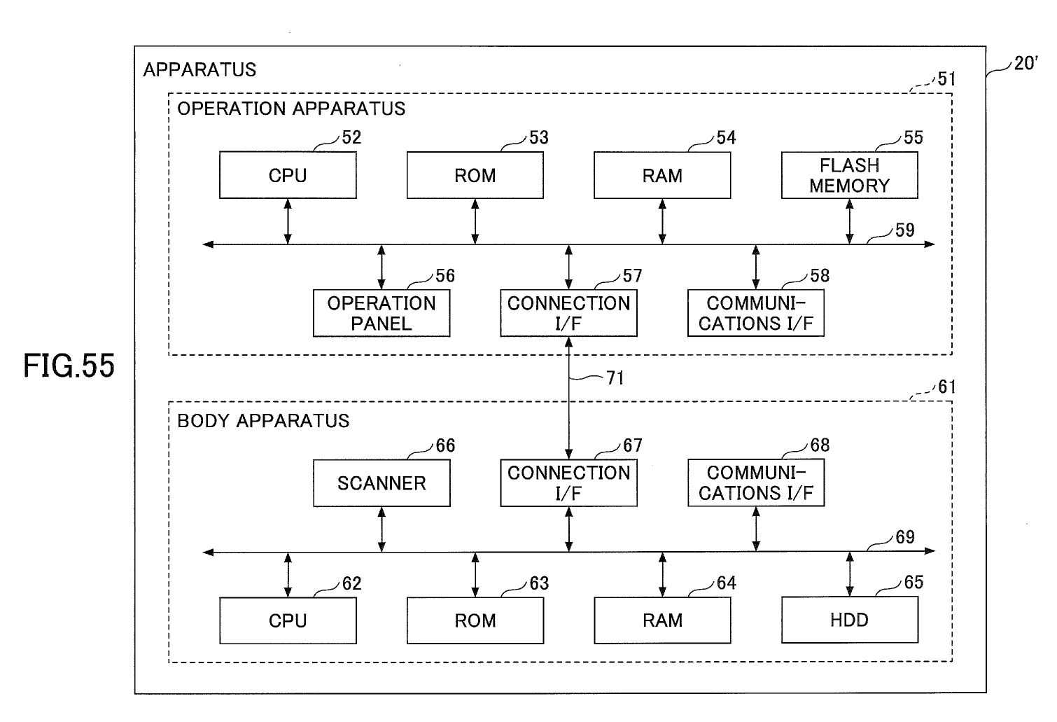

A hardware configuration of the apparatus 20′ included in the information processing system 1′ according to the present embodiment will now be described with reference to FIG. 55. FIG. 55 illustrates a hardware configuration of one example of the apparatus 20′ according to the present embodiment.

The apparatus 20′ illustrated in FIG. 55 includes an operation apparatus 51 and a body apparatus 61. The operation apparatus 51 is used by the user to perform various operations such as selecting an image processing function to be carried out by the body apparatus 61, inputting various setting values for the body apparatus 61 to carry out an image processing function such as a scanning function, inputting an instruction to start the image processing function, switching a display screen page, and so forth.

The body apparatus 61 responds to the user's various operations performed on the operation apparatus 51 to carry out various processes such as image processing functions such as a scanning function.

As illustrated in FIG. 55, the operation apparatus 51 of the apparatus 20′ includes a CPU 52, a ROM 53, a RAM 54, a flash memory 55, an operation panel 56, a connection I/F 57, and a communications I/F 58. These hardware elements are connected via a bus 59.

The CPU 52 controls the entirety of the operation apparatus 51 by executing various programs stored in the ROM 53 or the flash memory 55 using the RAM 54 as a work area.

The ROM 53 is a nonvolatile semiconductor memory (storage device) that can hold data even after the power supply is stopped. The RAM 54 is a volatile semiconductor memory (storage device) temporarily storing programs and data.

The flash memory 55 is a nonvolatile storage medium and stores various programs (for example, an expense reimbursement application 500 described later) to be executed by the CPU 52, and various data.

The operation panel 56 is used by the user to perform various operations. That is, the operation panel 56 displays, for example, a GUI (Graphical User Interface) display screen page for the user to perform various operations concerning various functions of the apparatus 20′; processing results of the apparatus 20′; and so forth.

The connection I/F 57 is used to carry out communications with the body apparatus 61 via a communications path 71. As the connection I/F 57, for example, a USB-standard interface is used.

The communications I/F 58 is used to carry out communications with external apparatuses, or the like. For the communications I/F 58, for example, a Wi-Fi-standard wireless LAN is used.

In the same way, the body apparatus 61 of the apparatus 20′ includes a CPU 62, a ROM 63, a RAM 64, a HDD 65, a scanner 66, a connection I/F 67, and a communications I/F 68. These hardware elements are connected via a bus 69.

The CPU 62 controls the entirety of the body apparatus 61 by executing various programs stored in the ROM 63 or the HDD 65 using the RAM 64 as a work area.

The ROM 63 is a nonvolatile semiconductor memory (storage device) that can hold data even after the power supply is stopped. The RAM 64 is a volatile semiconductor memory (storage device) temporarily storing programs and data.

The HDD 65 is a nonvolatile storage medium, and stores various programs (for example, a program for implementing the present embodiment) to be executed by the CPU 62, and various data.

The scanner 66 is a reading device that reads an original image and generates an electronic file (i.e., an image file).

The connection I/F 67 is used to carry out communications with the operation apparatus 51 via the communications path 71. As the connection I/F 57, for example, a USB-standard interface is used.

The communications I/F 68 is used to carry out communications with external apparatuses, or the like. For the communications I/F 68, for example, a Wi-Fi-standard wireless LAN is used.

The apparatus 20′ according to the present embodiment implements various processes, described later, using the hardware configuration illustrated in FIG. 55.

FIG. 55 illustrates the apparatus 20′ having the operation apparatus 51, as one example, and the configuration of the apparatus 20′ is not limited to this configuration. For example, an information processing terminal such as a tablet terminal, a smartphone, a cellular phone, a PDA, or the like, may function as another operation apparatus for the apparatus 20′. Such an information processing terminal may control the apparatus 20′ where the communications I/F 58 of the operation apparatus 51 or the communications I/F 68 of the body apparatus 61 is used for the information processing apparatus to carry out communications with the apparatus 20′.

### <Functional Configuration>

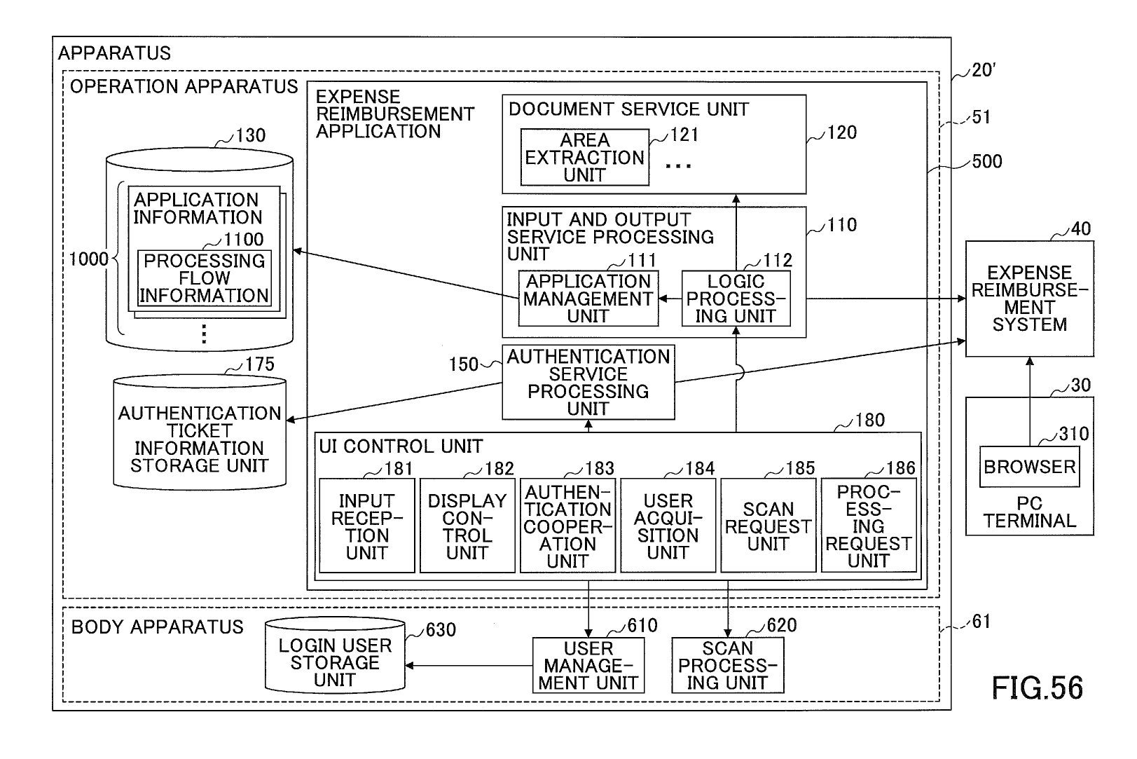

A functional configuration of the information processing system 1′ according to the present embodiment will be described with reference to FIG. 56. FIG. 56 illustrates one example of a functional configuration of the information processing system 1′ according to the present embodiment.

The operation apparatus 51 of the apparatus 20′ illustrated in FIG. 56 includes the expense reimbursement application 500 implemented by, for example, the CPU 52, and so forth. The expense reimbursement application 500 is an application program for the user of the apparatus 20′ to use a receipt registration service. The user uses a receipt registration service through the expense reimbursement application 500 installed in the operation apparatus 51 of the apparatus 20′.

The operation apparatus 51 of the apparatus 20′ illustrated in FIG. 56 includes an input and output service processing unit 110, a document service unit 120, a UI control unit 180, and an authentication service processing unit 150. These functional units are implemented by processes carried out by the CPU 52 according to the expense reimbursement application 500 installed in the operation apparatus 51 of the apparatus 20′.

Also, the operation apparatus 51 of the apparatus 20′ illustrated in FIG. 56 includes an application information storage unit 130 and an authentication ticket information storage unit 175. These storage units can be implemented by, for example, the flash memory 55.

The UI control unit 180 carries out processes for the user to use a receipt registration service. The UI control unit 180 includes an input reception unit 181, a display control unit 182, an authentication cooperation unit 183, a user acquisition unit 184, a scan request unit 185, and a processing request unit 186.

The input reception unit 181 receives operations (for example, a scanning start operation for starting scanning receipts) that are performed and input by the user. The display control unit 182 displays various screen pages (for example, a scan screen page for scanning receipts).

The authentication cooperation unit 183 transmits an authentication request, and so forth, to the authentication service processing unit 150. The user acquisition unit 184 transmits a request (i.e., a login user acquisition request) to acquire the user ID of the user (i.e., a login user) who has logged in to the apparatus 20′, to the body apparatus 61. The scan request unit 185 transmits a request (i.e., a scan request) to the body apparatus 61 to scan receipts. The processing request unit 186 transmits a request (i.e., a processing flow carrying-out request) to the logic processing unit 112 to carry out a sequence of processes (i.e., a processing flow) implementing a receipt registration service. The authentication service processing unit 150 carries out authentication cooperation with the expense reimbursement system 40. That is, if authentication for the expense reimbursement system 40 is successful, the authentication service processing unit 150 stores authentication ticket information in which an authentication ticket that is returned as a result of authentication being successful is associated with the user ID of the login user of the apparatus 20′ in the authentication ticket information storage unit 175. When the user will use a receipt registration service, the authentication service processing unit 150 acquires the authentication ticket that is stored in the authentication ticket information storage unit 175 in the state of being associated with the user ID of the user.

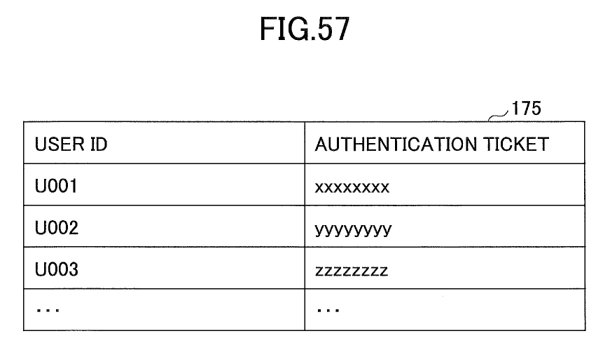

The authentication ticket information storage unit 175 stores authentication ticket information in which user IDs for logging in to the apparatus 20′ are associated with authentication tickets for the expense reimbursement system 40, respectively. Authentication ticket information stored in the authentication ticket information storage unit 175 will now be described with reference to FIG. 57. FIG. 57 illustrates one example of authentication ticket information.

As illustrated in FIG. 57, in authentication ticket information stored in the authentication ticket information storage unit 175, the user IDs are associated with the authentication tickets, respectively.

Thus, a user who has logged in to the apparatus 20′ can use a receipt registration service using the authentication ticket associated with the user ID of the user.

Returning to FIG. 56, the body apparatus 61 of the apparatus 20′ illustrated in FIG. 56 has a user management unit 610 and a scan processing unit 620. These functional units are implemented by processes carried out by the CPU 62 according to one or more programs installed in the apparatus 20′.

Also, the body apparatus 61 of the apparatus 20′ illustrated in FIG. 56 has a login user storage unit 630. The login user storage unit 630 can be implemented using, for example, the HDD 65.

The user management unit 610 manages user IDs stored in the login user storage unit 630. The user management unit 610 responds to a login user acquisition request to acquire a user ID from the login user storage unit 630 and returns the acquired user ID to the operation apparatus 51.

The scan processing unit 620 responds to a scan request to carry out a scanning process using the scanner 66.

The login user storage unit 630 stores the user ID of the user who has logged in to the apparatus 20′.

### <Process Details>

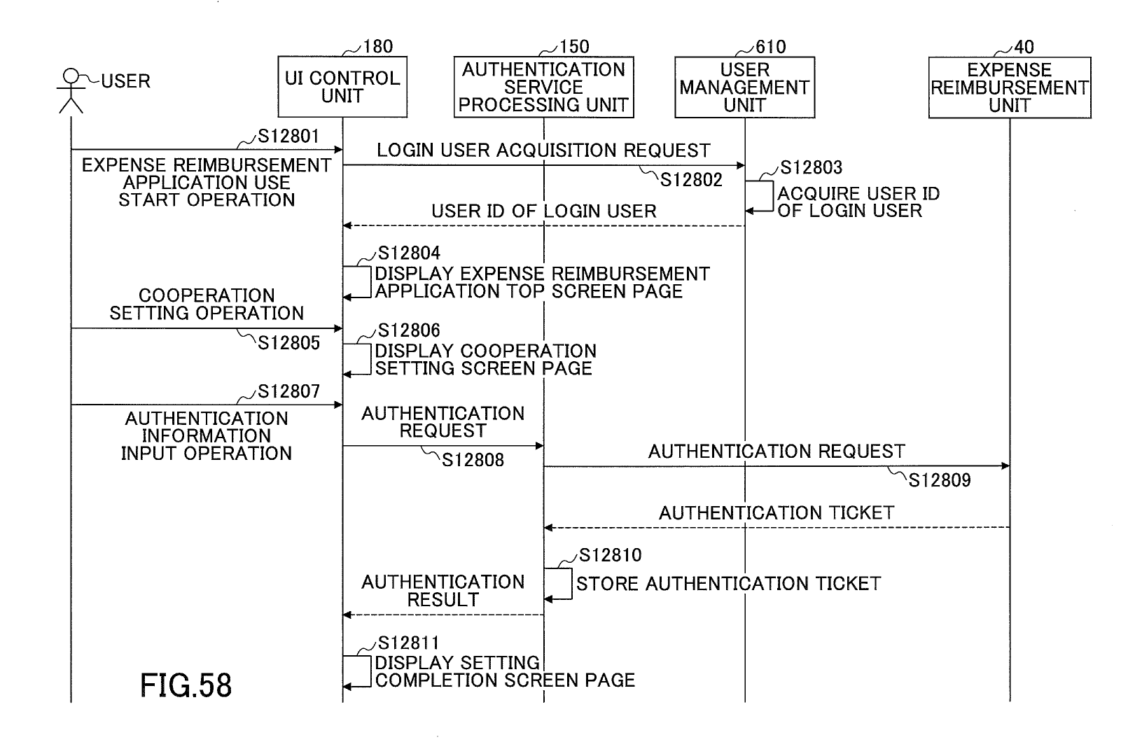

Processes of the information processing system 1′ according to the present embodiment will now be described in detail. Below, a process where, before the user of the apparatus 20′ uses a receipt registration service, settings for authentication cooperation with the expense reimbursement system 40 are made, will be described with reference to FIG. 58. FIG. 58 is a sequence diagram illustrating one example of a cooperation setting operation according to the eighth embodiment.

First, the user uses the operation apparatus 51 of the apparatus 20′ to perform an expense reimbursement application use start operation to start using the expense reimbursement application 500 (step S12801). The user performs the expense reimbursement application use start operation as follows.

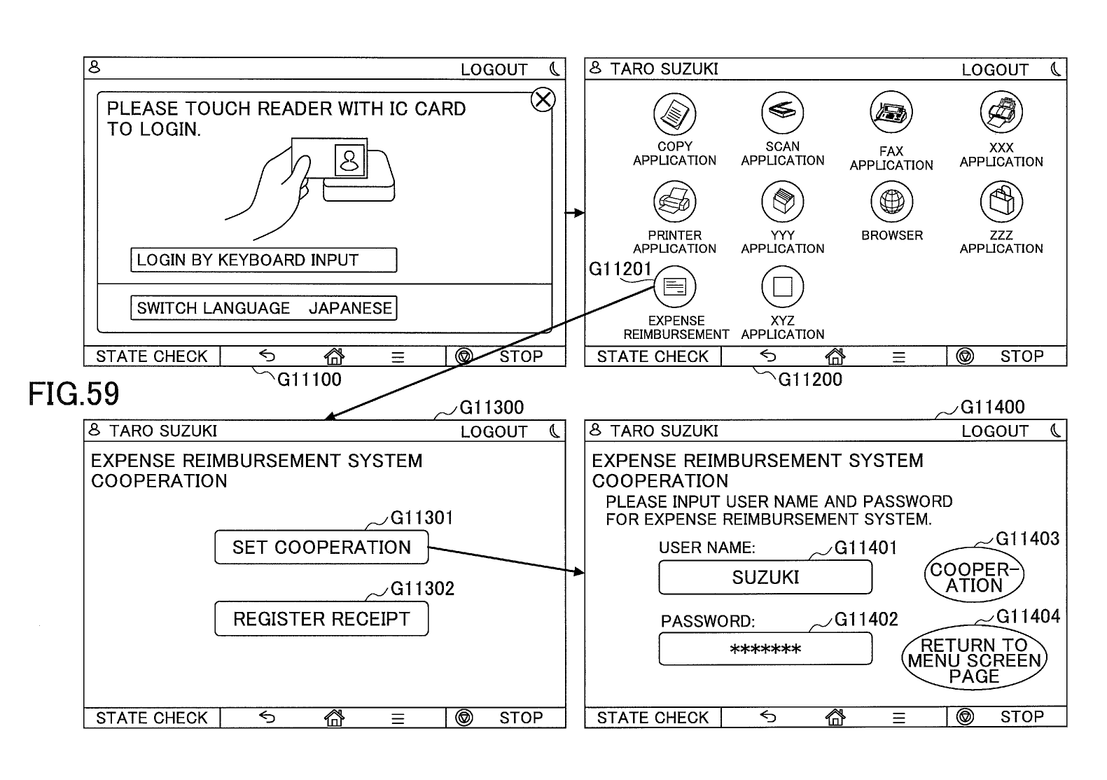

That is, first, on the operation panel 56 of the operation apparatus 51, an initial screen page G11100 illustrated in FIG. 59 is displayed. After the user holds, for example, a certain IC card over a certain position of the apparatus 20′, an application list screen page G11200 illustrated in FIG. 59 is displayed on the operation panel 56 of the operation apparatus 51.

Then, the user can perform the expense reimbursement application use start operation by selecting an “expense reimbursement” icon G11201 in the application list screen page G11200 illustrated in FIG. 59 prepared for starting using the expense reimbursement application 500.

After the input reception unit 181 receives the user's expense reimbursement application use start operation, the user acquisition unit 184 of the UI control unit 180 transmits a login user acquisition request to the body apparatus 61 (step S12802). Note that, the user acquisition unit 184 can transmit the login user acquisition request by, for example, transmitting a HTTP (Hypertext Transfer Protocol) request to a certain WebAPI of the body apparatus 61.

After receiving the login user acquisition request, the user management unit 610 of the body apparatus 61 acquires the user ID of the user who has logged in to the apparatus 20′ from the login user storage unit 630 (step S12803). Then, the user management unit 610 returns the acquired user ID to the operation apparatus 51.

Then, the display control unit 182 of the UI control unit 180 displays a top screen page G11300 of the expense reimbursement application 500 illustrated in FIG. 59 (step S12804). The top screen page G11300 of the expense reimbursement application 500 includes a “cooperation setting” button G11310 for setting authentication cooperation with the expense reimbursement system 40 and a “receipt registration” button G11320 for using a receipt registration service.

Hereinafter, it is assumed that the user selects the “cooperation setting” button G11310, and performs a cooperation setting operation (step S12805).

After the input reception unit 181 receives the cooperation setting operation, the display control unit 182 of the UI control unit 180 displays an authentication information input screen page G11400 illustrated in FIG. 59 (step S12806). The authentication information input screen page G11400 includes a user name input field G11401 for inputting the user name to login to the expense reimbursement system 40 and a password input field G11402 for inputting the password corresponding to the user name. Also, the authentication information input screen page G11400 includes a “cooperation” button G11403 for starting authentication cooperation and a “return” button G11404 for returning to the top screen page G11300.

The user performs an authentication information input operation by selecting the “cooperation” button G11403 after inputting the user name and the password for the expense reimbursement system 40 in the user name input field G11401 and the password input field G11402, respectively (step S12807).

After the input reception unit 181 receives the authentication information input operation, the authentication cooperation unit 183 of the UI control unit 180 transmits an authentication request to the authentication service processing unit 150 (step S12808). Note that the authentication request includes the user name and the password (that is, the authentication information for the expense reimbursement system 40) that have been input in the user name input field G11401 and the password input field G11402, respectively.

After receiving the authentication request from the authentication cooperation unit 183, the authentication service processing unit 150 transmits the authentication request to the expense reimbursement system 40 (step S12809). After receiving the authentication request, the expense reimbursement system 40 carries out authentication based on the authentication information (the user name and the password) included in the authentication request. If the authentication is successful, the expense reimbursement system 40 returns an authentication ticket. If the expense reimbursement system 40 has failed in the authentication, the expense reimbursement system 40 returns information indicating that the authentication is failed. Hereinafter, the description will be continued assuming that the expense reimbursement system 40 returns an authentication ticket.

Because the expense reimbursement system 40 has returns the authentication ticket, the authentication service processing unit 150 stores authentication ticket information in which the user ID that has been returned in step S12803 is associated with the authentication ticket in the authentication ticket information storage unit 175 (step S12810). Then, the authentication service processing unit 150 returns the authentication result to the UI control unit 180. Thus, the authentication ticket to be used for authentication cooperation is stored in the state of being associated with the user ID.

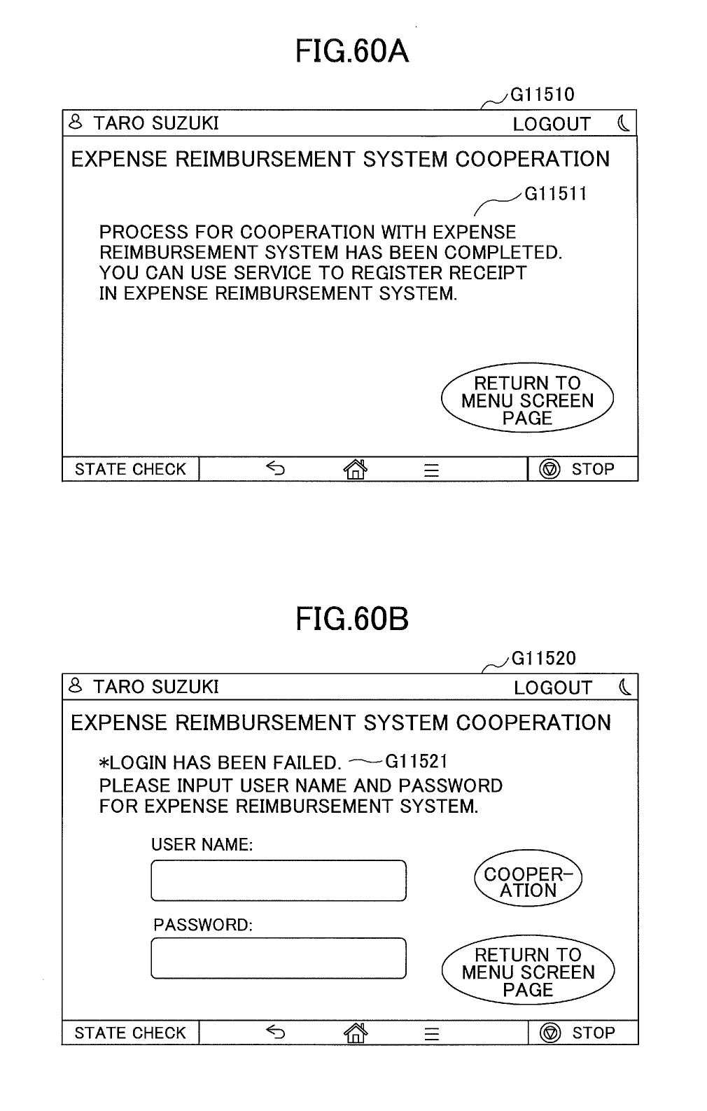

Then, the display control unit 182 of the UI control unit 180 displays a setting completion screen page G11510 illustrated in FIG. 60A (step S12811). The setting completion screen page G11510 includes a message G11511 indicating that settings for carrying out authentication cooperation with the expense reimbursement system 40 have been completed. Thus, the user can see that settings for carrying out authentication cooperation with the expense reimbursement system 40 have been completed.

If, in step S12809 described above, information indicating that the expense reimbursement system 40 has failed in the authentication has been returned, the display control unit 182 of the UI control unit 180 displays a login failure screen page G11520 illustrated in FIG. 60B. The login failure screen page G11520 includes a message G11521 indicating that authentication for the expense reimbursement system 40 has been failed (i.e., login has been failed). Thus, the user can know that, because, for example, the inputting the authentication information includes an error, or the like, the authentication for the expense reimbursement system 40 has been failed.

Thus, the apparatus 20′ according to the present embodiment can store an authentication ticket for carrying out authentication cooperation with the expense reimbursement system 40 in a state of the authentication ticket with the user ID of a login user of the apparatus 20′. Thus, the user of the apparatus 20′ can use a receipt registration service in authentication cooperation with the expense reimbursement system 40.

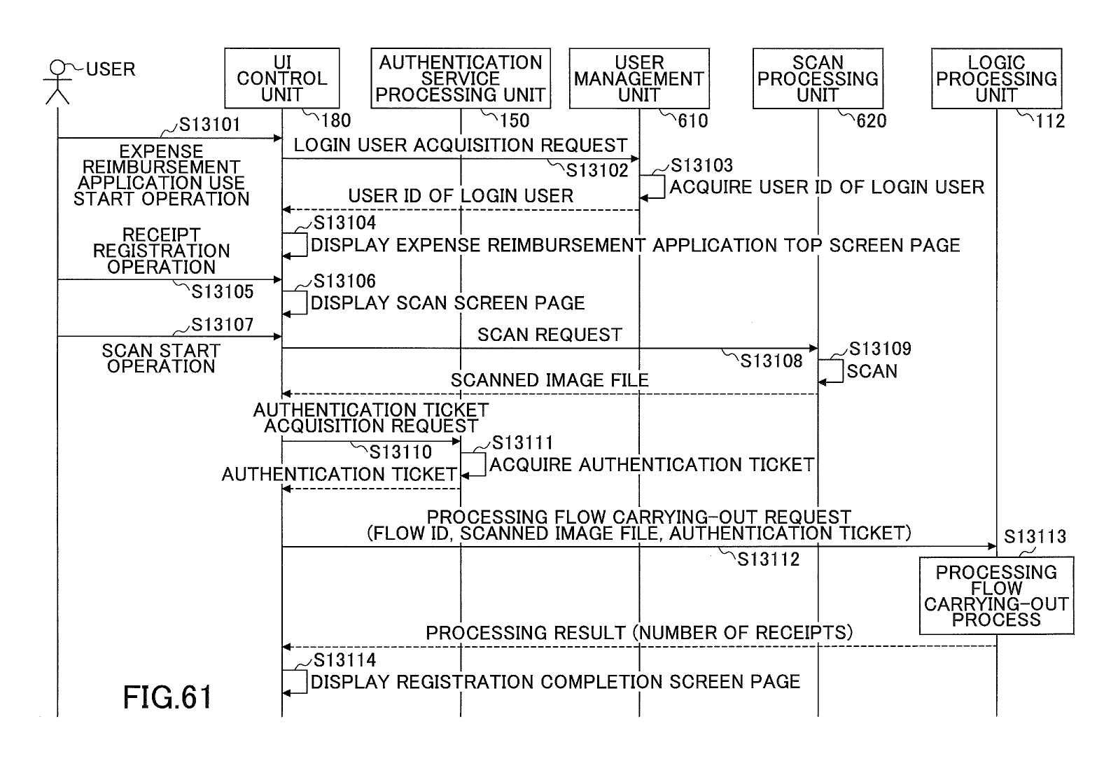

Next, a process where the user of the apparatus 20′ uses a receipt registration service to register receipt image files (i.e., image files of receipts) in an expense reimbursement service will now be described with reference to FIG. 61. FIG. 61 is a sequence diagram illustrating one example of an overall process for using a receipt registration service according to the eighth embodiment. Note that, steps S13101-S13104 are the same as steps S12801-S12804 of FIG. 58, and therefore, duplicate description will be omitted.

Hereinafter, it is assumed that the user selects the “receipt registration” button G11320 in the top screen page G11300 displayed in step S13104 to perform a receipt registration operation (step S13105).

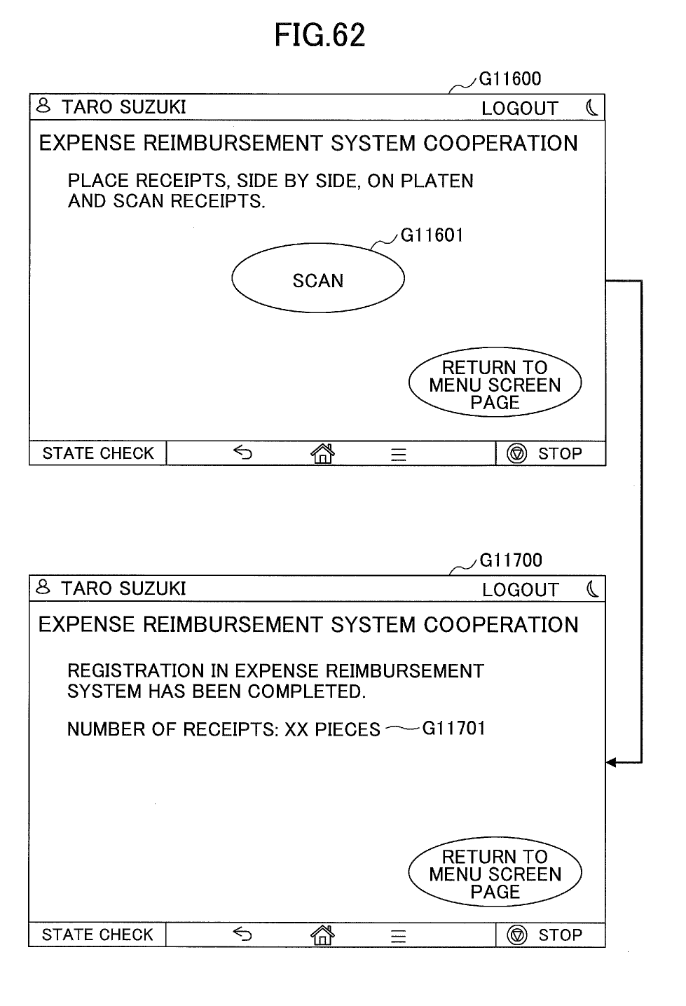

After the input reception unit 181 receives the receipt registration operation, the display control unit 182 of the UI control unit 180 displays a scan screen page G11600 illustrated in FIG. 62 (step S13106). The scan screen page G11600 includes a “scan” button G11601 for the user to start scanning receipts to generate a scanned image file.

The user performs a scan start operation by pressing the “scan” button G11601 after setting one or more receipts on the scanner 66 of the body apparatus 61 (step S13107).

After the input reception unit 181 receives the scan start operation, the scan request unit 185 of the UI control unit 180 transmits a scan request to the body apparatus 61 (step S13108). Note that, the scan request unit 185 can transmit the scan request by, for example, transmitting a HTTP request to a certain WebAPI of the body apparatus 61.

After receiving the scan request, the scan processing unit 620 of the body apparatus 61 reads each receipt through the scanner 66 to generate a scanned image file including areas of images of the respective receipts (step S13109). Then, the scan processing unit 620 returns the generated scanned image file.

Then, the authentication cooperation unit 183 of the UI control unit 180 transmits an authentication ticket acquisition request to the authentication service processing unit 150 (step S13110). The authentication ticket acquisition request includes the user ID (that is, the user ID of the login user of the apparatus 20′) that has been returned in step S13103.

After receiving the authentication ticket acquisition request, the authentication service processing unit 150 acquires the authentication ticket associated with the user ID included in the authentication ticket acquisition request from the authentication ticket information storage unit 175 (step S13111). Then, the authentication service processing unit 150 returns the acquired authentication ticket.

Then, the processing request unit 186 of the UI control unit 180 transmits a processing flow carrying-out request to the logic processing unit 112 (step S13112). The processing flow carrying-out request includes the flow ID “flow001” of the set of processing flow information 1100 for implementing a receipt registration service according to the present embodiment, the scanned image file, and the authentication ticket. The flow ID “flow001” has been associated with, for example, the “scan” button G11601 of the scan screen page G11600 illustrated in FIG. 62.

After receiving the processing flow carrying-out request, the logic processing unit 112 carries out a processing flow carrying-out process (step S13113). That is, the logic processing unit 112 carries out the sequence of processes based on the set of processing flow information 1100 having the flow ID “flow001” included in the processing flow carrying-out request. Then, the logic processing unit 112 returns the processing result of the processing flow carrying-out process to the UI control unit 180. The processing result includes the number of the areas of images of the receipts included in the scanned image file (that is, the number of the receipt areas extracted from the scanned image file).

After receiving the processing result, the display control unit 182 of the UI control unit 180 displays a registration completion screen page G11700 illustrated in FIG. 62 (step S13114). The registration completion screen page G11700 includes the number of receipts G11701 (that is, the number of the receipts extracted from the scanned image file) that is the number of the receipts having been registered in the expense reimbursement system 40. Thus, the user can know how many receipts have been registered in the expense reimbursement system 40. Thus, the user of the apparatus 20′ can use a receipt registration service by using a previously stored authentication ticket. Therefore, the user of the apparatus 20′ can use a receipt registration service without inputting authentication information (a user name and a password, or the like, for the expense reimbursement system 40).

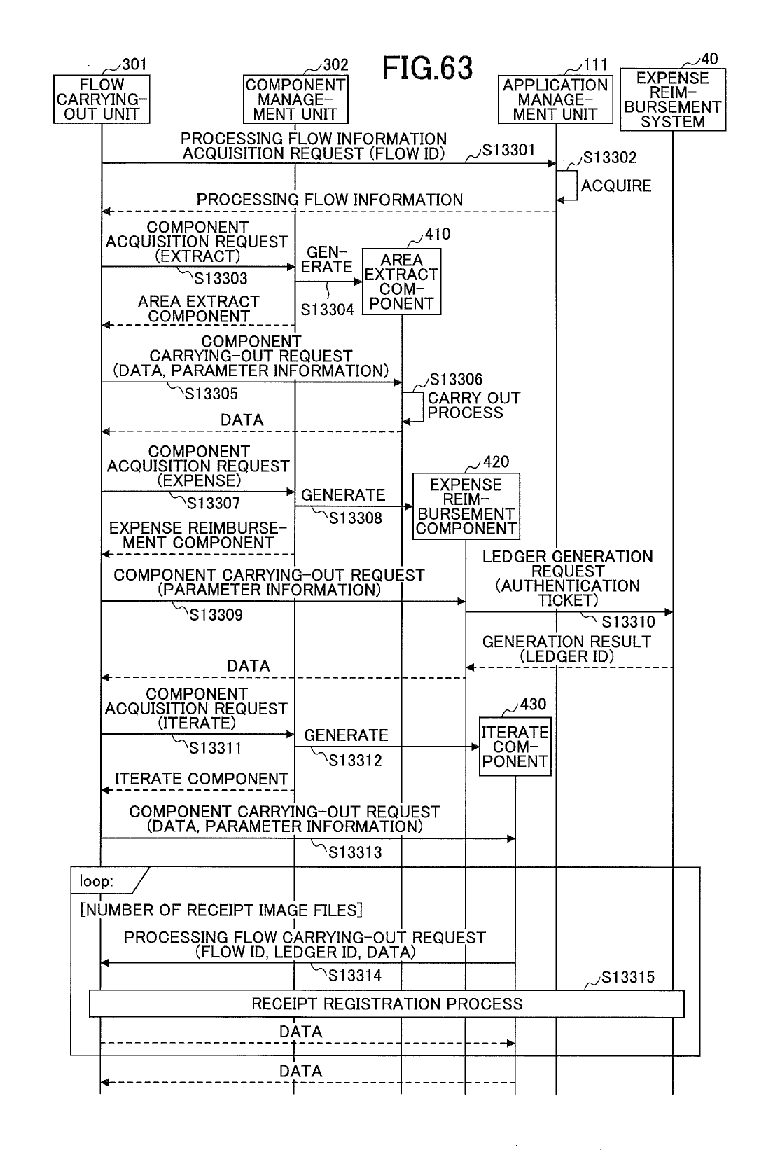

The processing flow carrying-out process (step S13113) illustrated in FIG. 62 will now be described in detail with reference to FIG. 63. FIG. 63 is a sequence diagram illustrating one example of a processing flow carrying-out process implementing a receipt registration service according to the eighth embodiment.

First, after receiving the processing flow carrying-out request from the UI control unit 180, the flow carrying-out unit 301 transmits a processing flow information acquisition request to the application management unit 111 (step S13301). Note that, the processing flow information acquisition request includes the flow ID “flow001” acquired from the processing flow carrying-out request.

Steps S13302-S13305 are the same as steps S11202-S11205 of FIG. 49, and therefore, duplicate description will be omitted.

Subsequent to step S13305, in the same way as step S11206 of FIG. 49, after receiving the component carrying-out request, the area extract component 410 carries out a process on the data included in the component carrying-out request using the parameter information (step S13306). Then, the area extract component 410 returns data indicating the generated receipt image files and the number (that is, the number of receipts) of the generated receipt image files to the flow carrying-out unit 301.

Steps S13307-S13308 are the same as steps S11207-S11208 of FIG. 49, and therefore, duplicate description will be omitted.

Sequent to step S13308, the flow carrying-out unit 301 transmits a component carrying-out request to the expense reimbursement component 420 (step S13309).

Note that, the component carrying-out request includes the respective sets of parameter information defined for “parameters” included in the processing definition 1112 of the set of processing flow information 1100 illustrated in FIG. 7. That is, the component carrying-out request includes parameter information in which the authentication ticket is set to parameter information ‘“auth”: null’. Also, the component carrying-out request includes parameter information for transmitting a ledger generation request to the expense reimbursement system 40.

After receiving the component carrying-out request, the expense reimbursement component 420 uses the parameter information to carry out a process (step S13310). That is, the expense reimbursement component 420 transmits a ledger generation request to the expense reimbursement system 40. The expense reimbursement component 420 can transmit the ledger generation request by using, for example, a WebAPI disclosed by the expense reimbursement system 40. Also, the ledger generation request includes the authentication ticket.

Steps S13311-S13314 are the same as steps S11211-S11214 of FIG. 49, and therefore, duplicate description will be omitted.

Subsequent to step S13314, after receiving the processing flow carrying-out request, the flow carrying-out unit 301 carries out a process (i.e., a receipt registration process) for registering the receipt image files in the ledger identified by the ledger ID concerning an expense reimbursement service using the authentication ticket (step S13315). Then, the flow carrying-out unit 301 returns the processing result of the receipt registration process to the iterate component 430.

Thereafter, the iterate component 430 returns data indicating the processing result (that includes the number of receipts registered in the expense reimbursement system 40) of iteratively carrying out the receipt registration process of step S13315 to the flow carrying-out unit 301.

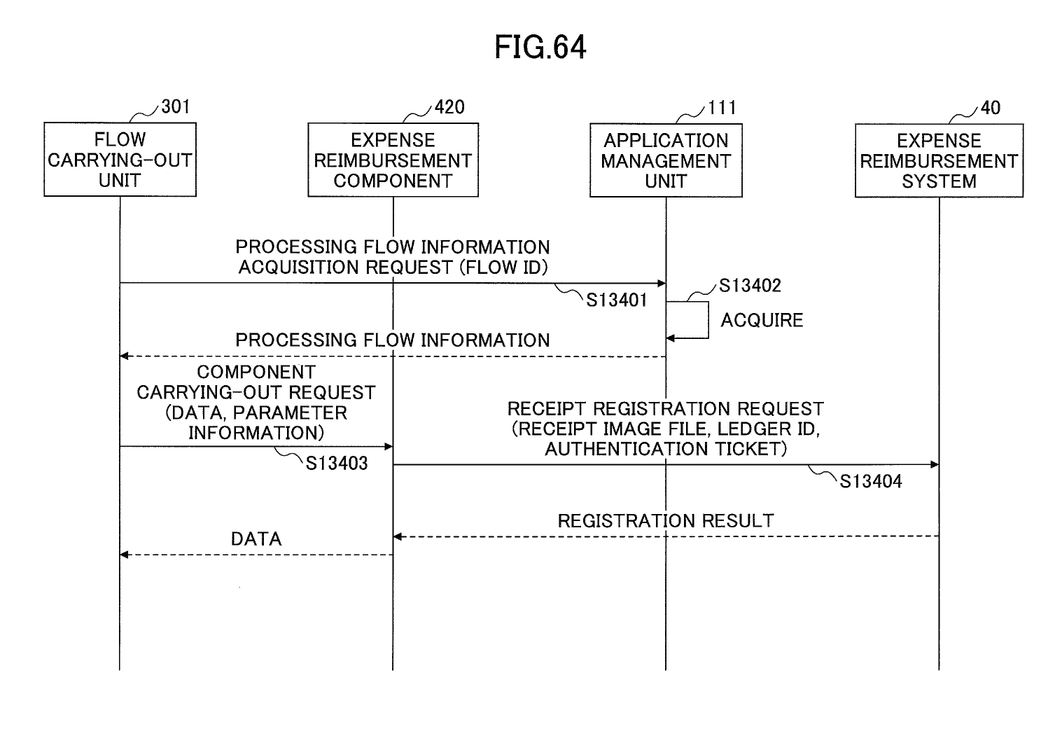

The receipt registration process (step S13315) will now be described in detail with reference to FIG. 64. FIG. 64 is a sequence diagram illustrating one example of the receipt registration process according to the eighth embodiment. Steps S13401-S13402 are the same as steps S11301-S11302 of FIG. 50, and therefore, duplicate description will be omitted.

Subsequent to step S13402, the flow carrying-out unit 301 transmits a component carrying-out request to a component defined for “component” having the component name “expense” included in the processing definition 1211 of the set of processing flow information 1100 illustrated in FIG. 8 (step S13403). That is, the flow carrying-out unit 301 transmits the component carrying-out request to the expense reimbursement component 420.

The component carrying-out request includes the data (the receipt image files). The component carrying-out request also includes parameter information in which the authentication ticket is set to parameter information ‘“auth”: null’, parameter information for transmitting a receipt registration request to the expense reimbursement system 40, and parameter information indicating the ledger ID.

After receiving the component carrying-out request, the expense reimbursement component 420 carries out a process using the data and the parameter information (step S13404). That is, the expense reimbursement component 420 transmits a receipt registration request to the expense reimbursement system 40. The expense reimbursement component 420 can transmit the receipt registration request by using, for example, a WebAPI disclosed by the expense reimbursement system 40. The receipt registration request includes the receipt image files, the ledger ID, and the authentication ticket. Thus, the receipt image files are registered in the ledger concerning the expense reimbursement service.

### <Summary of Sixth Through Eighth Embodiments>

Thus, the apparatus 20′ (for example, an image forming apparatus such as a MFP) according to the sixth embodiment provides a receipt registration service that is in cooperation with the expense reimbursement system 40 to the user. Therefore, the user of the apparatus 20′ can register image files indicating pieces of paper for evidence such as receipts (that may be simple receipts) as evidence for expenses in the expense reimbursement system 40 by scanning the pieces of paper for evidence through the apparatus 20′.

By using the apparatus 20′ (for example, a smartphone, a tablet terminal, a digital camera, or the like) according to the seventh embodiment, the user of the apparatus 20′ can register image files indicating pieces of paper for evidence such as receipts (that may be simple receipts) as evidence for expenses in the expense reimbursement system 40 by photographing the pieces of paper for evidence through the apparatus 20′.

Thus, the user of the apparatus 20′ can easily register image files indicating pieces of paper for evidence such as receipts (that may be simple receipts) as evidence for expenses in the expense reimbursement system 40 in a case of performing expense reimbursement using a expense reimbursement service provided by the expense reimbursement system 40.

The apparatus 20′ according to the eighth embodiment stores authentication tickets for authentication cooperation with the expense reimbursement system 40. Thus, the user of the apparatus 20′ can use a receipt registration service without inputting authentication information (a user name and a password, or the like, for the expense reimbursement system 40) by performing settings for authentication cooperation with the expense reimbursement system 40.

The information processing systems and the information processing apparatuses have been described in the embodiments. However, embodiments are not limited to the above-described embodiments, and various modifications and replacements may be made.

The above-mentioned expense reimbursement system 40 is one example of a system including at least an expense report function for expense reporting using evidence paper images such as receipt images as expense reports.

What is claimed is:

1. An information processing system comprising one or more processors, the one or more processors being configured to:
receive, from an apparatus, first image data that includes one or more evidence paper images for expense reporting;
extract the one or more evidence paper images from the received first image data, and generate one or more sets of second image data corresponding to the one or more evidence paper images, respectively; and
send the generated one or more sets of second image data to a system including at least an expense report function to cause the system including at least the expense report function to register each of the one or more sets of second image data in the system including at least the expense report function.

2. The information processing system according to claim 1, wherein
the one or more processors are further configured to
generate a ledger in which the one or more sets of second image data are registered, the ledger being generated in the system including at least the expense report function, and
register each of the one or more sets of second image data in the generated ledger.

3. The information processing system according to claim 1, wherein
the one or more processors are further configured to
send the one or more sets of second image data to the system including at least the expense report function to cause the system including at least the expense report function to register each of the one or more sets of second image data in the system including at least the expense report function, using a WebAPI provided by the system including at least the expense report function.

4. The information processing system according to claim 1, wherein
the first image data that includes one or more evidence paper images is generated as a result of one or more pieces of paper for evidence being scanned by the apparatus or being photographed by the apparatus.

5. The information processing system according to claim 4, wherein
each of the one or more pieces of paper for evidence is one of a receipt and a piece of paper that is output from a cash register.

6. The information processing system according to claim 1, wherein
the one or more processors are further configured to
receive, from the apparatus, the first image data and authentication information to be used for authentication concerning the system including at least the expense report function, and
send the one or more sets of second image data to the system including at least the expense report function to cause the system including at least the expense report function to register each of the one or more sets of second image data in the system including at least the expense report function, with the use of the authentication information.

7. The information processing system according to claim 1, wherein
the one or more processors are further configured to
store a token that is generated when authentication concerning the system including at least the expense report function is successful, and
send the one or more sets of second image data to the system including at least the expense report function to cause the system including at least the expense report function to register each of the one or more sets of second image data in the system including at least the expense report function, with the use of the token.

8. The information processing system according to claim 1, wherein
the one or more processors are further configured to store a template that defines positions in the one or more sets of second image data from which information is extracted,
extract one or more sets of the information from the positions of the one or more sets of second image data according to the template, and
send the one or more sets of second image data and the one or more sets of the information respectively extracted from the one or more sets of second image data to the system including at least the expense report function to cause the system including at least the expense report function to register each of the one or more sets of second image data and register the one or more sets of the information respectively extracted from the one or more sets of second image data in the system including at least the expense report function.

9. The information processing system according to claim 8, wherein
the one or more processors are further configured to
extract one or more sets of numeral information that indicates money amounts from the positions defined by the template in the one or more sets of second image data.

10. An information processing apparatus comprising one or more processors, the one or more processors being configured to:
receive, from an apparatus, first image data that includes one or more evidence paper images for expense reporting;
extract the one or more evidence paper images from the received first image data, and generate one or more sets of second image data corresponding to the one or more evidence paper images, respectively; and
send the generated one or more sets of second image data to a system including at least an expense report function to cause the system including at least the expense report function to register each of the one or more sets of second image data in the system including at least the expense report function.

11. An information processing system comprising:
an image forming apparatus configured to generate, by scanning one or more pieces of paper for evidence, first image data that includes one or more evidence paper images for expense reporting; and
a server apparatus that includes one or more processors configured to:
extract the one or more evidence paper images from the first image data generated by the image forming apparatus, and generate one or more sets of second image data corresponding to the one or more evidence paper images, respectively; and
send the generated one or more sets of second image data to a system including at least an expense report function to cause the system including at least the expense report function to register each the one or more sets of second image data in the system including at least the expense report function.
